(19) United States
(12) Patent Application Publication
(10) Pub. No.: US 2001/0028418 A1
(43) Pub. Date: Oct. 11, 2001

(54) Liquid crystal display device and fault repairing method for the liquid crystal display device

(75) Inventors: Kiyoshi Ozaki, Yonago (JP); Kenichi Nagaoka, Kawasaki (JP); Kunio Matsubara, Yonago (JP); Yoji Nagase, Kawasaki (JP)

Correspondence Address: Patrick G. Burns, Esq., GREER, BURNS & CRAIN, LTD., 300 South Wacker Dr., Suite 2500, Chicago, IL, 60606, US

(73) Assignee: FUJITSU LIMITED

(21) Appl. No.: 09/819,291

(22) Filed: Mar. 28, 2001

(30) Foreign Application Priority Data
Mar. 29, 2000 (JP) 2000-92151
Oct. 4, 2000 (JP) 2000-305470
Dec. 18, 2000 (JP) 2000-383829

(51) Int. Cl. G02F 1/1333

(52) U.S. Cl. 349/54

(57) ABSTRACT

There is provided a fault repairing method for a liquid crystal display device capable of repairing simply a disconnected portion when a disconnection fault occurs in a display panel. For example, it is on the assumption that the disconnected portion is present in a data bus line. Disconnection repairing contact holes that have a width larger than that of the data bus line are formed in a protection insulating film on the data bus line on both sides of the disconnected portion respectively. Then, a laser CVD film (metal film) for covering inner surfaces of the disconnection repairing contact holes is formed by the laser CVD method, and then respective laser CVD films are connected electrically.

### BACKGROUND OF THE INVENTION

1. Field of the Invention

The present invention relates to an active matrix type liquid crystal display device and its fault repairing method.

2. Description of the Prior Art

(Prior Art 1)

The liquid crystal panel of the liquid crystal display device has the structure that is constructed by sticking two sheets of glass substrates, i.e., the TFT substrate on which TFTs (thin film transistors), etc. are formed and the CF (color filter) substrate on which the color filters, etc. are formed, to oppose to each other and then sealing the liquid crystal between them.

A plurality of gate bus lines, a plurality of data bus lines intersected with these gate bus lines via the interlayer insulating film, storage capacitance bus lines for crossing respective pixel areas that are defined by the gate bus lines and the data bus lines in parallel with the gate bus lines, and lead wirings for connecting the gate bus lines and the data bus lines to external connecting terminal portions respectively are provided on the TFT substrate. The TFTs are formed in vicinity of the intersection points of the gate bus lines and the data bus lines. The drain electrode of this TFT is connected to the data bus line, and the source electrode is connected to the pixel electrode.

Meanwhile, the reduction in the fabrication cost is the important subject in the liquid crystal display device. In order to reduce the cost, first the improvement in yield of the production is strongly desired. As the cause to lower the yield of the production of the liquid crystal display device, there are the disconnection occurred in the wirings such as the gate bus lines, the data bus lines, the storage capacitance bus lines, etc., the interlayer short-circuit between these wirings, and the like.

For example, in case the driver circuit is connected to the one side of the gate bus line since the disconnection occurs in the gate bus line, such display panel is the defective unit. In order to repair the disconnection occurred in the data bus line, there is employed the repairing method of providing the repair wiring around the display area and then connecting the disconnected data bus line to the repair wiring by the laser welding such as the YAG laser welding, etc. However, there is the problem that the detailed wiring routing becomes complicated in panel design.

Also, as other cause to lower the yield of fabrication of the liquid crystal display device, there is the interlayer short-circuit (line fault) in which the gate bus line and the data bus line are short-circuited or the interlayer short-circuit in which the data bus line and the storage capacitance bus line are short-circuited. In the prior art, there is employed the repairing method of providing the repairing wiring on the outside of the display area, then disconnecting the short-circuited area of the concerned bus line and connecting the concerned bus line to the repair wiring by the laser beam when the line fault occurs in the display panel. However, according to this method, the number of repaired wirings (the number of bus lines) is limited by the number of repair wirings provided on the outside of the display area and the repairable number in the block. Since the unrepaired line fault still remains if the number of line fault is larger than the limited number, there is the problem that such display panel is treated inevitably as the defective unit.

(Prior Art 2)

In recent years, the larger size and higher definition of the active matrix type liquid crystal display device make progress. However, with the progress of the larger size and higher definition, the wiring load capacitance is increased and also the horizontal scanning time is shortened. Therefore, the resistance value required for the wiring must be lowered much more. In particular, the serious degradation of the display quality such as the lateral crosstalk, etc. is brought about by the increase in the resistance of the storage capacitance bus line to provide the potential to the storage capacitance electrode. For this reason, the counterplan is applied by supplying the voltage from both ends of the storage capacitance bus lines to reduce the time constant. However, in such structure, there exists the portion at which the electrode that is provided to connect collectively the storage capacitance bus lines intersects with the gate bus lines.

FIG. 1 is a top view showing a configuration of the liquid crystal display device. In this liquid crystal display device, the liquid crystal is sealed between the TFT substrate 18 and the CF substrate 40 and the area in which the liquid crystal is sealed acts as the display area 38. At the end portion of the TFT substrate 18, the gate bus lines and the data bus lines (called also as the drain bus lines) are collected as a plurality of gate bus line groups 48 and a plurality of data bus line groups 50, and connected to the TAB substrates 44, 46 respectively. The TAB substrates 44, 46 are connected to the printed-wiring board 42.

FIG. 2 is an enlarged view showing the portion encircled by a broken line in FIG. 1. The gate bus lines 10 are connected to the gates of the TFTs 30 formed in the display area respectively. End portions of the gate bus lines 10 are connected to the gate terminal (TAB terminal). A plurality of pixels are arranged in a matrix fashion in the display area. Each pixel is surrounded by the gate bus line 10 and the data bus line 34, and the TFT 30 and the pixel electrode 32 are formed every pixel. The source electrode of the TFT 30 is connected to the pixel electrode 32, and the drain electrode is connected to the data bus line 34. The storage capacitance bus lines 22 that are formed in parallel with the gate bus lines 10 by the same steps as the gate bus lines 10 are formed in the central portion of the pixel area. Also, in order to prevent the destruction of the TFT by the static electricity, the gate bus lines 10 are connected to the guard ring 26 via the protection elements 28.

The storage capacitance bus lines 22 are connected to the storage capacitance bus line general electrode 16 via the storage capacitance bus line connecting electrodes 24 and the connecting portions 24a, 24b respectively. The storage capacitance bus line general electrode 16 is formed by the same steps as the gate bus lines 10, and the storage capacitance bus line connecting electrodes 24 are formed by the same steps as the pixel electrode 32. The storage capacitance bus line general electrode 16 is provided commonly to a plurality of storage capacitance bus lines 22 and is connected to a plurality of storage capacitance bus lines 22.

In the meanwhile, the gate bus lines 10 are provided to intersect with the storage capacitance bus line general electrode 16 via the insulating film. FIG. 3 shows the intersecting portion of the gate bus line 10 and the storage capacitance bus line general electrode 16. If the short circuit occurs in this intersecting portion due to the static electricity, etc. during manufacturing steps, the line fault is brought about in the direction along the gate bus lines.

FIG. 4 is a view showing another configuration of the intersecting portion in the prior art. In the configuration in FIG. 4, the gate bus line 10 is separated into two branch portions 10d, 10e in the portion at which the gate bus line 10 intersects with the storage capacitance bus line general electrode 16. In case the short circuit occurs in the intersecting portion due to the static electricity, etc. during manufacturing steps, the short-circuited portion is electrically separated by cutting off the short-circuited branch portion by the laser beam, etc. after the short-circuited position is checked by the inspection using the pattern recognition. Thus, the gate bus line 10 is restored to the normal gate bus line.

However, all the short circuits that occurs actually cannot always be recognized by the inspection using the pattern recognition. Therefore, even if no problem exists in appearance, there are many cases where the very small short-circuits are present. In addition, if the short-circuit can be detected by the electrical test, it cannot be found that which one of the branch portions 10d, 10e should be cut off. This causes the extreme reduction in the repair rate (relief rate) of the short-circuit fault.

(Prior Art 3)

FIG. 5 is a sectional view showing the normal TN type liquid crystal display device in the display area. FIG. 6 is a plan view showing the TFT substrate of the same liquid crystal display device. In this case, FIG. 5 shows a sectional shape at the position corresponding to a X-X line in FIG. 6.

The TN type liquid crystal display device consists of the TFT substrate 18, the CF substrate 40, and the liquid crystal 79 that is sealed between the TFT substrate 18 and the CF substrate 40.

The TFT substrate 18 is constructed as described in the following. That is, a plurality of gate bus lines 52 and a plurality of storage capacitance bus lines 53 are formed as the first wiring layer on the glass substrate 51. Respective gate bus lines 52 are formed in parallel mutually, the storage capacitance bus lines 53 are arranged between the gate bus lines 52 in parallel with the gate bus lines 52 respectively.

The gate bus lines 52 and the storage capacitance bus lines 53 are covered with the first insulating film (gate insulating film) (not shown). The amorphous silicon film 54 serving as the channels of the switching TFTs 56 is formed on the first insulating film over the gate bus lines 52. Also, the data bus lines 55, and the source electrodes 56s and the drain electrodes 56d of the TFTs 56 are formed as the second wiring layer on the first insulating film. The data bus lines 55 are formed to intersect orthogonally with the gate bus lines 52. The source electrodes 56s and the drain electrodes 56d of the TFTs 56 are formed on both sides of the amorphous silicon film 54 to be separated mutually in the width direction of the amorphous silicon film 54. Also, the drain electrodes 56d of the TFTs 56 are connected to the data bus lines 55. Rectangular areas that are partitioned by the gate bus lines 52 and the data bus lines 55 act as the pixel area respectively.

The data bus lines 55, and the source electrodes 56s and the drain electrodes 56d of the TFTs 56 are covered with the second insulating film (protection insulating film) 58. The transparent pixel electrodes 59 made of ITO (Indium-Tin Oxide) are formed on the second insulating film 58. The pixel electrodes 59 are electrically connected to the source electrodes 56s of the TFTs 56 via the contact holes 58a formed in the second insulating film 58 respectively.

The alignment film 57 that decides the alignment direction of the liquid crystal molecules is formed on the pixel electrodes 59. This alignment film 57 is formed of polyimide, for example, and the alignment process is applied to the alignment film 57 by the rubbing, etc.

In contrast, the CF substrate 40 is constructed as described in the following. That is, the black matrix 72 that is made of the light-shielding substance such as Cr (chromium), etc. to shield the areas between respective pixels and the TFT forming areas from the light is formed on one surface (lower surface in FIG. 5) of the glass substrate 71. Also, the color filter 73 having any one color of the red color (R), the green color (G), and the blue color (B) formed at positions that oppose to the pixel electrodes 59 on the TFT substrate 18.

The common electrode 74 made of ITO is formed under the color filters 73. The alignment film 75 made of polyimide, for example, is formed under the common electrode 74. The alignment process is also applied to the alignment film 57 by the rubbing, etc.

Spherical or cylindrical spacers (not shown) having a uniform diameter, for example, are arranged between the TFT substrate 18 and the CF substrate 40 such that the interval between the TFT substrate 18 and the CF substrate 40 is constant. Also, the polarizing plate (not shown) is arranged below the TFT substrate 18 and over the CF substrate 40 respectively.

In the liquid crystal display panel constructed as above, the desired images can be displayed by supplying the scanning signals and the video signals from the driving circuit to the gate bus lines 52 and the data bus lines 55 at a predetermined timing to control the voltage between the pixel electrodes 59 and the common electrode 74 pixel by pixel.

By the way, in the liquid crystal display device, the patterning is not normally carried out because of the adhesion of dust, etc. during the manufacturing steps, and thus the short-circuit or the disconnection occurs. Therefore, the pixel is brought into the state that such pixel is normally turned ON, otherwise the pixel is brought into the state that such pixel is normally turned OFF or such pixel as well as other pixel is simultaneously turned ON. Normally the spot faults are allowed in the liquid crystal display device inasmuch as the number of them is smaller than a predetermined number, but the liquid crystal display device becomes the defective unit if the number of faults is increased.

As the method of repairing the spot faults in the prior art, the method of connecting the pixel electrode of the defective pixel and the gate bus lines or the storage capacitance bus lines by the laser welding has been known. For example, if the short-circuit occurs between the source electrode and the drain electrode of the TFT, the pixel electrode and the data bus line are electrically separated by cutting off the source electrode or the drain electrode by the laser beam, and then the pixel electrode and the gate bus line or the storage capacitance bus line are deposited (welded) by the laser beam. Accordingly, since the defective pixel is brought into its normally turned OFF state, the fault of the pixel can be made inconspicuously.

However, the above fault repairing method of the liquid crystal display device in the prior art can make the fault inconspicuous, but such method cannot repair the defective pixel to be normally driven.

In Patent Application Publication (KOKAI) Hei 2-153324, there is set forth the fault repairing method of repairing the fault in the liquid crystal display device, in which the spare TFTs are provided in addition to the switching TFTs, by separating the switching TFT from the data bus line if the fault occurs in the data bus line and then connecting the spare TFT and the pixel electrode to repair the fault. However, according to this method, since the drain electrodes of the spare TFTs are previously connected to the data bus lines via the wirings, the reduction in the display quality is brought about because of the large load capacitance (Cgs).

In Patent Application Publication (KOKAI) Hei 3-171034 and Patent Application Publication (KOKAI) Hei 9-90408, the liquid crystal display devices in which the spare TFTs are provided in addition to the switching TFTs are set forth. In these liquid crystal display devices, since the drain electrodes of the spare TFTs are not connected to the data bus lines, the load capacitances are relatively small. However, in these liquid crystal display devices, the spare wirings for connecting the drain electrodes of the spare TFTs to the data bus lines must be provided previously. Since the data bus lines and the drain electrodes of the spare TFTs are overlapped via these spare wirings to put the insulating film between them, it is impossible to say that the load capacitance can be reduced sufficiently.

(Prior Art 4)

FIGS. 7A and 7B are schematic plan views showing the repairing method when the disconnection occurs in the gate bus line respectively. FIG. 7A shows the neighborhood of the connection portion of one end side of the data bus lines and the TAB terminal, and FIG. 7B shows the neighborhood of other end side of the data bus lines.

One end side of the data bus lines 55 is connected to the TAB terminal. The liquid crystal display device is connected to the TAB substrate via these TAB terminals 60. As shown in FIGS. 7A and 7B, the first repair wiring 62 that intersects with a plurality of data bus lines 55 are provided on one end side of the data bus lines 55. The first repair wiring 62 is connected to the spare TAB terminal 61 that is aligned in parallel with the TAB terminals 60. Also, repair terminals 55a are provided to the data bus lines 55 at the intersecting portions with the first repair wiring 62.

The second repair wiring 63, that passes through the repair terminals 55b provided to the end portions of the data bus lines 55, and a plurality of (two in FIG. 7B) third repair wirings 64 are provided to other end side of the data bus lines 55. The top end of the second repair wiring 63 is bended like the L-shape, and this top end portion intersects with the third repair wirings 64. The third repair wirings 64 are connected to the spare TAB terminals 65.

The above fault repairing method for the liquid crystal display device will be explained with reference to FIGS. 7A and 7B and FIGS. 8A and 8B hereunder. FIG. 8A is a sectional view taken along a XI-XI line in FIG. 7A, and FIG. 8B is a sectional view taken along a XII-XII line in FIG. 7B. It is on the assumption that the data bus lines 55 are disconnected at positions indicated by the X mark in FIGS. 8A and 8B. Also, in FIGS. 8A and 8B, a reference 71 denotes the first insulating film (gate insulating film) and a reference 72 denotes the second insulating film (protection insulating film).

First, as shown in FIG. 7A and FIG. 8A, the repair terminals 55a of the data bus lines 55 and the first repair wiring 62 are welded by virtue of the laser welding by irradiating the laser beam onto the intersecting portions of the data bus line 55, at which the disconnection occurs, and the first repair wiring 62.

Also, as shown in FIG. 7B and FIG. 8B, the intersecting portions of the second repair wiring 63 and the repair terminals 55a of the data bus lines 55 are electrically connected by the laser welding, and also the intersecting portions of the second repair wiring 63 and the third repair wirings 64 are electrically connected by the laser welding.

Then, the spare TAB terminal 61 and the TAB terminals 65 are electrically connected via the wire, etc. such that the same video signal can be supplied to both sides of the disconnected data bus line 55. As a result, it is possible to operate normally the liquid crystal display device.

However, according to the method shown in FIGS. 7A and 7B and FIGS. 8A and 8B, since the first repair wiring 62 and the second repair wiring 63 intersect with the data bus lines 55, capacitances are generated at the intersecting portions. With the progress of the larger size and higher definition of the liquid crystal display device in recent years, the wiring resistance of the repair wiring is increased and also the capacitance of the intersecting portion is increased. Therefore, sometimes the signal delay is increased and the thin line fault or spot fault occurs after the fault portion is repaired. As a result, there is the problem that the number of the repair wirings is limited.

### SUMMARY OF THE INVENTION

It is an object of the present invention to provide a fault repairing method for a liquid crystal display device for repairing a disconnection occurred in a wiring in a display area of the liquid crystal display device.

Also, it is another object of the present invention to provide a liquid crystal display device and its fault repairing method capable of repairing a fault without fail if the short-circuit is generated in the portion at which an electrode, that connects storage capacitance bus lines collectively, intersects with a gate bus line.

In addition, it is still another object of the present invention to provide a fault repairing method for a liquid crystal display device capable of repairing a pixel in which the fault occurs to restore it to a normal pixel and reducing a load capacitance, and a liquid crystal display device in which the fault can be easily repaired by its fault repairing method.

Further, it is yet still another object of the present invention to provide a liquid crystal display device and its fault repairing method capable of repairing a disconnection easily if the disconnection occurs in a gate bus line and a data bus line.

A fault repairing method for a liquid crystal display device set forth in claim 1 of the present invention, comprises the steps of forming first and second disconnection repairing contact holes, that have a width larger than a width of a disconnected wiring and a depth to expose an upper surface and both side surfaces of the disconnected wiring respectively, at two locations which are positioned to sandwich a disconnected portion of the disconnected wiring; and forming first and second conductive films, that are connected electrically to the upper surface and both side surfaces, on inner walls and surfaces of the first and second disconnection repairing contact holes to repair the disconnection.

According to the present invention, the disconnection repairing contact holes which have the width larger than the width of the disconnected wiring respectively are formed at two positions that puts the disconnected portion of the disconnected wiring between them respectively. Then, the disconnection can be repaired by forming the conductive films in the disconnection repairing contact holes by means of the laser CVD method, etc. to connect electrically the disconnection repairing contact holes. Accordingly, the contact area between the wiring and the repairing conductive films can be extended and the reliability of connection can be increased in contrast to the disconnection repairing method using the laser welding in the prior art.

According to the situation of the disconnection, the first and second conductive films can be directly connected, otherwise both the first and second conductive films can be connected to the pixel electrode to be connected electrically via the pixel electrode.

Also, a fault repairing method for a liquid crystal display device set forth in claim 5 of the present invention, comprises the steps of forming a conductive film over an area located between disconnection end portions of a disconnected wiring by a laser CVD method; and connecting electrically the conductive film and the disconnection end portions by a laser welding method to repair the disconnection.

According to the present invention, the conductive film is formed over the disconnected portion of the disconnected wiring by the laser CVD method. Then, the disconnection can be repaired by connecting electrically the conductive film and the end portions of the disconnection by virtue of the laser welding method. Accordingly, the wiring in which the disconnection occurs can be easily repaired.

Also, a liquid crystal display device set forth in claim 6 of the present invention, in which a liquid crystal is sealed between a first substrate, on which first and second wirings intersected via an insulating film are formed, and a second substrate that opposes to the first substrate, comprises spare wirings that are formed in vicinity of intersecting positions of the first and second wirings and constitute a part of a detour route used when an interlayer short-circuit between the first and second wirings is repaired.

Also, a liquid crystal display device set forth in claim 7 of the present invention, in which a liquid crystal is sealed between a first substrate, on which first and second wirings intersected via an insulating film are formed, and a second substrate that opposes to the first substrate, comprises spare pads that are connected to any one of the first and second wirings in vicinity of intersecting positions of the first and second wirings and constitute a part of a detour route used when an interlayer short-circuit between the first and second wirings is repaired.

Also, a fault repairing method for a liquid crystal display device set forth in claim 8 of the present invention, comprises the steps of disconnecting one wiring of first and second wirings in which an interlayer short-circuit occurs, at two locations that sandwich a short-circuit portion to separate electrically from other wiring; and forming a detour route to detouring the short-circuit portion to connect electrically disconnection end portions of one wiring.

In the fault repairing method for the liquid crystal display device according to the present invention, the detour route contains spare wirings, that are formed in vicinity of an intersecting position of the first and second wirings to repair an interlayer short-circuit between the first and second wirings, as a part of its configuration.

In the fault repairing method for the liquid crystal display device according to the present invention, the detour route contains spare pads, that are connected to any one of the first and second wirings in vicinity of an intersecting position of the first and second wirings to repair an interlayer short-circuit between the first and second wirings, as a part of its configuration.

According to the present invention, the short-circuit can be repaired by cutting off the wiring in which the short-circuit occurs on both sides of the short-circuited portion respectively and then forming the detour route to detour the short-circuited portion. At this time, the spare wiring formed previously in vicinity of the wiring, for example, can be employed as a part of the detour route. In this manner, the wiring in which the short-circuit is caused can be repaired.

Also, a liquid crystal display device set forth in claim 11 of the present invention, comprises a plurality of gate bus lines; a plurality of storage capacitance bus lines; a storage capacitance bus line general electrode connected commonly to the storage capacitance bus lines, and arranged to intersect with the plurality of gate bus lines to sandwich an insulating film; repairing auxiliary wirings that are intersected with the storage capacitance bus line general electrode to sandwich the insulating film and are provided electrically independently from the gate bus lines; and repairing connecting electrodes arranged on both sides of the storage capacitance bus lines in a width direction respectively, one ends of which overlap with the gate bus lines to sandwich the insulating film between them and other ends of which overlap with the repairing auxiliary wirings to sandwich the insulating film between them.

According to the present invention, since the repairing auxiliary wirings are provided electrically independently from the gate bus line, the identification of the short-circuited portion and the treated area can be facilitated. Accordingly, the repairing operation can be easily carried out and thus the fault repairing can be accomplished without fail.

Also, a fault repairing method for a liquid crystal display device set forth in claim 16 of the present invention, that includes switching thin film transistors that are connected to gate bus lines, data bus lines and pixel electrodes, and spare thin film transistors that are not connected to both the data bus lines and the pixel electrodes, comprises the step of forming a conductive pattern, that connects at least a drain electrode of a spare thin film transistor and a data bus line, in repairing a fault.

Also, a fault repairing method for a liquid crystal display device set forth in claim 21 of the present invention, that includes switching thin film transistors that are connected to gate bus lines, data bus lines and pixel electrodes, and spare thin film transistors that are not connected to both the data bus lines and the pixel electrodes, comprises the step of forming a conductive pattern, that connects at least a gate electrode of a spare thin film transistor and a gate bus line, in repairing a fault.

According to the present invention, the spare thin film transistors are prepared previously in addition to the switching thin film transistors. In the spare thin film transistor, for example, a part of the gate bus line may be formed as the gate electrode, or the gate electrode may be formed between the pixel electrode and the data bus line. In the situation before the fault repairing is carried out, the spare thin film transistor is neither connected to the pixel electrode nor any one of the gate bus line and the data bus line. Accordingly, the increase in the load capacitance can be avoided and also the reduction in the display quality can be prevented.

Furthermore, according to the present invention, in repairing the defective pixel, the conductive pattern for connecting the drain electrode of the spare thin film transistor and the data bus line or the conductive pattern for connecting the gate electrode of the spare thin film transistor and the gate bus line is formed. This conductive pattern is formed by depositing the metal film by means of the laser CVD method or by laser-baking the conductive chemicals (conductive paste), for example. According to this method, the conductive pattern can be formed on the insulating film or the conductive film with good adhesiveness. Also, the source electrode of the spare thin film transistor is connected to the pixel electrode by the melt-joint using the laser, for example. According to the present invention, since the pixel can be driven by the spare thin film transistor by connecting the spare thin film transistor, the pixel electrode, the gate bus line, and the data bus line in this manner, the high quality image display without fault can be achieved.

Also, a fault repairing method for a liquid crystal display device set forth in claim 28 of the present invention, that includes a plurality of bus lines formed on a substrate, TAB terminals arranged along a first side of the substrate and connected to the bus lines respectively, and repair wirings arranged along a second side opposing to the first side, comprises the step of forming at least a conductive pattern for connecting electrically a bus line and a repair wiring, in repairing the fault.

According to the present invention, when the disconnection occurs in the bus line, the conductive pattern for connecting the end portion of the disconnection opposite to the TAB terminal of the bus line and the repair wiring is formed. That is, since the repair wiring does not overlap with the bus line before the fault repairing is carried out, the load capacitance is small and thus the signal delay can be prevented. As a result, the degradation of the display quality due to the repair wiring can be avoided.

According to the present invention, the conductive pattern can be formed by the laser CVD method or by baking the conductive chemicals (conductive paste), for example. The conductive pattern can be formed on the insulating film with good adhesiveness by using these methods.

### BRIEF DESCRIPTION OF THE DRAWINGS

FIG. 1 is a top view showing a configuration of a liquid crystal display device;

FIG. 2 is a view (#1) showing a configuration of the liquid crystal display device in the prior art, i.e., an enlarged view showing a portion encircled by a broken line in FIG. 1;

FIG. 3 is a view (#2) showing a configuration of the liquid crystal display device in the prior art, i.e., a view showing an example of an intersecting portion of a storage capacitance bus line general electrode and a gate bus line;

FIG. 4 is a view (#3) showing a configuration of the liquid crystal display device in the prior art, i.e., a view showing another example of the intersecting portion of the storage capacitance bus line general electrode and the gate bus line;

FIG. 5 is a sectional view showing a configuration of a normal TN type liquid crystal display device in the prior art;

FIG. 6 is a plan view showing a TFT substrate of the same liquid crystal display device in the prior art;

FIGS. 7A and 7B are schematic plan views showing a method of repairing disconnection of a gate bus line in the prior art respectively;

FIGS. 8A and 8B are sectional views showing the method of repairing the disconnection of the gate bus line in the prior art respectively;

FIG. 9 is a plan view showing a schematic configuration of a display panel of a liquid crystal display device serving as a premise of a liquid crystal display device and its fault repairing method according to a first embodiment of the present invention;

FIGS. 10A and 10B, FIGS. 11A and 11B, FIGS. 12A and 12B, FIGS. 13A and 13B, FIGS. 14A and 14B, and FIGS. 15A and 15B are schematic sectional views showing a method of manufacturing the display panel of the same liquid crystal display device respectively;

FIG. 16 is a plan view showing an outline of an example 1 of a fault repairing method for a liquid crystal display device according to a first embodiment of the present invention;

FIGS. 17A to 17D are sectional views showing the example 1 of the fault repairing method according to the first embodiment of the present invention;

FIG. 18 is a plan view showing an outline of an example 2 of a fault repairing method for a liquid crystal display device according to the first embodiment of the present invention;

FIGS. 19A to 19D are sectional views showing the example 2 of the fault repairing method according to the first embodiment of the present invention;

FIG. 20 is a plan view showing an outline of an example 3 of a fault repairing method for a liquid crystal display device according to the first embodiment of the present invention;

FIG. 21 is a plan view showing an outline of an example 4 of a fault repairing method for a liquid crystal display device according to the first embodiment of the present invention;

FIGS. 22A to 22D are sectional views showing the example 4 of the fault repairing method according to the first embodiment of the present invention;

FIG. 23 is a plan view showing an outline of an example 5 of a fault repairing method for a liquid crystal display device according to the first embodiment of the present invention;

FIGS. 24A to 24C are sectional views showing the example 5 of the fault repairing method according to the first embodiment of the present invention;

FIG. 25 is a plan view showing an outline of an example 6 of a fault repairing method for a liquid crystal display device according to the first embodiment of the present invention;

FIG. 26 is a plan view showing an outline of an example 7 of a fault repairing method for a liquid crystal display device according to the first embodiment of the present invention;

FIGS. 27A to 27D are sectional views showing the example 7 of the fault repairing method according to the first embodiment of the present invention;

FIG. 28 is a plan view showing an outline of an example 8 of a fault repairing method for a liquid crystal display device according to the first embodiment of the present invention;

FIG. 29 is a plan view showing an outline of an example 9 of a fault repairing method for a liquid crystal display device according to the first embodiment of the present invention;

FIGS. 30A to 30C are sectional views showing the example 9 of the fault repairing method according to the first embodiment of the present invention;

FIG. 31 is a plan view showing an outline of an example 10 of a fault repairing method for a liquid crystal display device according to the first embodiment of the present invention;

FIGS. 32A and 32B, FIGS. 33A and 33B, and FIGS. 34A and 34B are sectional views showing the example 10 of the fault repairing method according to the first embodiment of the present invention;

FIGS. 35A to 35D are views showing the principle of a liquid crystal display device and a fault repairing method according to a second embodiment of the present invention;

FIG. 36 is a plan view showing an outline of an example 1 of the liquid crystal display device and its fault repairing method according to the second embodiment of the present invention;

FIG. 37 is a schematic sectional view (#1) showing the example 1 of the fault repairing method according to the second embodiment of the present invention;

FIG. 38 is a schematic sectional view (#2) showing the example 1 of the fault repairing method according to the second embodiment of the present invention;

FIG. 39 is a plan view showing an outline of an example 2 of the liquid crystal display device and its fault repairing method according to the second embodiment of the present invention;

FIG. 40 is a schematic sectional view (#1) showing the example 2 of the fault repairing method according to the second embodiment of the present invention;

FIG. 41 is a schematic sectional view (#2) showing the example 2 of the fault repairing method according to the second embodiment of the present invention;

FIG. 42 is a plan view showing an outline of an example 3 of the liquid crystal display device and its fault repairing method according to the second embodiment of the present invention;

FIG. 43 is a schematic sectional view (#1) showing the example 3 of the fault repairing method according to the second embodiment of the present invention;

FIG. 44 is a schematic sectional view (#2) showing the example 3 of the fault repairing method according to the second embodiment of the present invention;

FIG. 45 is a plan view showing an outline of an example 4 of the liquid crystal display device and its fault repairing method according to the second embodiment of the present invention;

FIG. 46 is a schematic sectional view (#1) showing the example 4 of the fault repairing method according to the second embodiment of the present invention;

FIG. 47 is a schematic sectional view (#2) showing the example 4 of the fault repairing method according to the second embodiment of the present invention;

FIG. 48 is a plan view showing an outline of an example 5 of the liquid crystal display device and its fault repairing method according to the second embodiment of the present invention;

FIG. 49 is a schematic sectional view showing the example 5 of the fault repairing method according to the second embodiment of the present invention;

FIG. 50 is a plan view showing an outline of an example 6 of the liquid crystal display device and its fault repairing method according to the second embodiment of the present invention;

FIG. 51 is a schematic sectional view (#1) showing the example 6 of the fault repairing method according to the second embodiment of the present invention;

FIG. 52 is a schematic sectional view (#2) showing the example 6 of the fault repairing method according to the second embodiment of the present invention;

FIG. 53 is a schematic sectional view (#3) showing the example 6 of the fault repairing method according to the second embodiment of the present invention;

FIG. 54 is a view (#1) showing the principle of the invention used in a third embodiment of the present invention;

FIG. 55 is a view (#2) showing the principle of the invention used in the third embodiment of the present invention, i.e., a view showing a short-circuit repairing method;

FIG. 56 is a view (#3) showing the principle of the invention used in the third embodiment of the present invention, i.e., a sectional view taken along a I-I line in FIG. 55;

FIG. 57 is a view showing a short-circuit repairing method according to a third embodiment of the present invention;

FIG. 58 is a view showing a part of FIG. 57 in an enlarged manner;

FIG. 59 is a sectional view taken along a II-II line in FIG. 58;

FIG. 60 is a plan view showing a TFT substrate of a liquid crystal display device according to a fourth embodiment of the present invention;

FIG. 61 is a plan view showing a fault repairing method for the liquid crystal display device according to the fourth embodiment of the present invention;

FIGS. 62A to 62C are schematic sectional views showing the fault repairing method for the liquid crystal display device according to the fourth embodiment of the present invention;

FIGS. 63A to 63C are schematic sectional views showing a fault repairing method for a liquid crystal display device according to a fifth embodiment of the present invention;

FIG. 64 is a plan view showing a TFT substrate of a liquid crystal display device according to a sixth embodiment of the present invention;

FIG. 65 is a plan view showing a fault repairing method for the liquid crystal display device according to the sixth embodiment of the present invention;

FIG. 66 is a plan view showing a TFT substrate of a liquid crystal display device according to a seventh embodiment of the present invention;

FIG. 67 is a plan view showing a fault repairing method for the liquid crystal display device according to the seventh embodiment of the present invention;

FIG. 68 is a sectional view taken along a III-III line in FIG. 67;

FIG. 69 is a schematic view showing a TFT substrate of a liquid crystal display device according to an eighth embodiment of the present invention;

FIGS. 70A and 70B are schematic views showing an example of a fault repairing method according to the eighth embodiment of the present invention;

FIGS. 71A and 71B are sectional views taken along a IV-IV line and a V-V line in FIG. 70A and 70B respectively;

FIGS. 72A and 72B are views showing another example of the fault repairing method according to the eighth embodiment of the present invention, i.e., views showing an example in which repair terminals and repair wirings are arranged on the outside of a CF substrate;

FIGS. 73A and 73B are schematic views showing a fault repairing method according to a ninth embodiment of the present invention; and

FIGS. 74A and 74B are sectional views taken along a VI-VI line and a VII-VII line in FIGS. 73A and 73B respectively.

### DESCRIPTION OF THE PREFERRED EMBODIMENTS

Embodiments of the present invention will be explained in detail with reference to the accompanying drawings hereinafter.

(First Embodiment)

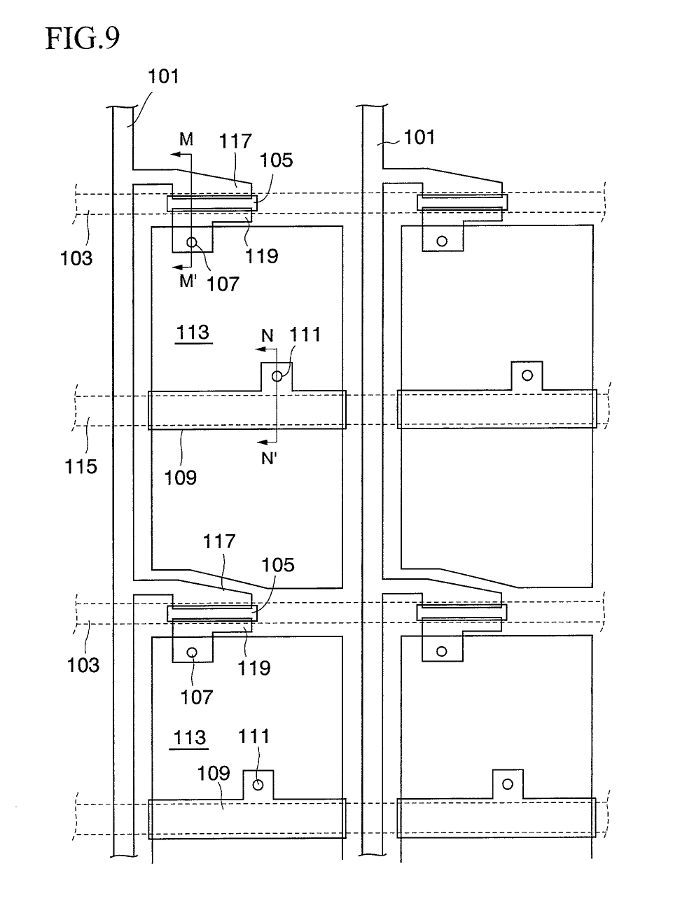

A fault repairing method for a liquid crystal display device according to a first embodiment of the present invention will be explained with reference to FIG. 9 to FIG. 34B hereunder. FIG. 9 is a plan view showing a schematic configuration of a display panel of a liquid crystal display device serving as a premise of a liquid crystal display device and its fault repairing method according to the first embodiment of the present invention. FIG. 9 shows the substrate side when a TFT substrate of a liquid crystal display panel is viewed from the liquid crystal layer side.

As shown in FIG. 9, a plurality of data bus lines 101 extended in the longitudinal direction in FIG. 9 are formed on the substrate. Also, a plurality of gate bus lines 103 indicated by a broken line extended in the lateral direction in FIG. 9 are formed on the substrate. Respective areas that are defined by the data bus lines 101 and the gate bus lines 103 are pixel areas. Then, TFTs are formed in vicinity of the intersection position of the data bus lines 101 and the gate bus lines 103.

A drain electrode 117 of the TFT is extracted from the left side data bus line 101, and is formed such that one end portion of the drain electrode 117 is positioned at one end side on a channel protection film 105 formed on the gate bus line 103.

Meanwhile, a source electrode 119 is formed such that it is positioned at other end side on the channel protection film 105. In such configuration, the portion of the gate bus line 103 positioned immediately under the channel protection film 105 functions as the gate electrode of the TFT. Although not shown, the gate insulating film is formed on the gate bus line 103 and then a semiconductor film constituting the channel is formed thereon.

Also, a storage capacitance bus line 115 is formed in the area indicated by a broken line extended laterally in the almost middle of the pixel area. A storage capacitance electrode 109 is formed over the storage capacitance bus line 115 via an insulating film every pixel. The source electrode 119 and the storage capacitance electrode 109 are covered with an insulating protection film. A pixel electrode 113 made of a transparent electrode is formed on the insulating protection film.

The pixel electrode 113 is connected electrically to the source electrode 119 via a contact hole 107 provided in the insulating protection film. Also, the pixel electrode 113 is connected electrically to the storage capacitance electrode 109 via a contact hole 111.

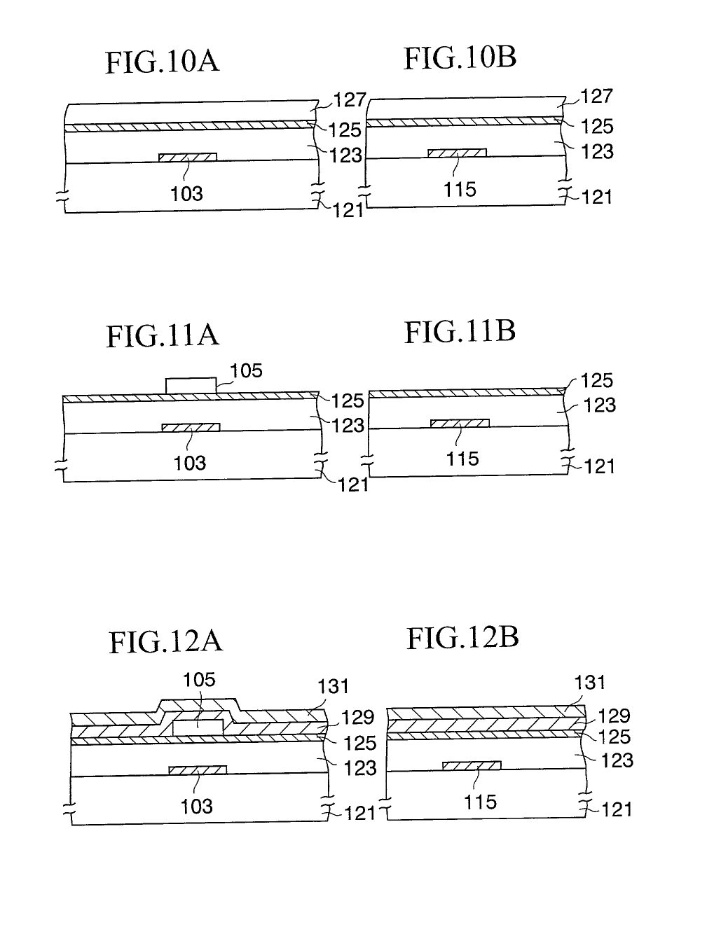

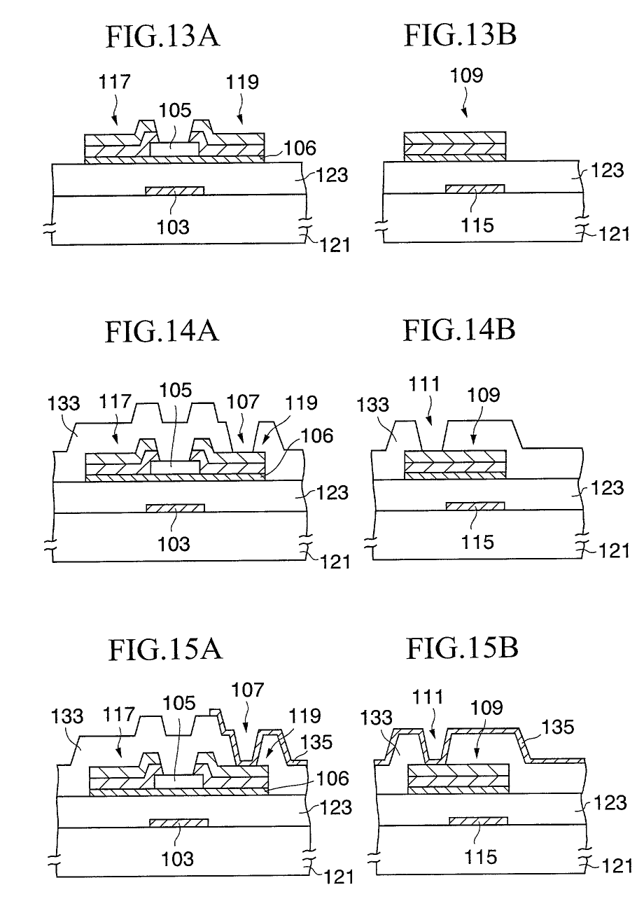

Next, a method of manufacturing the liquid crystal display device shown in FIG. 9 will be explained with reference to FIGS. 10A and 10B, FIGS. 11A and 11B, FIGS. 12A and 12B, FIGS. 13A and 13B, FIGS. 14A and 14B, and FIGS. 15A and 15B hereunder. In FIG. 10A to FIG. 15B, the same symbols are affixed to the same constituent elements as those shown in FIG. 9. Also, FIG. 10A, FIG. 11A, FIG. 12A, FIG. 13A, FIG. 14A, and FIG. 15A show a sectional shape of the TFT taken along an M-M′ line in FIG. 9 respectively, and FIG. 10B, FIG. 11B, FIG. 12B, FIG. 13B, FIG. 14B, and FIG. 15B show a sectional shape of the storage capacitor portion taken along an N-N′ line in FIG. 9 respectively.

First, as shown in FIGS. 10A and 10B, a metal film of about 150 nm thickness is formed on a transparent glass substrate 121 by forming Al (aluminum), for example, on the overall surface. Then, the gate bus line 103 (see FIG. 10A) and the storage capacitance bus line 115 (see FIG. 10B) are formed by patterning this metal film by using a first mask. Then, a gate insulating film 123 of about 40 nm thickness is formed by forming a silicon nitride (SiN) film, for example, on the overall surface of the substrate by virtue of the plasma CVD method. Then, an amorphous silicon (a-Si) film 125 serving as the channel of the TFT is formed on the overall surface of the substrate by the plasma CVD method to have a thickness of about 15 μm, for example. Then, a silicon nitride (SiN) film 127 serving as the channel protection film is formed on the overall surface by the plasma CVD method to have a thickness of about 120 nm, for example.

Then, a photoresist film is coated on the overall surface, then the back exposure is applied to the transparent glass substrate 121 while using the gate bus line 103 and the storage capacitance bus line 115 as a mask, and then the exposure using a second mask is carried out. Then, a resist pattern (not shown) is formed in a self-alignment manner on the gate bus line 103 by the developing process. Then, the channel protection film 105 is formed on the gate bus line 103 in the TFT forming region by etching the silicon nitride film 127 while using this resist pattern as a mask (see FIGS. 11A and 11B).

Then, as shown in FIGS. 12A and 12B, an n⁺ a-Si film 129 serving as an ohmic contact layer is formed on the overall surface by the plasma CVD method to have a thickness of about 30 nm, for example. Then, a metal layer (e.g., a Cr layer) 131 serving as the drain electrode 117, the source electrode 119, the storage capacitance electrode 109, and the data bus line 101 is formed by the sputtering to have a thickness of about 170 nm, for example.

Then, as shown in FIGS. 13A and 13B, the data bus line 101 (not shown in FIGS. 13A and 13B), the drain electrode 117, the source electrode 119, the storage capacitance electrode 109, and the semiconductor film 106 are formed by etching the metal film 131, the n⁺ a-Si film 129, and the amorphous silicon film 125 while using a third mask. In this etching process, the channel protection film 105 can function as the etching stopper and thus the underlying amorphous silicon film 125 is not etched to remain.

Then, as shown in FIGS. 14A and 14B, a protection insulating film 133 made of a silicon nitride film, for example, is formed by the plasma CVD method to have a thickness of about 30 nm. Then, the protection insulating film 133 is patterned while using a fourth mask to form the contact hole 107 on the source electrode 119 and also form the contact hole 111 on the storage capacitance electrode 109.

Then, as shown in FIGS. 15A and 15B, a transparent pixel electrode material 135 made of ITO and having a thickness of about 70 nm, for example, is formed on the overall upper surface of the transparent glass substrate 121. Then, a pixel electrode 113 having a predetermined profile, as shown in FIG. 9, is formed by patterning the pixel electrode material 135 using as a fifth mask. The pixel electrode 113 is connected electrically to the source electrode 119 via the contact hole 107, and also is connected electrically to the storage capacitance electrode 109 via the contact hole 111.

The display panel of the liquid crystal display device shown in FIG. 9 can be completed via the steps described above. If the disconnection occurs in the wiring patterns such as the gate bus line 103, the data bus line 101, the storage capacitance bus line 115, etc. in the middle of above steps, the display panel can be restored to the non-defective unit by carrying out the fault repairing method according to embodiments shown in (A) to (G) described in the following.

(A) Two hole patterns are formed by coating the resist on the overall surface of the substrate, and then applying the spot-exposure or the laser beam irradiation to the resist film on two wiring patterns on both sides of the disconnected portion to pattern (develop) the resist film. The hole patterns are formed to have a length longer than a line width of the wiring pattern and to extend across the width of the wiring pattern.

(B) Then, two disconnection repairing contact holes are formed by dry-etching the insulating film (the protection insulating film 133 or the protection insulating film 133 and the insulating film 123) while using the resist film as a mask to expose the upper surface and side surfaces of the wiring pattern.

(C) The disconnection repairing contact holes are filled with a laser CVD film made of organic metal compound by virtue of the laser CVD (Chemical Vapor Deposition) method using the laser beam.

(D) The laser CVD films that are filled in the disconnection repairing contact holes are connected via the laser CVD film. Otherwise, (E) respective laser CVD films that are filled in two disconnection repairing contact holes are connected to the same pixel electrode by using the laser CVD method. Otherwise, (F) the laser CVD films that are filled in two disconnection repairing contact holes are connected to different pixel electrodes via the laser CVD film respectively, and then the pixel electrodes are connected via the laser CVD film. At this time, the connection between the drain electrode of the TFT connected to one or both of the pixel electrodes and the data bus line should be disconnected.

Alternatively, (G) the disconnection repairing contact holes are not provided, but the laser CVD film that is wider than the disconnected wiring pattern is formed on the protection film at the disconnection portion to cross the disconnection portion. Then, the laser CVD film and both end portions of the disconnected wiring pattern are connected on both end sides of the disconnection portion by the laser welding method.

According to the disconnection fault repairing method of the first embodiment, at least five advantages described in the following can be achieved. First, since the disconnection repairing contact holes are formed by dry-etching the insulating film prior to the formation of the pixel electrode, such disconnection repairing contact holes can be formed with good precision, without the contamination of the pixel electrode caused by the laser beam irradiation, unlike the prior art. Second, since the disconnection repairing contact holes are formed to expose the side surfaces of the wiring pattern also, the contact area can be spread and the reliability of connection can be enhanced rather than the case where the contact holes are formed only on the wiring pattern.

Third, since the disconnection repairing contact holes are formed merely at one location on both sides of the disconnection portion respectively, such contact holes can be filled simply with the laser CVD film without fail rather than the case where a plurality of contact holes are provided. Fourth, since the detour connection can be accomplished by using the laser CVD film via the pixel electrode, the long disconnection portion can be repaired. Thus, most of the disconnection faults or the interlayer short-circuit faults can be relieved.

Fifth, since the laser CVD films can be locally formed on the insulating film at the disconnection portion and then they can be connected from the back surface or the front surface by the laser welding, such laser CVD films can be connected simply not to increase the number of masks. In this case, since there is no necessity to form the disconnection repairing contact holes, the repairing operation can be performed in the middle of the steps as occasion demands.

Then, the fault repairing method according to the first embodiment will be explained with reference to particular examples hereunder.

### EXAMPLE 1

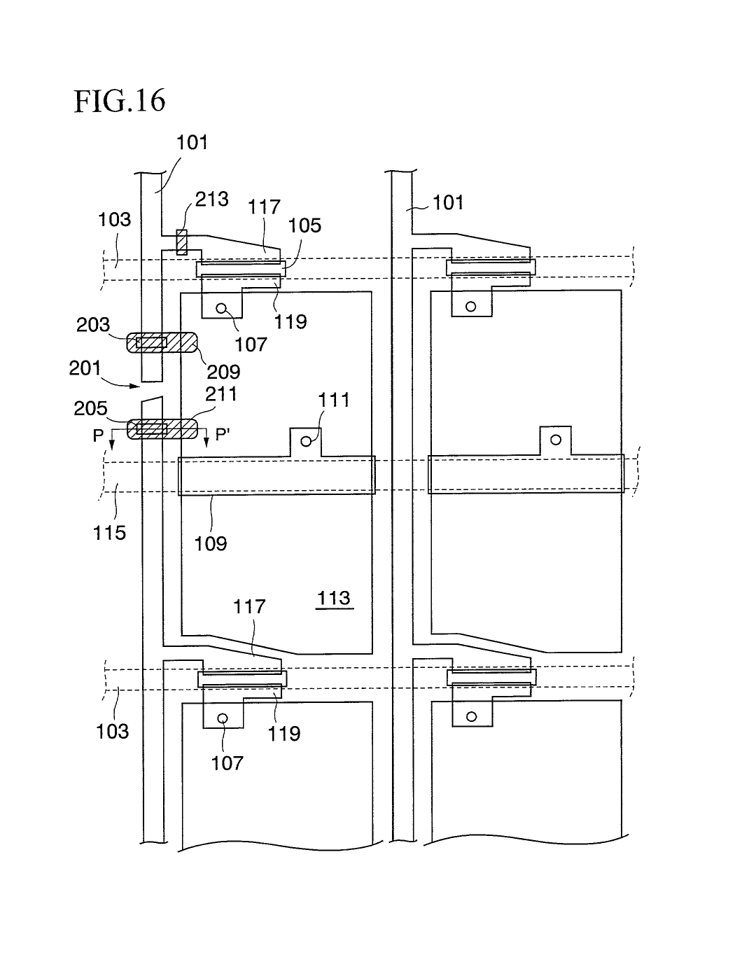

FIG. 16 shows a substrate surface when the TFT substrate of the liquid crystal display panel is viewed from the liquid crystal layer side, like FIG. 9. In FIG. 16, the same symbols are affixed to the same constituent elements as those shown in FIG. 9. FIG. 16 shows such a situation that the data bus line 101 located on the left side in FIG. 16 is disconnected at a disconnected portion 201 between the gate bus line 103 located on the upper side in FIG. 16 and the storage capacitance bus line 115.

First, disconnection repairing contact holes 203, 205 whose widths are larger than the width of the data bus line 101 are formed on disconnection end portions of the data bus line 101 on both ends of the disconnected portion 201 respectively to cross the data bus line 101. The data bus line 101 containing its side surfaces is exposed from the disconnection repairing contact holes 203, 205. Then, the data bus line 101 in the disconnection repairing contact holes 203, 205 and the pixel electrode 113 are connected by laser CVD films 209, 211 respectively. Also, the drain electrode 117 of the TFT of the pixel that is located in the neighborhood of the disconnected portion 201 is separated from the data bus line 101 by irradiating the laser beam to a cutting position 213 at the root portion of the drain electrode 117. In this manner, the disconnection fault occurred in the data bus line (drain bus line) 101 can be repaired surely.

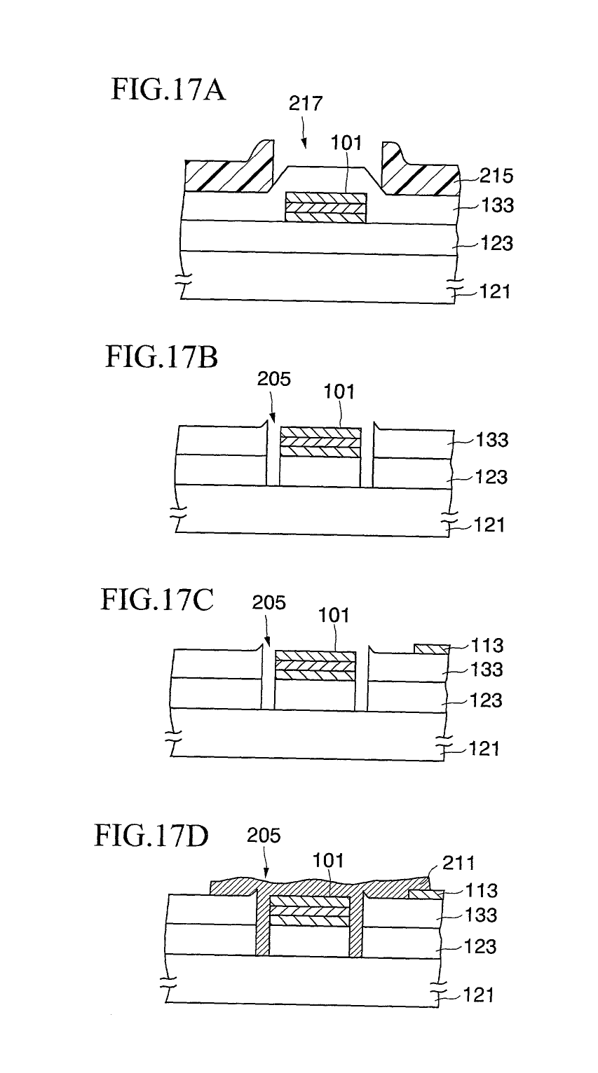

The disconnection repairing method in the example 1 will be explained in more detail with reference to FIGS. 17A to 17D hereunder. FIGS. 17A to 17D show a sectional shape in vicinity of the data bus line 101 taken along a P-P′ line in FIG. 16 respectively. In this case, the same symbols are affixed to the same constituent elements as those shown in FIG. 10A to FIG. 15B. Similarly, the same symbols are affixed to the same constituent elements as those in the accompanying drawings in the following explanation.

It is on the assumtion that the disconnection inspection of the gate bus lines 103 and the data bus lines 101 has been carried out before the contact holes 107, 111 shown in FIG. 16 are formed, and that the disconnected portion 201 of the data bus line 101 shown in FIG. 16 is found as the result of the disconnection inspection.

In order to form the contact holes 107 and 111, a resist film 215 is formed by coating the photoresist on the overall surface of the substrate. Then, as shown in FIG. 17A, a hole 217 that has a width larger than the width of the data bus line 101 is formed by applying the spot-exposure or the laser beam irradiation (e.g., excimer laser beam irradiation) to the resist film 215 on the disconnection end portions of the data bus line 101 on both sides of the disconnected portion 201 and then patterning (developing) the resist film 215.

Then, as shown in FIG. 17B, the formation of the contact holes 107, 111 and the window opening of the terminal portion (not shown) are carried out by the selective etching using the dry etching. At the same time, by selectively etching the inside of the hole 217, an upper surface of the disconnection end portion of the data bus line 101 is exposed, and also the disconnection repairing contact hole 205 reaching the surface of the glass substrate 121 is formed on both sides of the data bus line 101 in the width direction. Similarly, the disconnection repairing contact hole 203 is also formed.

Then, as shown in FIG. 17C, the pixel electrode 113 is formed by forming the film of the transparent electrode material such as ITO, etc. on the overall surface of the substrate and then patterning the film.

Then, as shown in FIG. 17D, a laser CVD film 211 for connecting the inside of the disconnection repairing contact hole 205 and the pixel electrode 113 is formed by the laser CVD method. Similarly, a laser CVD film 209 for connecting the inside of the disconnection repairing contact hole 203 and the pixel electrode 113 is formed by the laser CVD method.

In this manner, as shown in FIG. 16, one disconnection end portion and the other disconnection end portion of the data bus line 101 are connected electrically by the laser CVD film 209, that is formed between the disconnection repairing contact hole 203 and the pixel electrode 113, and the laser CVD film 211, that is formed between the disconnection repairing contact hole 205 and the pixel electrode 113. Thus, the disconnection fault can be repaired.

According to this example 1, since the disconnection repairing contact holes are formed by dry-etching the insulating film prior to the formation of the pixel electrode, such disconnection repairing contact holes can be formed with good precision, without the contamination of the pixel electrode caused by the laser beam irradiation, unlike the prior art. Also, the repairing operation can be carried out not to increase the number of masks.

In addition, since the disconnection repairing contact holes are formed to have the width larger than the data bus line, the contact area can be spread and the reliability of connection can be enhanced rather than the case where the contact holes are formed only on the data bus line.

Further, since the disconnection repairing contact holes are formed merely at one location on both sides of the disconnection portion respectively, such contact holes can be filled simply with the laser CVD film without fail rather than the case where a plurality of contact holes are provided.

Moreover, since the detour connection can be accomplished by using the laser CVD film via the pixel electrode, the long disconnection portion can be repaired. Thus, most of the disconnection faults or the interlayer short-circuit faults can be relieved.

### EXAMPLE 2

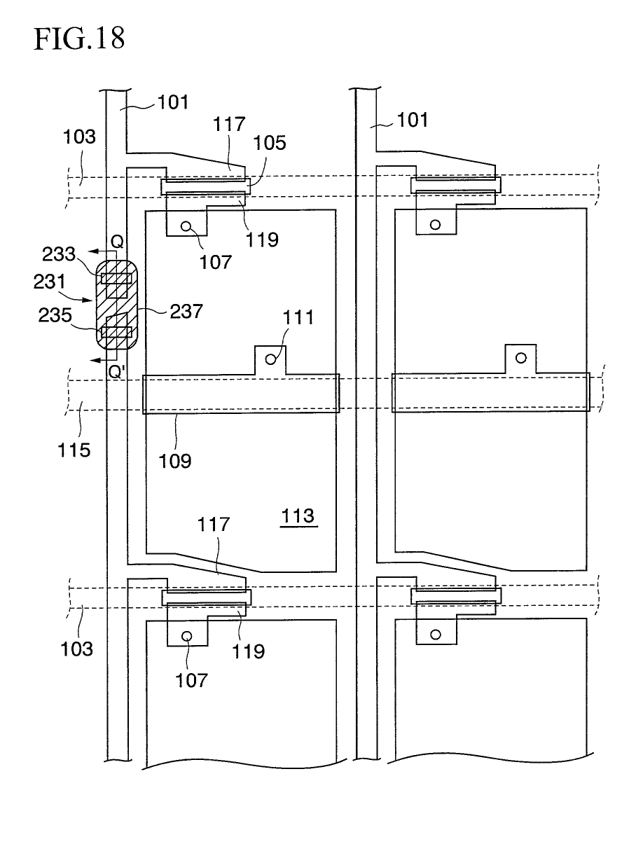

FIG. 18 shows a substrate surface when the TFT substrate of the liquid crystal display panel is viewed from the liquid crystal layer side, like FIG. 9. FIG. 18 shows such a situation that, like the example 1, the data bus line 101 located on the left side in FIG. 18 is disconnected at a disconnected portion 231 between the gate bus line 103 located on the upper side in FIG. 18 and the storage capacitance bus line 115.

First, disconnection repairing contact holes 233, 235 whose widths are larger than the width of the data bus line 101 are formed on disconnection end portions of the data bus line 101 on both ends of the disconnected portion 201 respectively to cross the data bus line 101. Then, the disconnection end portions of the data bus line 101 in the disconnection repairing contact holes 233, 235 are connected by a laser CVD film 237. In this manner, the disconnection fault occurred in the data bus line 101 can be repaired firmly.

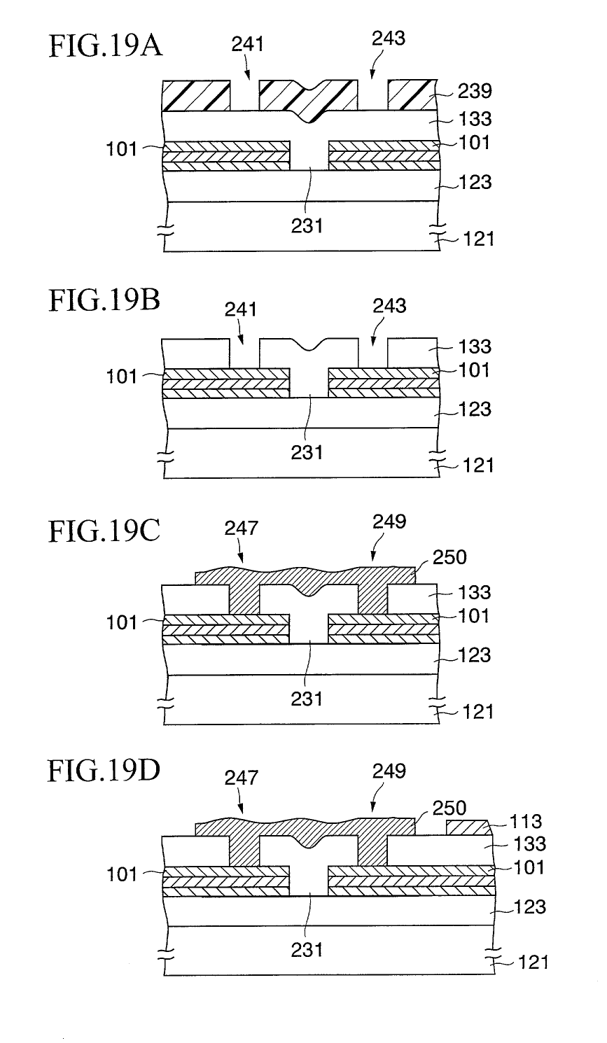

The disconnection repairing method in the example 2 will be explained in more detail with reference to FIGS. 19A to 19D hereunder. FIGS. 19A to 19D show a sectional shape in vicinity of the data bus line 101 taken along a Q-Q′ line in FIG. 18 respectively. It is on the assumption that the disconnection inspection of the gate bus lines 103 and the data bus lines 101 has been carried out before the contact holes 107, 111 shown in FIG. 18 are formed, and that the disconnected portion 231 of the data bus line 101 shown in FIG. 18 is found as the result of the disconnection inspection.

In order to form the contact holes 107 and 111, a resist film 239 is formed by coating the photoresist on the overall surface of the substrate. Then, as shown in FIG. 19A, holes 241, 243 that have a width larger than the width of the data bus line 101 respectively are formed by applying the spot-exposure or the laser beam irradiation to the resist film 239 on the disconnection end portions of the data bus line 101 on both sides of the disconnected portion 231 and then patterning the resist film 239.

Then, as shown in FIG. 19B, the formation of the contact holes 107, 111 and the window opening of the terminal portion (not shown) are carried out by the selective etching using the dry etching. At the same time, by selectively etching the inside of the holes 241, 243, the upper surface of the disconnection end portion of the data bus line 101 is exposed, and also disconnection repairing contact holes 247, 249 reaching the surface of the glass substrate 121 are formed on both sides of the data bus line 101 in the width direction.

Then, as shown in FIG. 19C, a laser CVD film 250 for connecting the insides of the disconnection repairing contact holes 247, 249 and the data bus line 101 is formed by the laser CVD method. Then, as shown in FIG. 19D, the pixel electrode 113 is formed by forming the film of the transparent electrode material such as ITO, etc. on the overall surface of the substrate and then patterning the film.

In this manner, as shown in FIG. 18, one disconnection end portion and the other disconnection end portion of the data bus line 101 are connected electrically by the laser CVD film 237 that is formed between the disconnection repairing contact holes 233, 235. Thus, the disconnection fault can be repaired.

According to this example 2, since the disconnection repairing contact holes are formed by dry-etching the insulating film prior to the formation of the pixel electrode, such disconnection repairing contact holes can be formed with good precision, without the contamination of the pixel electrode caused by the laser beam irradiation, unlike the prior art. Also, the repairing operation can be carried out not to increase the number of masks.

In addition, since the disconnection repairing contact holes are formed to have the width larger than the data bus line, the contact area can be spread and the reliability of connection can be enhanced rather than the case where the contact holes are formed only on the data bus line.

In this case, the connection of the wirings by the laser CVD method may be carried out after the pixel electrode has been formed.

### EXAMPLE 3

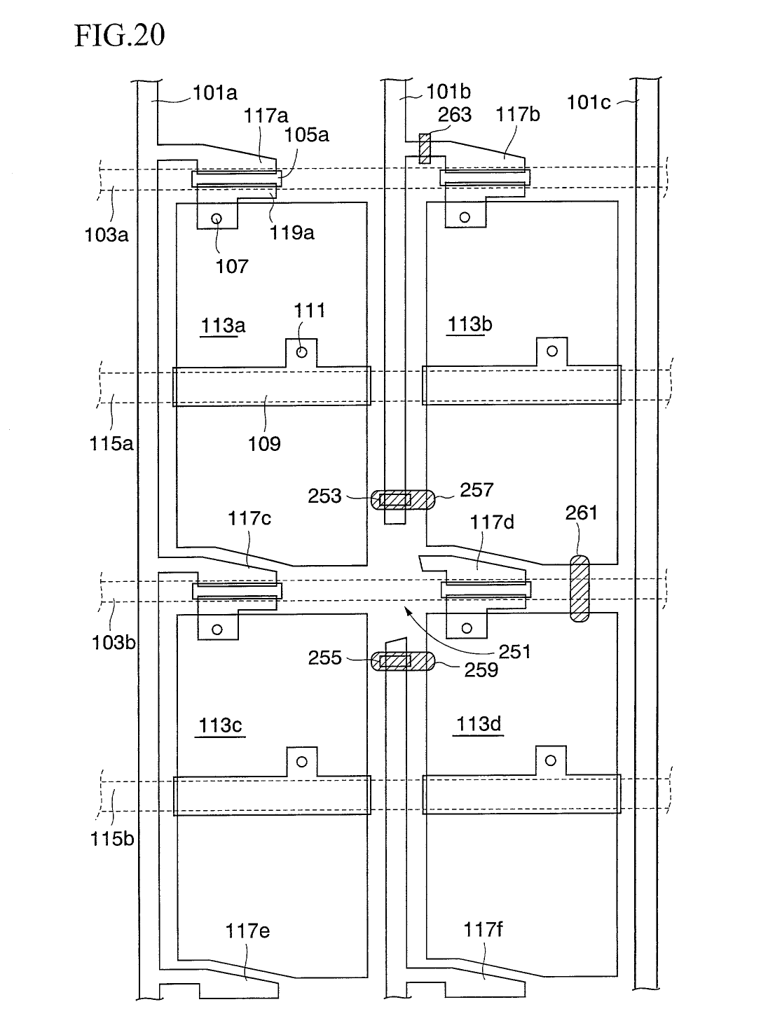

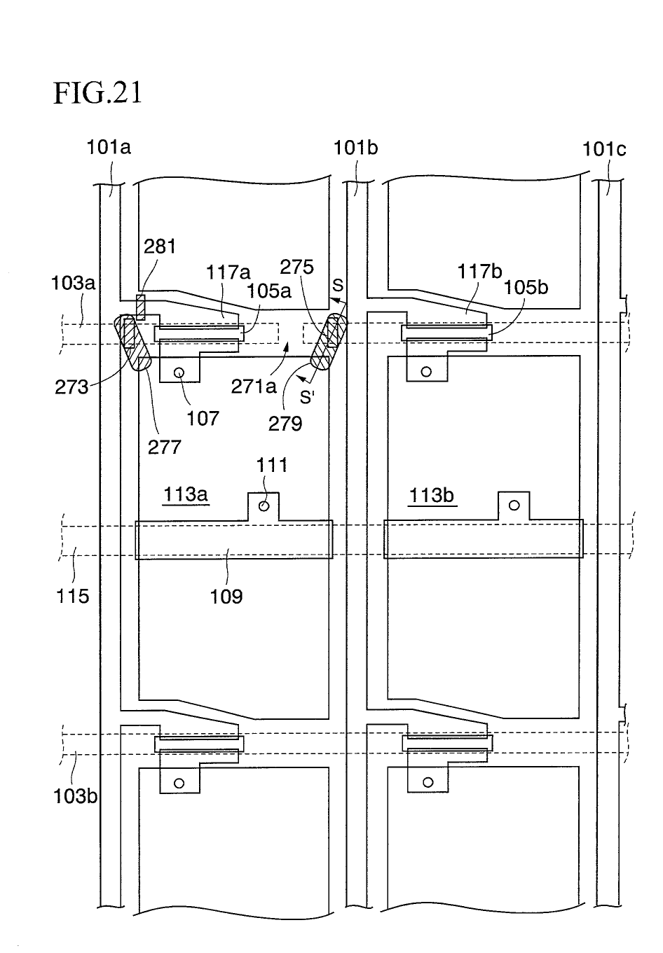

FIG. 20 shows a substrate surface when the TFT substrate of the liquid crystal display panel is viewed from the liquid crystal layer side, like FIG. 9. FIG. 20 shows pixel electrodes 113a, 113b, 113c, 113d in four pixel areas that are defined by three data bus lines 101a, 101b, 101c and three gate bus lines 103a, 103b, 103c. A storage capacitance bus line 115a or 115b is formed in each pixel area.

FIG. 20 shows such a situation that the data bus line 101b is disconnected at a disconnected portion 251 that extends over two pixel areas to cross the gate bus line 103b, and thus the connection between the drain electrode 117d of the TFT connected to the pixel electrode 113d and the data bus line 101b is cut off.

In this Example 3, first, disconnection repairing contact holes 253, 255 whose width is larger than the width of the data bus line 101b are formed on disconnection end portions of the data bus line 101b located on both sides of the disconnected portion 251 respectively, like the example 1. Then, the laser CVD film 257 that connects the data bus line 101b in the disconnection repairing contact hole 253 and the left side end of the pixel electrode 113b is formed, and similarly the laser CVD film 259 that connects the data bus line 101b in the disconnection repairing contact hole 255 and the left side end of the pixel electrode 113d is formed. Also, the laser CVD film 261 that directly connects the lower side end of the pixel electrode 113b and the upper side end of the pixel electrode 113d. In this case, prior to the formation of the pixel electrodes 113a to 113d, the drain electrode 117b of the TFT connected to the pixel electrode 113b is separated from the data bus line 101b by irradiating the laser beam to a cutting position 263 at the root portion of the drain electrode 117b so as to cut off the connection to the data bus line 101b.

As a result, one disconnection end portion of the data bus line 101b is connected to the pixel electrode 113b via the laser CVD film 257 in the disconnection repairing contact hole 253, and the other disconnection end portion of the data bus line 101b is connected to the pixel electrode 113d via the laser CVD film 259 in the disconnection repairing contact hole 255, and the pixel electrode 113b and the pixel electrode 113d are connected by the laser CVD film 261. Therefore, the electrical connection can be routed to detour the disconnected portion 251 of the data bus line 101b. In addition, since the disconnection repairing contact holes 253, 255 are formed in the same way as the examples 1, 2, the electrical connection with the high reliability can be obtained similarly.

### EXAMPLE 4

FIG. 21 shows a substrate surface when the TFT substrate of the liquid crystal display panel is viewed from the liquid crystal layer side, like FIG. 9. In FIG. 21, three data bus lines 101a, 101b, 101c and two gate bus lines 103a, 103b are shown, and two pixel areas (pixel electrodes 113a, 113b) defined by these bus lines are shown. Also, the storage capacitance bus line 115 to traverse two pixel areas is shown.

In addition, in FIG. 21, the gate bus line 103a is disconnected (disconnected portion 271) between the channel protection film 105a of the TFT, that is connected to the data bus line 111a, and the data bus line 101b.

First, disconnection repairing contact holes 273, 275 whose width is larger than the width of the gate bus line 103a are formed on the gate bus line 103a in vicinity of corner portions of the pixel electrode 113a respectively. Then, the laser CVD films 277, 279 that connects the gate bus line 103a in the disconnection repairing contact holes 273, 275 and the pixel electrode 113a are formed. In this case, the drain electrode 117a of the TFT connected to the pixel electrode 113a is separated from the data bus line 101a by irradiating the laser beam to a cutting position 281 at the root portion of the drain electrode 117a so as to cut off the connection to the data bus line 101a.

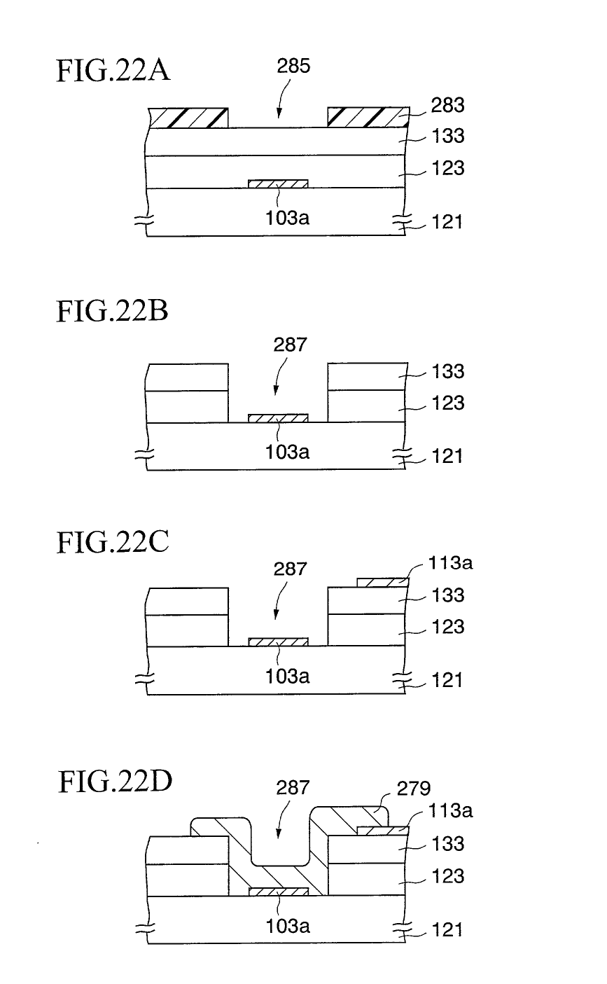

The disconnection repairing method in the example 4 will be explained in more detail with reference to FIGS. 22A to 22D hereunder. FIGS. 22A to 22D show a sectional shape in vicinity of the gate bus line 103a taken along an S-S′ line in FIG. 21 respectively. It is on the assumption that the disconnection inspection of the gate bus lines 103 and the data bus lines 101 has been carried out before the contact holes 107, 111 shown in FIG. 21 are formed, and that the disconnected portion 271 of the gate bus line 103a shown in FIG. 21 is found as the result of the disconnection inspection.

In order to form the contact holes 107 and 111, a resist film 283 is formed by coating the photoresist on the overall surface of the substrate. Then, as shown in FIG. 22A, a resist hole 285 that has a width larger than the width of the gate bus line 103a is formed by applying the spot-exposure or the laser beam irradiation to the resist film 283 on the disconnection end portions of the gate bus line 103a on both sides of the disconnected portion 271 (see FIG. 21) and then patterning (developing) the resist film 283.

Then, as shown in FIG. 22B, the formation of the contact holes 107, 111 and the window opening of the terminal portion (not shown) are carried out by the selective etching using the dry etching. At the same time, by selectively etching the inside of the hole 285, an upper surface of the disconnection end portion of the gate bus line 103a is exposed, and also the disconnection repairing contact hole 287 reaching the surface of the glass substrate 121 is formed on both sides of the gate bus line 103a in the width direction.

Then, as shown in FIG. 22C, the pixel electrode 113 is formed by forming the film of the transparent electrode material such as ITO, etc. on the overall surface of the substrate and then patterning the film. Then, as shown in FIG. 22D, a laser CVD film 279 for connecting the gate bus line 103a in the disconnection repairing contact hole 287 and the pixel electrode 113a is formed by the laser CVD method. Similarly, a laser CVD film 277 for connecting the gate bus line 103a in the disconnection repairing contact hole 273 and the pixel electrode 113a is formed by the laser CVD method.

In this manner, as shown in FIG. 21, one disconnection end portion and the other disconnection end portion of the gate bus line 103a are connected electrically by the laser CVD film 277, that is formed between the disconnection repairing contact hole 273 and the pixel electrode 113a, and the laser CVD film 279, that is formed between the disconnection repairing contact hole 275 and the pixel electrode 113a. Thus, the disconnection fault can be repaired.

According to this example 4, since the disconnection repairing contact holes are formed by dry-etching the insulating film before the formation of the pixel electrode, such disconnection repairing contact holes can be formed with good precision, without the contamination of the pixel electrode caused by the laser beam irradiation, unlike the prior art. Also, the repairing operation can be carried out not to increase the number of masks.

In addition, since the disconnection repairing contact holes are formed to have the width larger than the data bus line, the contact area can be spread and the reliability of connection can be enhanced rather than the case where the contact holes are formed only on the data bus line.

Further, since the disconnection repairing contact holes are formed merely at one location on both sides of the disconnection portion respectively, such contact holes can be filled simply with the laser CVD film without fail rather than the case where a plurality of contact holes are provided.

Moreover, since the detour connection can be accomplished by using the laser CVD film via the pixel electrode, the long disconnection portion can be repaired. Thus, most of the disconnection faults can be relieved.

### EXAMPLE 5

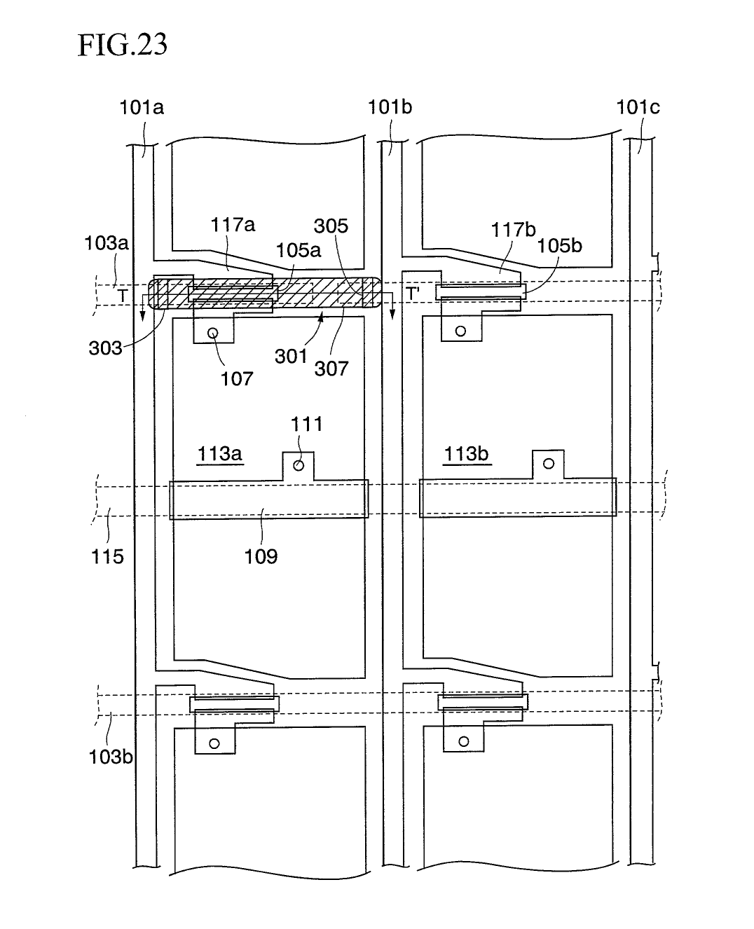

FIG. 23 shows a substrate surface when the TFT substrate of the liquid crystal display panel is viewed from the liquid crystal layer side, like FIG. 9. In FIG. 23, three data bus lines 101a, 101b, 101c and two gate bus lines 103a, 103b are shown, and also two pixel areas (pixel electrodes 113a, 113b) defined by these bus lines are shown. Also, the storage capacitance bus line 115 to traverse two pixel areas is shown.

In FIG. 23, the gate bus line 103a is disconnected at a disconnected portion 301 between the channel protection film 105a of the TFT, that is connected to the data bus line 101a, and the data bus line 101b.

First, disconnection repairing contact holes 303, 305 whose width is larger than the width of the gate bus line 103a are formed on the disconnected end portions of the gate bus line 103a on both ends of the disconnected portion 301 respectively. The gate bus line 103a containing its side surfaces are exposed in the disconnection repairing contact holes 303, 305. Then, a laser CVD film 307 that connects the gate bus line 103a in the disconnection repairing contact holes 303, 305 is formed. In this manner, the disconnection fault occurred in the gate bus line can be repaired without fail.

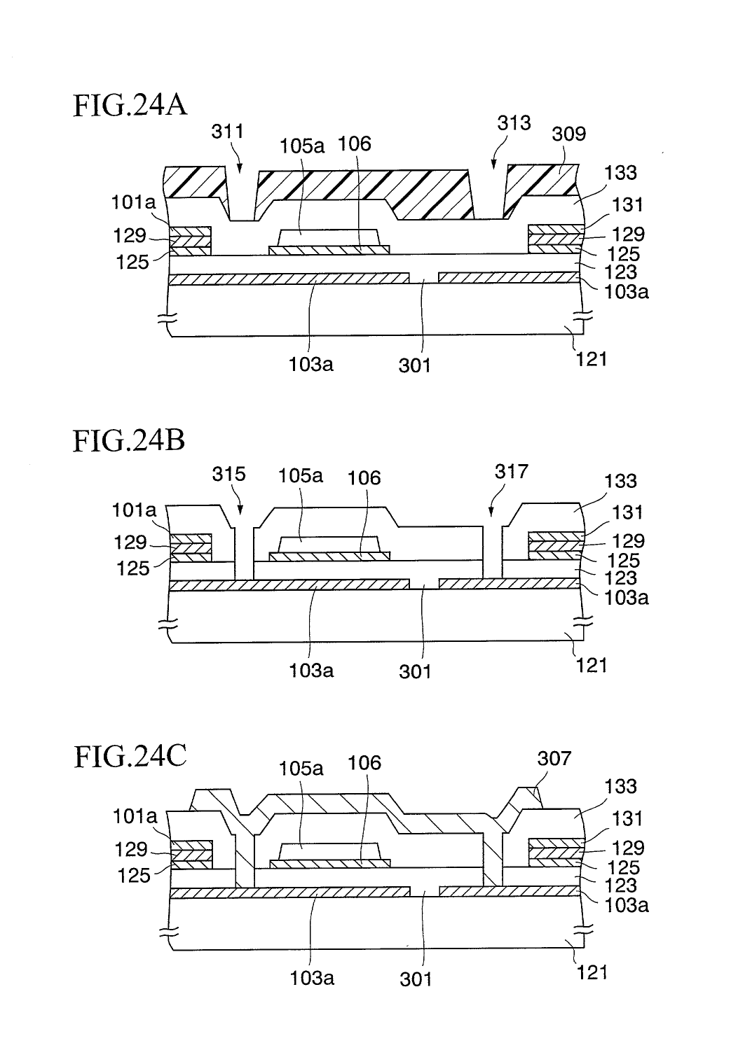

The disconnection repairing method in the example 5 will be explained in more detail with reference to FIGS. 24A to 24C hereunder. FIGS. 24A to 24C show a sectional shape in vicinity of the gate bus line 103a taken along a T-T′ line in FIG. 23 respectively. It is on the assumption that the disconnection inspection of the gate bus lines 103 and the data bus lines 101 has been carried out before the contact holes 107, 111 shown in FIG. 23 are formed, and that the disconnected portion 301 of the gate bus line 103a shown in FIG. 23 is found as the result of the disconnection inspection.

In order to form the contact holes 107 and 111, a resist film 309 is formed by coating the photoresist on the overall surface of the substrate. Then, as shown in FIG. 24A, holes 311, 313 that have a width larger than the width of the gate bus line 103a to transverse the gate bus line 103a are formed by applying the spot-exposure or the laser beam irradiation to the resist film 309 located at the disconnection end portions of the gate bus line 103a on both sides of the disconnected portion 301 and then patterning (developing) the resist film 309.

Then, as shown in FIG. 24B, the formation of the contact holes 107, 111 and the window opening of the terminal portion (not shown) are carried out by the selective etching using the dry etching. At the same time, by selectively etching the inside of the holes 311, 313, an upper surface of the disconnection end portion of the gate bus line 103a is exposed, and also the disconnection repairing contact holes 315, 317 reaching the surface of the glass substrate 121 is formed on both sides of the gate bus line 103a in the width direction.

Then, as shown in FIG. 24C, a laser CVD film 307 for connecting the gate bus line 103a in the disconnection repairing contact holes 315, 317 is formed by the laser CVD method. Then, the pixel electrode 113 is formed by forming the film of the transparent electrode material such as ITO, etc. on the overall surface of the substrate and then patterning the film.

In this manner, as shown in FIG. 23, one disconnection end portion and the other disconnection end portion of the gate bus line 103a are connected electrically by the laser CVD film 307 that is formed between the disconnection repairing contact holes 315, 317. Thus, the disconnection fault can be repaired.

According to this example 5, since the disconnection repairing contact holes are formed by dry-etching the insulating film before the formation of the pixel electrode, such disconnection repairing contact holes can be formed with good precision, without the contamination of the pixel electrode caused by the laser beam irradiation, unlike the prior art. Also, the repairing operation can be carried out not to increase the number of masks.

In addition, since the disconnection repairing contact holes are formed to have the width larger than the data bus line, the contact area can be spread and the reliability of connection can be enhanced rather than the case where the contact holes are formed only on the wiring pattern.

In this case, the connection of the wirings by the laser CVD method may be carried out after the pixel electrode has been formed.

### EXAMPLE 6

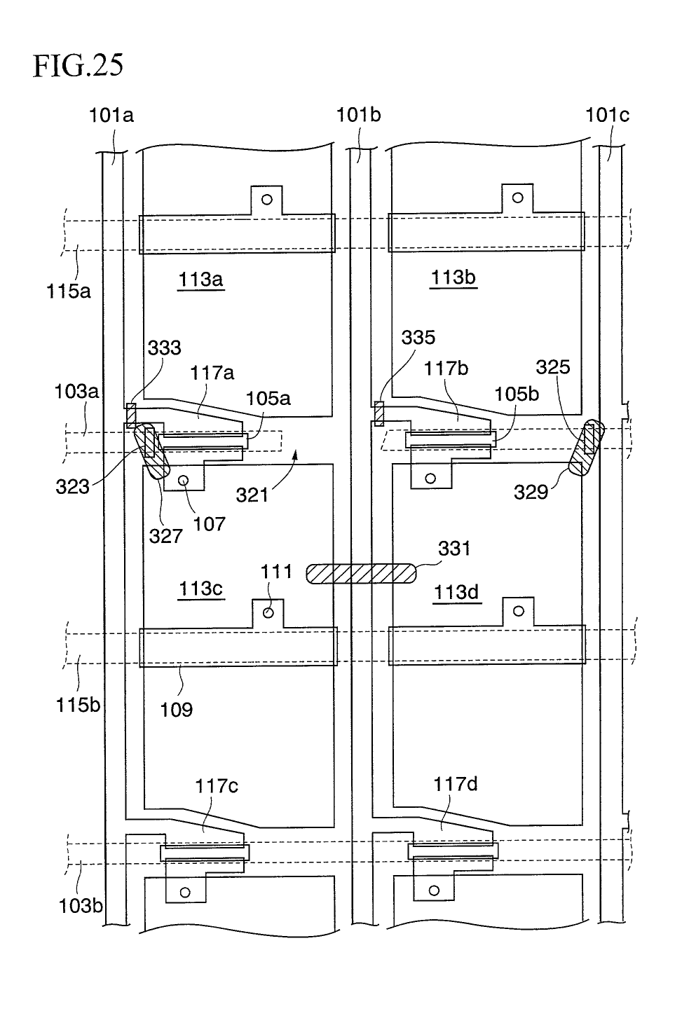

FIG. 25 shows a substrate surface when the TFT substrate of the liquid crystal display panel is viewed from the liquid crystal layer side, like FIG. 9. FIG. 25 shows pixel electrodes 113a, 113b, 113c, 113d in four pixel areas that are defined by three data bus lines 111a, 101b, 101c and two gate bus lines 103a, 103b. A storage capacitance bus line 115a or 115b is formed in each pixel area.

FIG. 25 shows such a situation that the gate bus line 103a is disconnected at a disconnected portion 321 that extends over two pixel areas to put the data bus line 101b between them.

In this example 6, first, disconnection repairing contact holes 323, 325 whose width is larger than the width of the gate bus line 103a are formed on disconnection end portions of the gate bus line 103a located on both sides of the disconnected portion 321 respectively. Then, a laser CVD film 327 that connects the gate bus line 103a in the disconnection repairing contact hole 323 and the left side end of the pixel electrode 113c is formed, and similarly a laser CVD film 329 that connects the gate bus line 103a in the disconnection repairing contact hole 325 and the left side end of the pixel electrode 113d is formed. Also, a laser CVD film 331 that directly connects the pixel electrode 113c and the pixel electrode 113d. In this case, prior to the formation of the pixel electrodes 113a to 113d, the drain electrode 117a of the TFT connected to the pixel electrode 113c is separated from the data bus line 101a by irradiating the laser beam to a cutting position 333 at the root portion of the drain electrode 117a so as to cut off the connection to the data bus line 101a. Similarly, the drain electrode 117b of the TFT connected to the pixel electrode 113d is separated from the data bus line 101b by irradiating the laser beam to a cutting position 335 at the root portion of the drain electrode 117b so as to cut off the connection to the data bus line 101b.

As a result, one disconnection end portion of the gate bus line 103a is connected to the pixel electrode 113c via the laser CVD film 327 in the disconnection repairing contact hole 323, and the other disconnection end portion of the gate bus line 103a is connected to the pixel electrode 113d via the laser CVD film 329 in the disconnection repairing contact hole 325, and the pixel electrode 113c and the pixel electrode 113d are connected by the laser CVD film 331. Therefore, the electrical connection can be routed to detour the disconnected portion 321 of the gate bus line 103a. In addition, since the disconnection repairing contact holes 323, 325 are formed in the same way as the above examples, the electrical connection with the high reliability can be obtained similarly.

### EXAMPLE 7

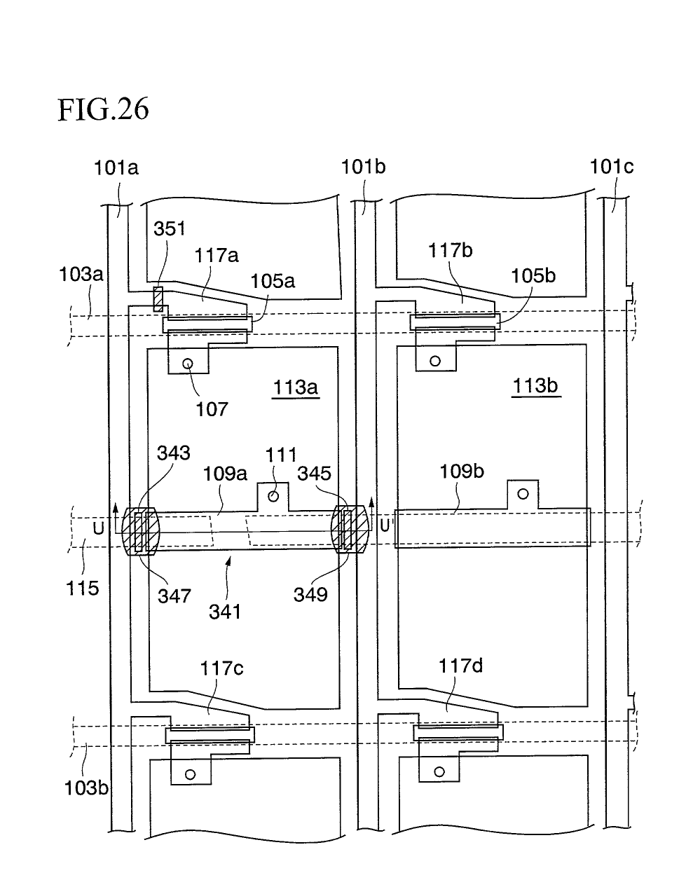

FIG. 26 shows a substrate surface when the TFT substrate of the liquid crystal display panel is viewed from the liquid crystal layer side, like FIG. 9. In FIG. 26, three data bus lines 101a, 101b, 101c and two gate bus lines 103a, 103b are shown, and also two pixel areas (pixel electrodes 113a, 113b) defined by these bus lines are shown. Also, a storage capacitance bus line 115 is formed between the gate bus lines 103a and 103b. In FIG. 26, the storage capacitance bus line 115 is disconnected at a disconnected portion 341 in the area of the pixel electrode 113a.

First, disconnection repairing contact holes 343, 345 whose width is larger than the width of the storage capacitance bus line 115 respectively are formed on the storage capacitance bus line 115 in areas between the pixel electrode 113a and the data bus lines 101a, 101b on both sides of the disconnected portion 341 to traverse the storage capacitance bus line 115.

The storage capacitance bus line 115 containing its side surfaces are exposed in the disconnection repairing contact holes 343, 345. Then, laser CVD films 347, 349 that connects the pixel electrode 113a and the storage capacitance bus line 115 in the disconnection repairing contact hole 343 and the pixel electrode 113a and the storage capacitance bus line 115 in the disconnection repairing contact hole 345 respectively are formed. In this case, prior to the formation of the pixel electrode 113a, the drain electrode 117a of the TFT connected to the pixel electrode 113a is separated from the data bus line 101a by irradiating the laser beam to a cutting position 351 at the root portion of the drain electrode 117a so as to cut off the connection to the data bus line 101a.

In this manner, the disconnection fault occurred in the gate bus line can be repaired without fail.

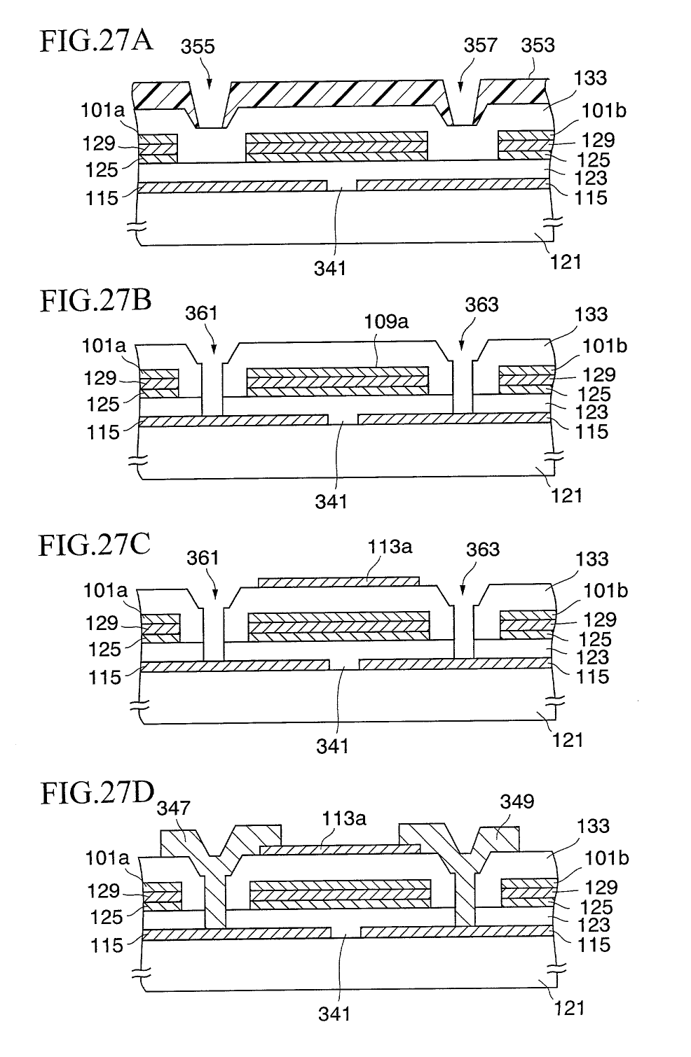

The disconnection repairing method in the example 7 will be explained in more detail with reference to FIGS. 27A to 27D hereunder. FIGS. 27A to 27D show a sectional shape in vicinity of the storage capacitance bus line 115 taken along a U-U′ line in FIG. 26 respectively. First, it is on the assumption that the disconnection inspection of the storage capacitance bus line 115 has been carried out before the contact holes 107, 111 shown in FIG. 26 are formed, and that the disconnected portion 341 of the storage capacitance bus line 115 shown in FIG. 26 is found as the result of the disconnection inspection.

In order to form the contact holes 107 and 111, a resist film 353 is formed by coating the photoresist on the overall surface of the substrate. Then, as shown in FIG. 27A, holes 355, 357 that have a width larger than the width of the storage capacitance bus line 115 respectively are formed by applying the spot-exposure or the laser beam irradiation to the resist film 353 on the disconnection end portions of the storage capacitance bus line 115 on both sides of the disconnected portion 341 and then patterning (developing) the resist film 353.

Then, as shown in FIG. 27B, the formation of the contact holes 107, 111 and the window opening of the terminal portion (not shown) are carried out by the selective etching using the dry etching. At the same time, by selectively etching the inside of the holes 355, 357, the upper surface of the disconnection end portion of the storage capacitance bus line 115 is exposed, and also the disconnection repairing contact holes 361, 363 reaching the surface of the glass substrate 121 are formed on both sides of the storage capacitance bus line 115 in the width direction.

Then, as shown in FIG. 27C, the pixel electrode 113 is formed by forming the film of the transparent electrode material such as ITO, etc. on the overall surface of the substrate and then patterning the film. Then, as shown in FIG. 27D, laser CVD films 347, 349 for connecting the pixel electrode 113a and the storage capacitance bus line 115 in the disconnection repairing contact holes 361, 363 respectively are formed by the laser CVD method.

In this manner, as shown in FIG. 26, one disconnection end portion and the other disconnection end portion of the storage capacitance bus line 115 are connected electrically by the laser CVD films 347, 349 that are formed between the pixel electrode 113a and the disconnection repairing contact holes 361, 363. Thus, the disconnection fault can be repaired.

According to this example 7, since the disconnection repairing contact holes are formed by dry-etching the insulating film prior to the formation of the pixel electrode, such disconnection repairing contact holes can be formed with good precision, without the contamination of the pixel electrode caused by the laser beam irradiation, unlike the prior art. Also, the repairing operation can be carried out not to increase the number of masks.

In addition, since the disconnection repairing contact holes are formed to have the width larger than the storage capacitance bus line 115, the contact area can be expanded and the reliability of connection can be enhanced rather than the case where the contact holes are formed only on the wiring pattern.

### EXAMPLE 8

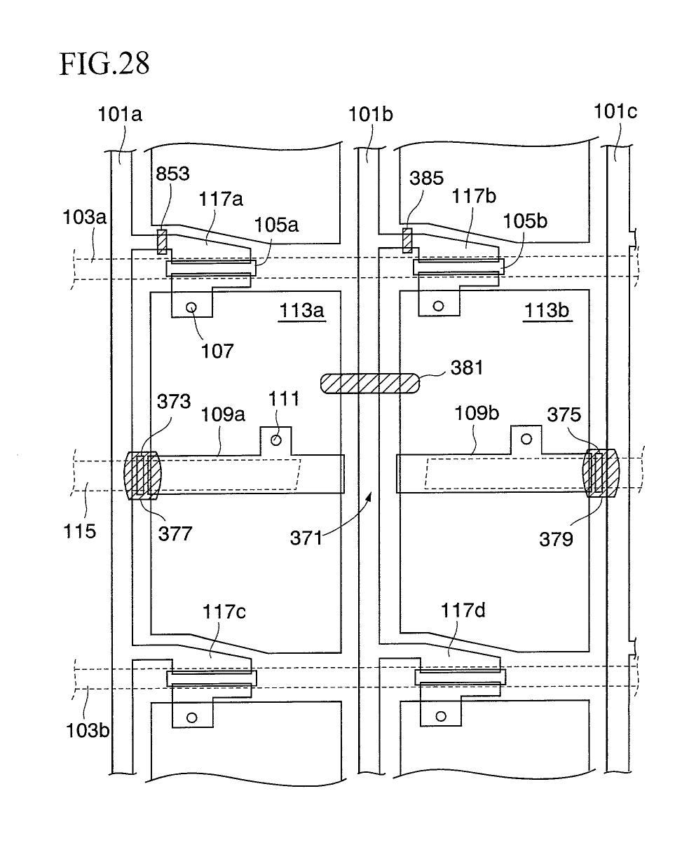

FIG. 28 shows a substrate surface when the TFT substrate of the liquid crystal display panel is viewed from the liquid crystal layer side, like FIG. 9. FIG. 28 shows the pixel electrodes 113a, 113b in two pixel areas that are defined by three data bus lines 101a, 101b, 101c and two gate bus lines 103a, 103b. The storage capacitance bus line 115 is formed in each pixel area.

FIG. 28 shows such a situation that the storage capacitance bus line 115 is disconnected at a disconnected portion 371 that extends over two pixel areas between which the data bus line 101b is put.

In this example 8, first a disconnection repairing contact hole 373 whose width is larger than the width of the storage capacitance bus line 115 is formed on the storage capacitance bus line 115 in the area between the pixel electrode 113a and the data bus line 101a on both sides of the disconnected portion 371. Similarly, a disconnection repairing contact hole 375 whose width is larger than the width of the storage capacitance bus line 115 is formed on the storage capacitance bus line 115 in the area between the pixel electrode 113b and the data bus line 101c. The storage capacitance bus line 115 containing its side surfaces are exposed in the disconnection repairing contact holes 373, 375.

Then, laser CVD films 377, 379 that connect the pixel electrode 113a and the storage capacitance bus line 115 in the disconnection repairing contact hole 373 and the pixel electrode 113c and the storage capacitance bus line 115 in the disconnection repairing contact hole 375 respectively are formed. In addition, a laser CVD film 381 that directly connects the pixel electrode 113a and the pixel electrode 113b.

In this case, prior to the formation of the pixel electrode 113a, the drain electrode 117a of the TFT connected to the pixel electrode 113a is separated from the data bus line 101a by irradiating the laser beam to a cutting position 383 at the root portion of the drain electrode 117a to cut off the connection to the data bus line 101a. Similarly, the drain electrode 117b of the TFT connected to the pixel electrode 113b is separated from the data bus line 101b by irradiating the laser beam to a cutting position 385 at the root portion of the drain electrode 117b to cut off the connection to the data bus line 101b.

As the result of the above, one disconnection end portion of the storage capacitance bus line 115 is connected to the pixel electrode 113a via the laser CVD film 377 in the disconnection repairing contact hole 373, and the other disconnection end portion of the storage capacitance bus line 115 is connected to the pixel electrode 113b via the laser CVD film 379 in the disconnection repairing contact hole 375, and the pixel electrode 113a and the pixel electrode 113b are connected by the laser CVD film 381. Therefore, the electrical connection can be routed to detour the disconnected portion 371 of the gate bus line 115. In addition, since the disconnection repairing contact holes 373, 375 are formed in the same way as the above examples, the electrical connection with the high reliability can be obtained similarly.

### EXAMPLE 9

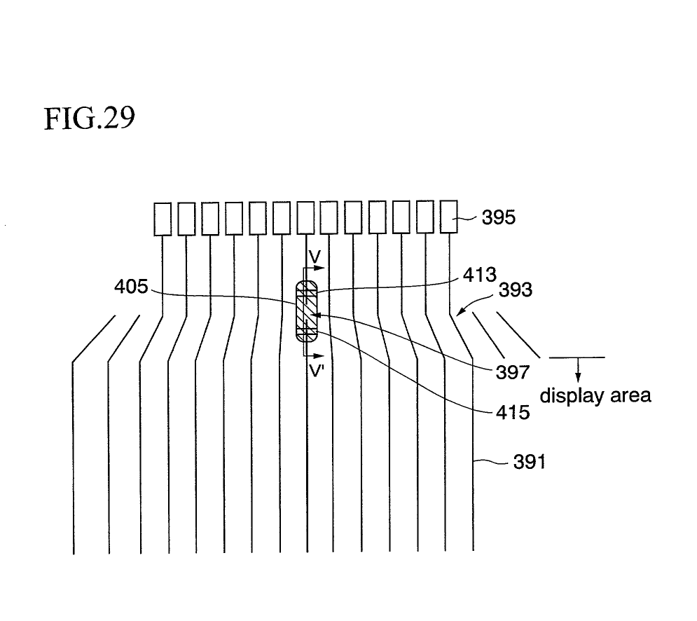

FIG. 29 shows a substrate surface when a lead wiring forming area of the gate bus lines and the data bus lines on the TFT substrate of the liquid crystal display panel is viewed from the liquid crystal layer side. In FIG. 29, the configuration in which the gate bus lines and the data bus lines 391 in the display area are connected to an external connection terminal portion 395 via lead wirings 393 is shown.

In FIG. 29, one of the lead wirings 393 is disconnected at a disconnected portion 397. In this example 9, disconnection repairing contact holes 413, 415 whose width is larger than the width of the lead wiring 393 are formed on disconnection end portions of the lead wiring 393 on both sides of the disconnected portion 393 to traverse the lead wiring 393. Then, a laser CVD film 405 that connects the lead wiring 393 in the disconnection repairing contact hole 413 and the lead wiring 393 in the disconnection repairing contact hole 415 is formed.

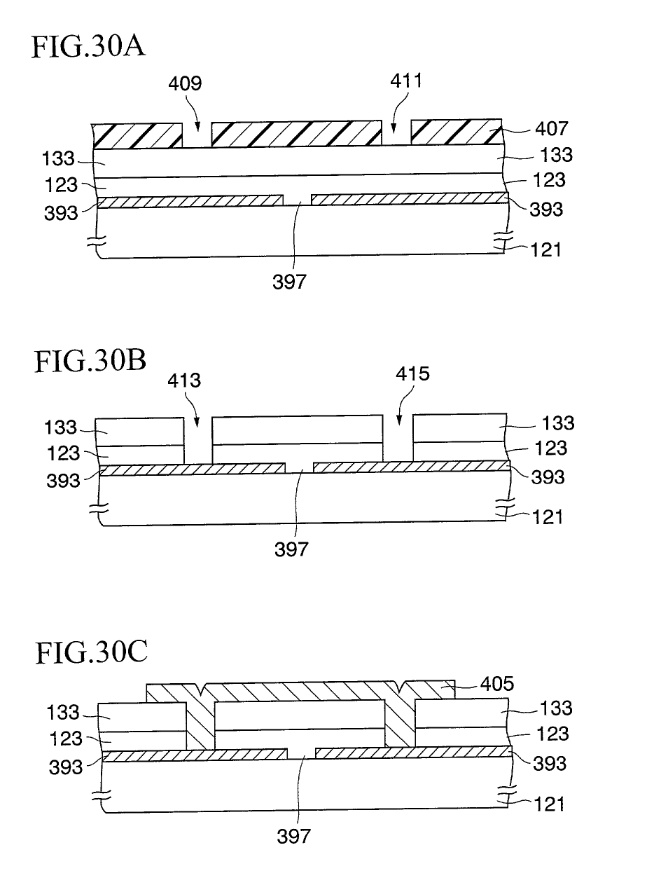

The disconnection repairing method in the example 9 will be explained in more detail with reference to FIGS. 30A to 30C hereunder. FIGS. 30A to 30C show a sectional shape in vicinity of the lead wiring 393 taken along a V-V′ line in FIG. 29 respectively. It is on the assumption that the disconnection inspection of the lead wiring 393 has been carried out before the contact holes 107 and 111 (not shown) are formed, and that the disconnected portion 397 of the lead wiring 393 shown in FIG. 29 is found as the result of the disconnection inspection.

In order to form the contact holes 107 and 111, a resist film 407 is formed by coating the photoresist on the overall surface of the substrate. Then, as shown in FIG. 30A, holes 409, 411 that have a width larger than the width of the lead wiring 393 respectively are formed by applying the spot-exposure or the laser beam irradiation to the resist film 407 on the disconnection end portions of the lead wiring 393 on both sides of the disconnected portion 397 and then patterning the resist film 407.

Then, as shown in FIG. 30B, the formation of the contact holes 107, 111 and the window opening of the terminal portion (not shown) are carried out by the selective etching using the dry etching. At the same time, by selectively etching the inside of the holes 409, 411, the upper surface of the disconnection end portion of the lead wiring 393 is exposed and also the disconnection repairing contact holes 413, 415 reaching the surface of the glass substrate 121 are formed on both sides of the lead wiring 393 in the width direction.

Then, the pixel electrode 113 (not shown) is formed by forming the film of the transparent electrode material such as ITO, etc. on the overall surface of the substrate and then patterning the film. Then, as shown in FIG. 30C, a laser CVD film 405 for connecting the lead wiring 393 in the disconnection repairing contact holes 413 and the lead wiring 393 in the disconnection repairing contact hole 415 is formed by the laser CVD method.

In this manner, as shown in FIG. 29, one disconnection end portion and the other disconnection end portion of the lead wiring 393 are connected electrically by the laser CVD film 405 that is formed between the disconnection repairing contact holes 413, 415. Thus, the disconnection fault can be repaired.

According to this example 9, since the disconnection repairing contact holes are formed by dry-etching the insulating film prior to the formation of the pixel electrode, such disconnection repairing contact holes can be formed with good precision, without the contamination of the pixel electrode caused by the laser beam irradiation, unlike the prior art. Also, the repairing operation can be carried out not to increase the number of masks.

In addition, since the disconnection repairing contact holes are formed to have the width larger than the lead wiring 393, the contact area can be widened and the reliability of connection can be increased rather than the case where the contact holes are formed only on the wiring pattern.

### EXAMPLE 10

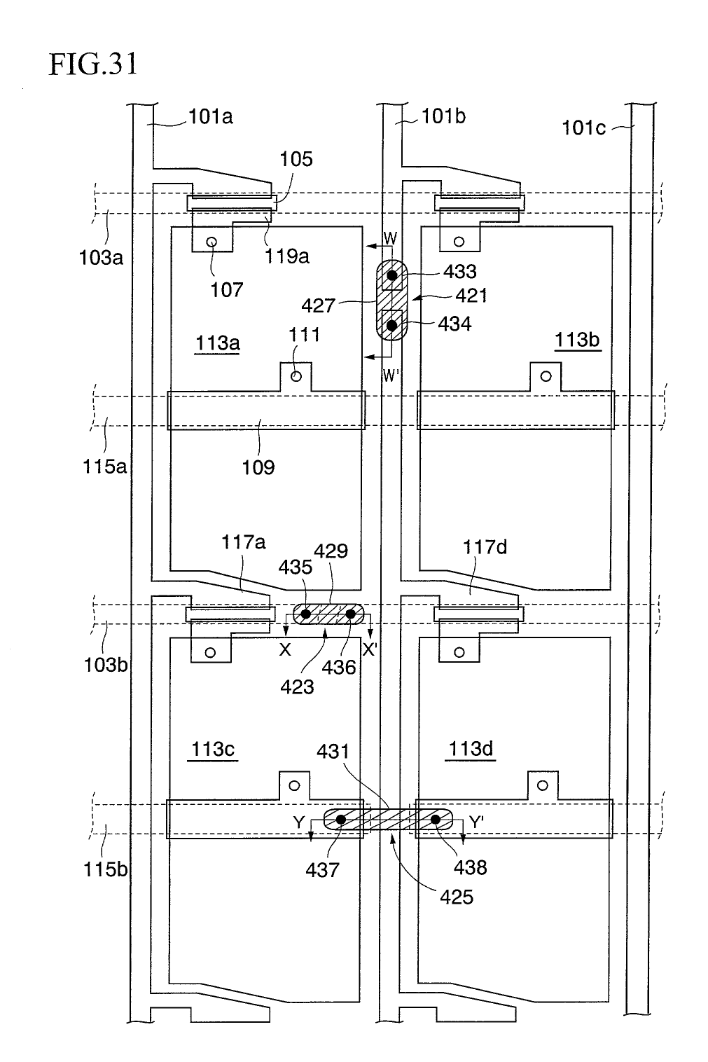

FIG. 31 shows a substrate surface when the TFT substrate of the liquid crystal display panel is viewed from the liquid crystal layer side, like FIG. 9. In FIG. 31, three data bus lines 111a, 101b, 101c and three gate bus lines 103a, 103b, 103c are shown, and also four pixel areas (pixel electrodes 113a, 113b, 113c, 113d) defined by these bus lines are shown. Also, a storage capacitance bus line 115a is shown between the gate bus lines 103a and 103b, and a storage capacitance bus line 115b is shown between the gate bus lines 103b and 103c.

In FIG. 31, the data bus line 101b is disconnected at a disconnected portion 421 between the pixel electrode 113a and the pixel electrode 113a. The gate bus line 103b is disconnected at a disconnected portion 423 located at a right upper end of the pixel electrode 113c. Also, the storage capacitance bus line 115b is disconnected at a disconnected portion 425 that extends over two areas located between the pixel electrode 113c and the pixel electrode 113d.

In this case, laser CVD films 427, 429, 431 that are wider than the line width of the disconnected portion are formed on the protection film, that is located immediately on both end portions of the disconnected portions 421, 423, 425, respectively. Then, laser welding portions indicated by a black mark are formed on both end portions of respective disconnected portions by the laser welding method, and disconnection ends of the disconnected wiring patterns are directly connected by the laser CVD films 427, 429, 431.

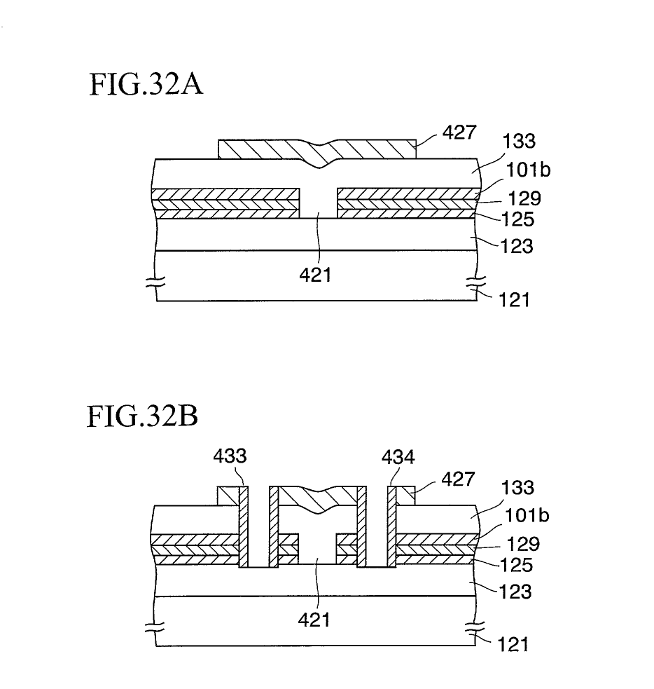

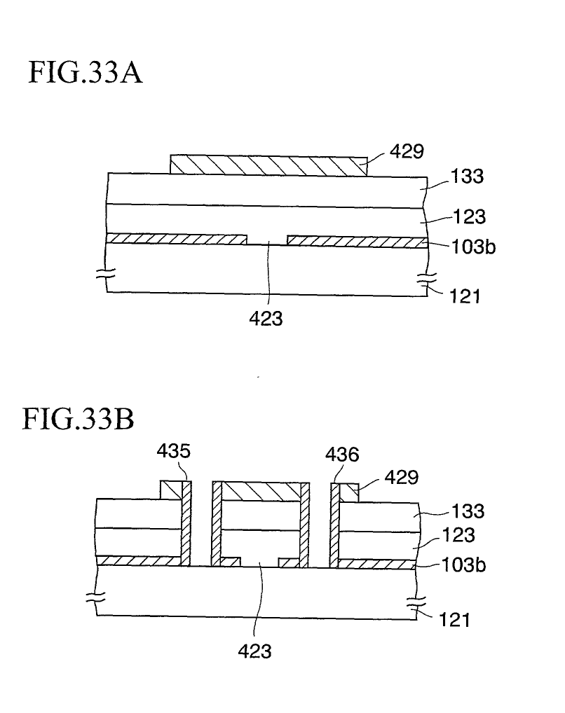

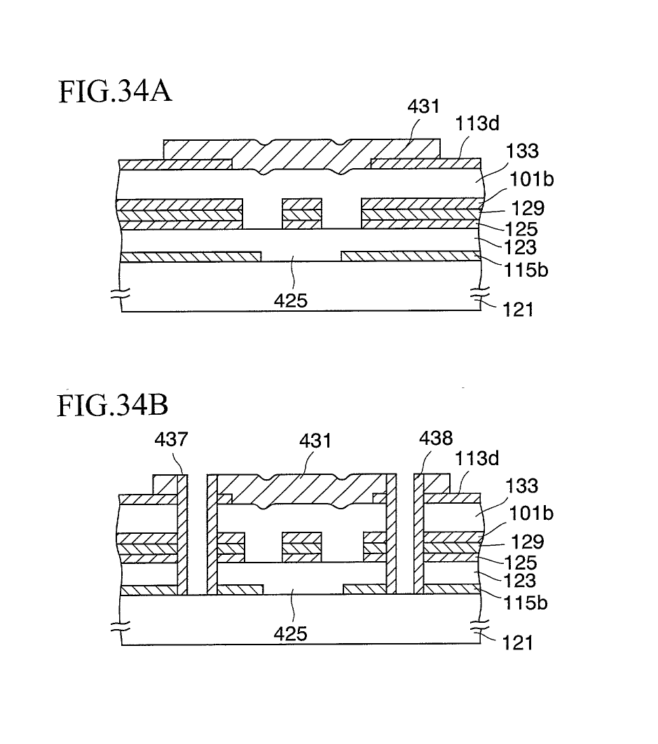

Then, the fault repairing method in the example 10 will be explained particularly with reference to FIGS. 32A and 32B, FIGS. 33A and 33B, and FIGS. 34A and 34B hereunder. FIGS. 32A and 32B show a sectional shape in vicinity of the data bus line 101b taken along a W-W′ line shown in FIG. 31 respectively. FIGS. 33A and 33B show a sectional shape in vicinity of the gate bus line 103b taken along an X-X′ line shown in FIG. 31 respectively. FIGS. 34A and 34B show a sectional shape in vicinity of the storage capacitance bus line 115b taken along a Y-Y′ line shown in FIG. 31 respectively.

First, as shown in FIG. 32A, FIG. 33A and FIG. 34A, the laser CVD films 427, 429, 431 that have a width larger than the disconnected portions 421, 423, 425 respectively are formed on the protection insulating film 133 to cover the disconnected portions 421, 423, 425. Then, as shown in FIG. 32B, FIG. 33B and FIG. 34B, the laser welding portions are formed on both end portions of the disconnected portions 421, 423, 425 by applying the laser welding method to irradiate the laser beam (e.g., YAG laser beam) to both end portions of the disconnected portions 421, 423, 425 from the back surface side or the front surface side.

As shown in FIG. 32B, the laser CVD film 427 and the data bus line 101b are connected by the laser welding portions 433, 434 at the disconnected portion 421, and thus the disconnection caused at the disconnected portion 421 can be repaired. As shown in FIG. 33B, the laser CVD film 429 and the gate bus line 103b are connected by the laser welding portions 435, 436 at the disconnected portion 423, and thus the disconnection caused at the disconnected portion 423 can be repaired. As shown in FIG. 34B, the laser CVD film 431 and the storage capacitance bus line 115b are connected by the laser welding portions 437, 438 at the disconnected portion 425, and thus the disconnection caused at the disconnected portion 425 can be repaired.

As a result, the disconnected portion 421 is connected electrically between one disconnection end portion of the data bus line 101b and the other disconnection end portion of the data bus line 101b via the laser welding portion 433, the laser CVD film 427, and the laser welding portion 434. The disconnected portion 423 is connected electrically between one disconnection end portion of the gate bus line 103b and the other disconnection end portion of the gate bus line 103b via the laser welding portion 435, the laser CVD film 429, and the laser welding portion 436. Also, the disconnected portion 425 is connected electrically between one disconnection end portion of the storage capacitance bus line 115b and the other disconnection end portion of the storage capacitance bus line 115b via the laser welding portion 437, the laser CVD film 431, and the laser welding portion 438.

Here, if the above-mentioned disconnection repairing method is employed in the disconnected portion 425, the right side end of the pixel electrode 113c and the left side end of the pixel electrode 113d are connected. For this reason, the drain electrode 117a of the TFT connected to the pixel electrode 113c and the drain electrode 117b of the TFT connected to the pixel electrode 113d must be separated from the data bus lines 101a, 101b respectively.

(Second Embodiment)

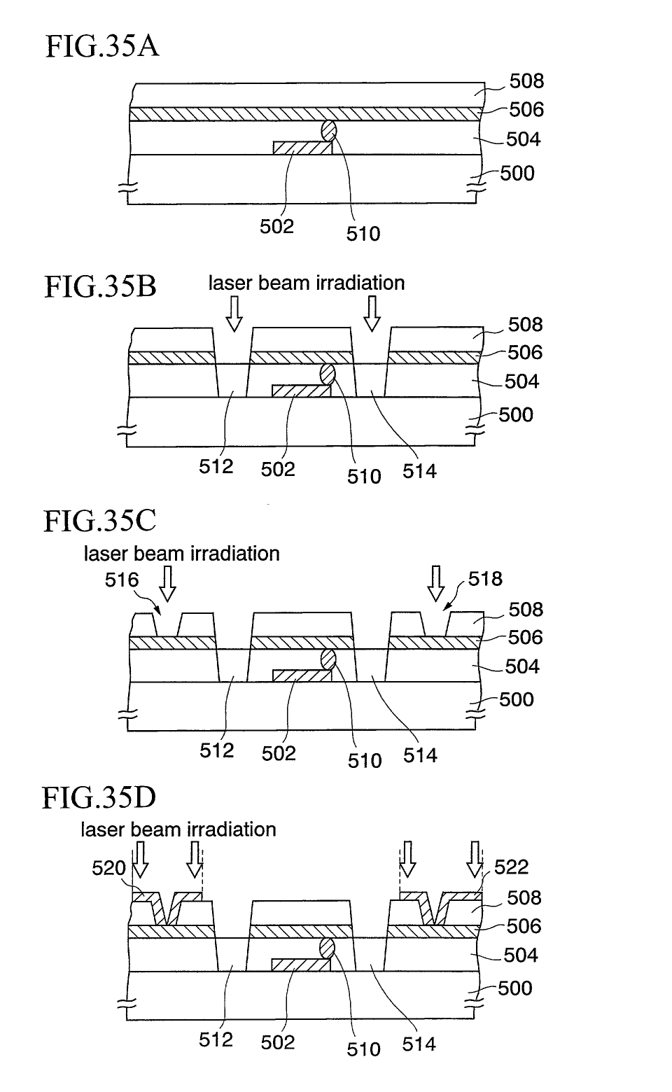

Next, a liquid crystal display device and its fault repairing method according to a second embodiment of the present invention will be explained with reference to FIG. 35A to FIG. 53 hereunder. FIGS. 35A to 35D are views showing the principle of the fault repairing method for liquid crystal display device according to the second embodiment of the present invention. FIG. 35A shows the display panel in which a gate bus line 502 is formed on a transparent glass substrate 500, then a data bus line 506 is formed on the gate bus line 502 via an insulating film (gate insulating film; SiN) 504 to intersect with the gate bus line 502, and then an insulating film (protection film; SiN) 508 is formed on the gate bus line 502. In addition, FIG. 35A shows the situation that short-circuit between the gate bus line 502 and the data bus line 506 occurs at an interlayer short-circuit portion 510.

As shown in FIG. 35B, the data bus line 506 is cut off at disconnected portions 512, 514 by irradiating the laser beam to both sides, between which the interlayer short-circuit portion 510 is sandwiched, from the uppermost layer insulating film (SiN) 508 along the data bus line 506.

Then, as shown in FIG. 35C, contact holes 516, 518 are formed by irradiating the laser beam onto the insulating (SiN) film 508 located on the outside of the disconnected portions 512, 514 respectively to expose the data bus line 506.

Then, as shown in FIG. 35D, metal deposition portions 520, 522 are formed by forming a metal film on respective inner peripheries of the contact holes 516, 518 and on the insulating layer 508 around the opening portions by virtue of the laser CVD method. Then, the metal deposition portions 520 and 522 formed on the insulating film 508 are connected electrically by any one of methods (A) to (E) described in the following.

(A) The metal deposition portions 520 and 522 are connected directly by the metal film, that is formed by the laser CVD method, subsequently when the metal deposition portions 520 and 522 are formed on the insulating layer 508.

(B) The spare wiring having a predetermined length is formed previously on the side of the data bus line 506, then the contact holes that are opened the uppermost layer insulating film 508 on both ends of the spare wiring is provided, and then the contact holes in the spare wiring and the metal deposition portions 520 and 522 are connected by the metal film that is formed by the CVD method.

(C) The pixel electrode and the metal deposition portions 520 and 522 are connected by the metal film that is formed by the CVD method.

(D) The contact holes 516, 518 in FIG. 35C are not provided. Spare pads are extended previously to the outside of both disconnected portions of the data bus line 506 respectively, then contact holes to be opened in the uppermost layer insulating film 508 are provided on the spare pads, and then both contact holes are connected by the metal film formed by the laser CVD method.

(E) After the contact holes 516, 518 in FIG. 35C are not provided, the transparent conductive film that is connected to the contact holes 516, 518 is formed as the spare pads on the insulating layer 508 on the outside ends of both disconnected portions of the data bus line respectively, and then both spare pads are connected by the metal film formed by the laser CVD method.

Accordingly, the disconnected end portions of the disconnected data bus line 506 are connected by the metal film that is drawn on the insulating film 508 by the laser CVD method, and thus the interlayer short-circuit can be repaired. The case where the interlayer short-circuit is repaired when the data bus line 506 is disconnected is explained above. However, it is needless to say that the interlayer short-circuit can be repaired when not the data bus line 506 but the gate bus line 502 or the storage capacitance bus line (not shown) is disconnected similarly.

In this manner, according to the second embodiment of the present invention, since the interlayer short-circuit portion (line fault portion) can be repaired by drawing the wiring by virtue of the laser CVD method, the line fault can be repaired in the display area. The fault repairing method according to the second embodiment will be explained with reference to respective examples hereunder.

In the following examples, the laser beam employed to form the contact holes is the third harmonic (wavelength 355 nm) or the fourth harmonic (wavelength 266 nm) of the YAG pulse laser. Also, the metal film formed by the laser CVD method is deposited by irradiating the continuous laser beam of the wavelength 355 nm, that is output from the YAG laser, after the concentration of the organic metal gas (film forming gas), the laser power, the scanning rate, and the number of times of scanning are adjusted while flowing the Ar gas containing W (tungsten) organic metal, Mo (molybdenum) organic metal, or Cr (chromium) organic metal.

The particular film forming conditions will be given as follows. The film forming gas is metal carbonyl {W(CO)₆,Cr(CO)₆}. The laser power is 0.2 to 0.4 as the attenuator value. The scanning rate is 3.0 m/sec. The number of times of scanning is one. The flow rate of the carrier gas (Ar) is 90 cc/min. If the film is formed under these conditions, the W (tungsten) film having the thickness of 400 to 600 nm and the specific resistance of 100 to 150 μm can be obtained. In this case, the specific resistance of W single substance is 5.65 μΩcm.

The diameter of the contact hole is set to the level of 2 to 5 μm although it depends on the conditions in laser irradiation. According to the metal wiring formed by the laser CVD method, the minimum drawing line width is 5 μm, the film thickness is 0.2 μm, and the specific resistance is less than 50 μΩcm. It has been checked that, when the liquid crystal display device is constructed by repairing the interlayer short-circuit under these conditions, no problem occurs.

### EXAMPLE 1

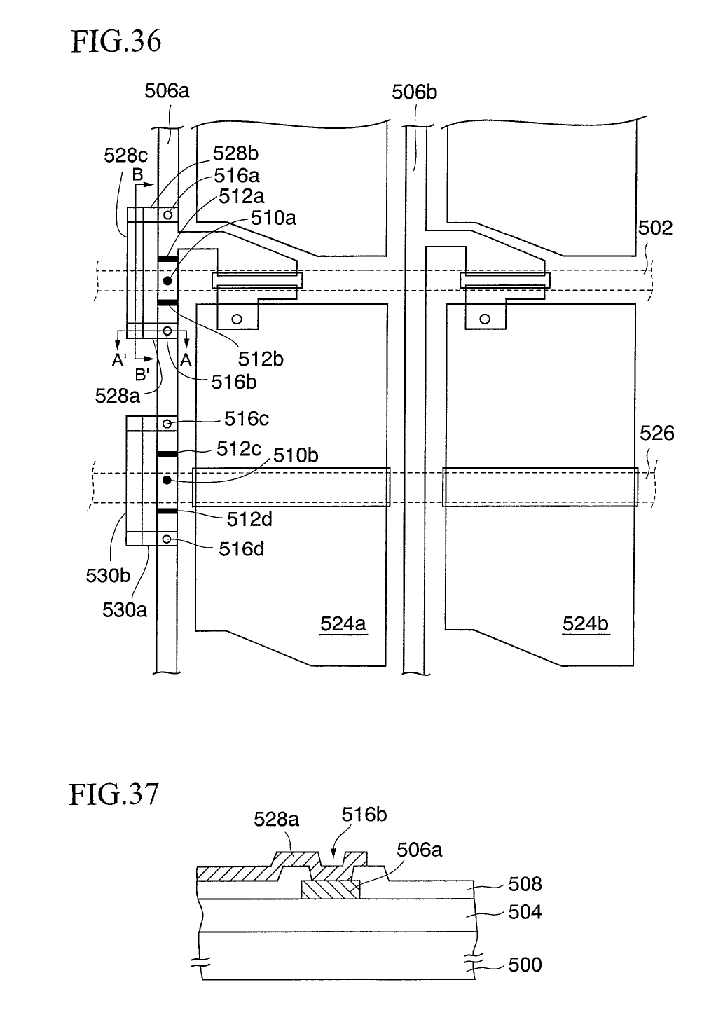

FIG. 36 shows a substrate surface when the interlayer short-circuit portion of the amorphous silicon (a-Si) TFT substrate of the liquid crystal display device is viewed from the liquid crystal layer side. FIG. 36 shows two data bus lines 506a, 506b and one gate bus line 502, and also two pixel areas (pixel electrodes 524a, 524b) are defined by these bus lines. Also, a storage capacitance bus line 526 is formed to traverse laterally lower portions of two pixel electrodes 524a, 524b.

In FIG. 36, a data bus line 506a is short-circuited to a gate bus line 502 at an interlayer short-circuit portion 510a. Also, the data bus line 506a is short-circuited to a storage capacitance bus line 526 at an interlayer short-circuit portion 510b.

In this case, in order to repair the interlayer short-circuits of the gate bus line 502 and the data bus line 506a on the insulating substrate, first the data bus line 506a is disconnected at disconnected portions 512a, 512b by irradiating the laser beam onto both sides of the interlayer short-circuit portion 510a of the data bus line 506a (see FIG. 35A). Then, contact holes 516a, 516b are formed respectively by irradiating the YAG pulse laser beam onto both sides of the interlayer short-circuit portion 510a from the uppermost layer insulating film (SiN) 508 to expose the data bus line 506a (see FIG. 35B). Then, a metal wiring for connecting the contact holes 516a and 516b is formed by the laser CVD method. In this case, if the metal wiring is formed to connect the contact holes 516a and 516b like a straight line, the data bus line 506a and the gate bus line 502 are short-circuited again via the disconnected portions 512a, 512b.

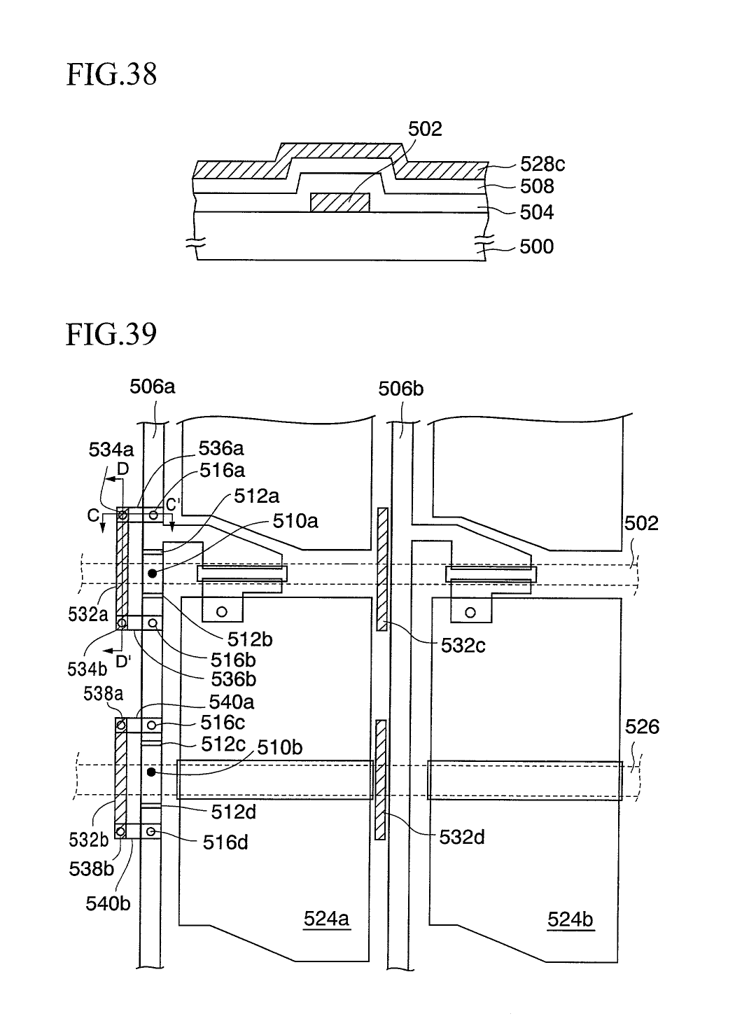

Therefore, as shown in FIG. 36, the contact holes 516a and 516b are connected by forming metal wirings 528a, 528b, 528c to detour the disconnected portions 512a, 512b of the data bus line 506a, and thus the interlayer short-circuit can be repaired. The disconnection repairing method according to the example 1 will be explained more particularly with reference to FIG. 37 and FIG. 38 hereunder.

FIG. 37 shows a sectional shape of the TFT taken along an A-A′ line in FIG. 36. FIG. 38 shows a sectional shape of the TFT taken along a B-B′ line in FIG. 36. As shown in FIG. 37, the contact hole 516b (516a) provided on the data bus line 506a is filled with the metal film by virtue of the laser CVD method and also a metal wiring 528a (528b) is formed by extending the metal film formed by the laser CVD method by a predetermined length in the direction that intersects orthogonally with the data bus line 506a. Then, a metal wiring 528c that connects end portions of the metal wirings 528a, 528b extended from the contact holes 516b, 516a is formed by the laser CVD method. Then, as shown in FIG. 38, the metal wiring 528c is provided to cross the gate bus line 502.

As a result, one end of the disconnected portion of the data bus line 506a can be connected electrically to the other end of the disconnected portion of the data bus line 506a via the contact hole 516a, the metal wiring 528b, the metal wiring 528c, and the contact hole 516b, and thus the interlayer short-circuit can be repaired.

Also, in FIG. 36, in order to repair the interlayer short-circuit between the storage capacitance bus line 526 and the data bus line 506a on the insulating substrate, disconnected portions 512c, 512d are formed by irradiating the laser beam onto both sides of the interlayer short-circuit portion 510b of the data bus line 506a (see FIG. 35A). Then, contact holes 516c, 516d are formed respectively by irradiating the YAG pulse laser beam onto both sides of the interlayer short-circuit portion 510a from the uppermost layer insulating film (SiN) 508 to expose the data bus line 506a (see FIG. 35B). Then, like the above, metal wirings 530a, 530b are formed by the laser CVD method to detour the disconnected portions 512c, 512d of the data bus line 506a, and then the interlayer short-circuit can be repaired by connecting the contact holes 516c and 516d via the metal wirings 530a, 530b.

### EXAMPLE 2

FIG. 39 shows a substrate surface when the interlayer short-circuit portion of the TFT substrate of the liquid crystal display device is viewed from the liquid crystal layer side. In FIG. 39, two data bus lines 506a, 506b and one gate bus line 502 are shown, and also two pixel areas (pixel electrodes 524a, 524b) defined by these bus lines are shown. Also, the storage capacitance bus line 526 is shown to traverse laterally middle portions of two pixel electrodes 524a, 524b.

In this example 2, in the intersection area between the data bus line 506 and the gate bus line 502, a spare wiring 532 having a predetermined length is formed between the pixel electrode 524 and the neighboring data bus line 506 along the data bus line 506 to traverse the gate bus line 502. Also, in the intersection area between the data bus line 506 and the storage capacitance bus line 526, a spare wiring 532 having a predetermined length is formed between the pixel electrode 524 and the neighboring data bus line 506 on the side of the data bus line 506 to traverse the storage capacitance bus line 526.

For example, in the intersection area between the data bus line 506b and the gate bus line 502, a spare wiring 532c having a predetermined length is formed between the pixel electrode 524a and the neighboring data bus line 506b on the data bus line 506 to traverse the gate bus line 502. Also, for example, in the intersection area between the data bus line 506 and the storage capacitance bus line 526, a spare wiring 532d having a predetermined length is formed between the pixel electrode 524 and the neighboring data bus line 506b on the side of the data bus line 506 to traverse the storage capacitance bus line 526.

In FIG. 39, like the example 1 of the second embodiment, the data bus line 506a is short-circuited to the gate bus line 502 at the interlayer short-circuit portion 510a. Also, the data bus line 506a is short-circuited to the storage capacitance bus line 526 at the interlayer short-circuit portion 510b.

First, the repairing method of the interlayer short-circuit portion 510a will be explained hereunder. In this example 2, like the example 1, the data bus line 506a is disconnected at the disconnected portions 512a, 512b, and then the contact holes 516a, 516b are formed respectively by irradiating the laser beam onto the insulating film 508 on the data bus line 502a in vicinity of the disconnected portions 512a, 512b. Also, the contact holes 534a, 534b are formed by irradiating the laser beam onto the insulating film 508 on both end portions of the spare wiring 532a.

Then, a metal wiring 536a for connecting the contact holes 516a and 516b is formed by the laser CVD method. Similarly, a metal wiring 536b for connecting the contact holes 516b and 534b is formed by the laser CVD method.

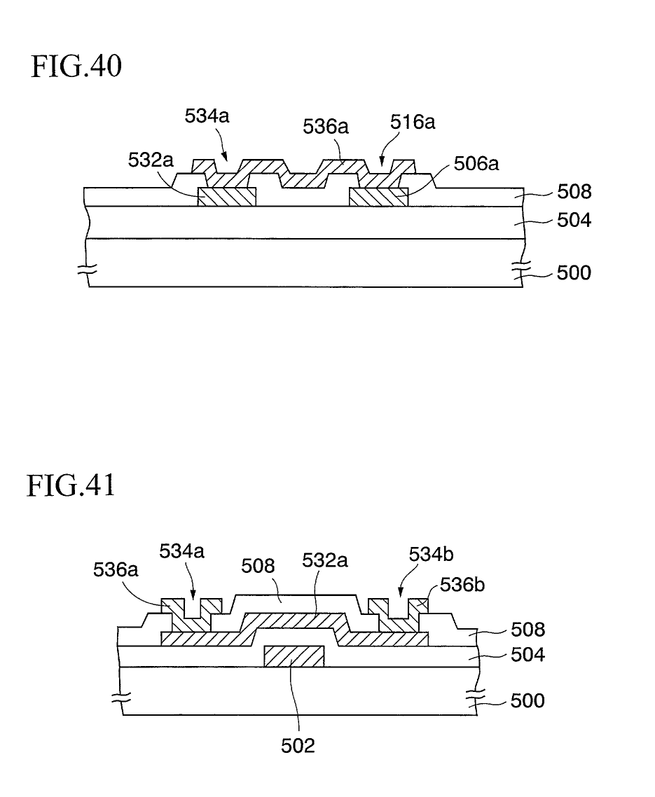

More particularly, the interlayer short-circuit is repaired in compliance with procedures shown in FIG. 40 and FIG. 41 hereunder. FIG. 40 shows a sectional shape taken along a C-C′ line in FIG. 39. FIG. 41 shows a sectional shape taken along a D-D′ line in FIG. 39. As shown in FIG. 40 and FIG. 41, a spare wiring 532a is formed previously by steps applied to form the data bus line 506a. If the interlayer short-circuit to the gate bus line 502 is caused, the contact holes 516a (516b), 534a (534b) are formed on the data bus line 506a and the spare wiring 532a respectively. Then, the contact holes 516a and 534a (the contact holes 516b and 534b) are connected by the metal wiring 536a (536b) to bury them.

As a result, as shown in FIG. 41, since the spare wiring 532a is formed to cross the gate bus line 502, the detouring circuit reaching the metal wiring 536b from the metal wiring 536a via the spare wiring 532a is constructed, and thus the interlayer short-circuit 510a between the data bus line 506a and the gate bus line 502 can be repaired. According to this example 2, since merely the metal wirings 536a, 536b are drawn by the laser CVD method, the areas that are drawn by the laser CVD method can be shortened.

Similarly to the interlayer short-circuit 510b, the contact holes 516c, 516d, 538a, 538b are formed respectively, and then the interlayer short-circuit 510b between the data bus line 506a and the storage capacitance bus line 526 can be repaired by connecting the contact holes 516c and 538a by the metal wiring 540a and also connecting the contact holes 516d and 538b by the metal wiring 540b.

### EXAMPLE 3

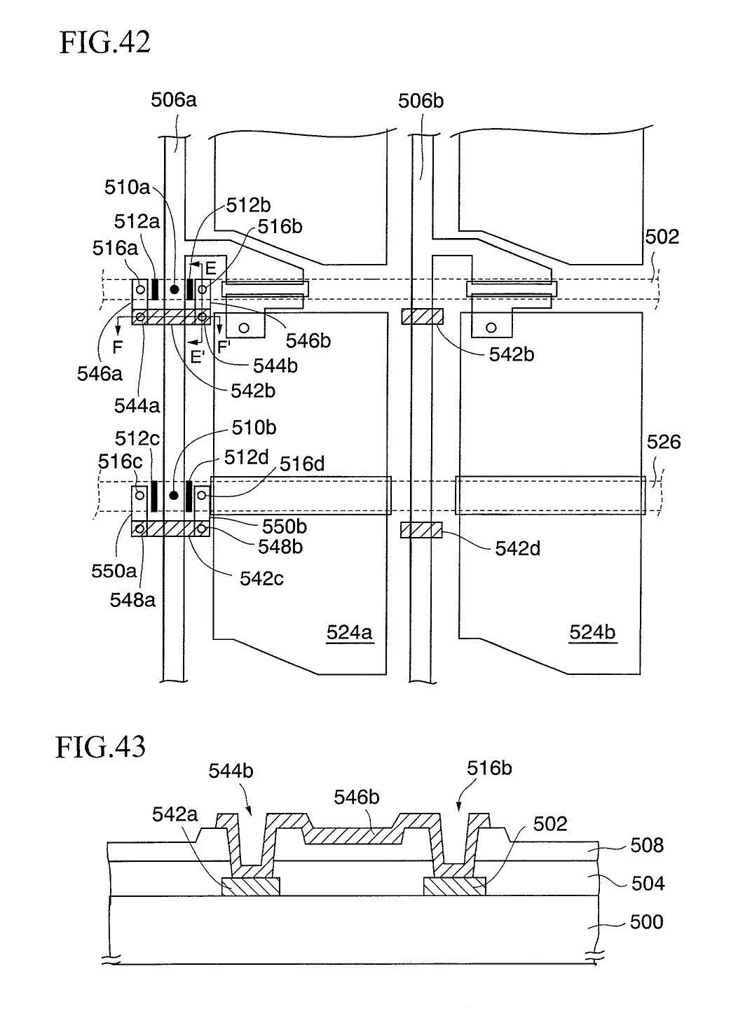

FIG. 42 shows a substrate surface when the interlayer short-circuit portion of the TFT substrate of the liquid crystal display device is viewed from the liquid crystal layer side. In FIG. 42, two data bus lines 506a, 506b and one gate bus line 502 are shown, and two pixel areas (pixel electrodes 524a, 524b) are defined by these bus lines. Also, the storage capacitance bus line 526 is shown to traverse laterally middle portions of two pixel electrodes 524a, 524b.

In this example 3, in the intersection area between the data bus line 506a and the gate bus line 502, a spare wiring 542a having a predetermined length is formed on the side of the gate bus line 502 to traverse the data bus line 506a. Also, in the intersection area between the data bus line 506a and the storage capacitance bus line 526, a spare wiring 542c having a predetermined length is formed on the side of the storage capacitance bus line 526 to traverse the storage capacitance bus line 526.

Similarly, in the intersection area between the data bus line 506b and the gate bus line 502, a spare wiring 542b having a predetermined length is formed on the side of the gate bus line 502 to traverse the data bus line 506b. Also, in the intersection area between the data bus line 506b and the storage capacitance bus line 526, a spare wiring 542d having a predetermined length is formed on the side of the storage capacitance bus line 526 to traverse the data bus line 506b. These spare wirings 542a to 542d are formed not to contact to the neighboring pixel electrode.

In FIG. 42, like the example 1 of the second embodiment, the data bus line 506a is short-circuited to the data bus line 502 at the interlayer short-circuit portion 510a. Also, the data bus line 506a is short-circuited to the storage capacitance bus line 526 at the interlayer short-circuit portion 510b.

First, the repairing method of the interlayer short-circuit portion 510a will be explained hereunder. In this example 3, the gate bus line 502 is disconnected at the disconnected portions 512a, 512b, and the contact holes 516a, 516b are formed respectively by irradiating the laser beam onto the insulating film 508 in vicinity of the disconnected portions 512a, 512b. Also, contact holes 544a, 544b are formed by irradiating the laser beam onto the insulating film 508 on both end portions of the spare wiring 542a.

Then, a metal wiring 546a for connecting the contact holes 516a and 544a is formed by the laser CVD method. Similarly, a metal wiring 546b for connecting the contact holes 516b and 544b is formed by the laser CVD method.

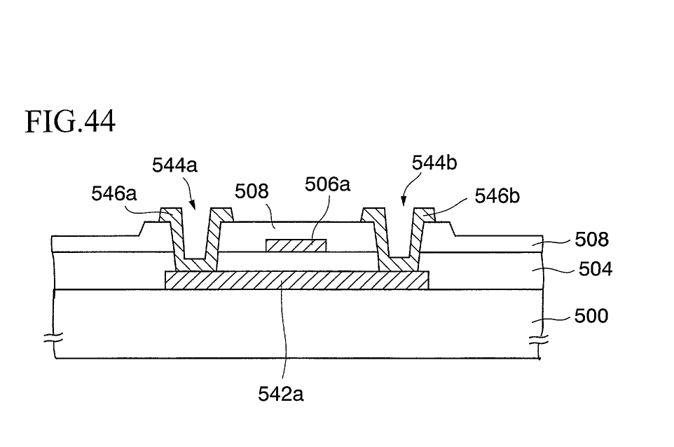

More particularly, the interlayer short-circuit is repaired in compliance with procedures shown in FIG. 43 and FIG. 44 hereunder. FIG. 43 shows a sectional shape taken along an E-E′ line in FIG. 42. FIG. 44 shows a sectional shape taken along an F-F′ line in FIG. 42. As shown in FIG. 43 and FIG. 44, a spare wiring 542a is formed previously by steps applied to form the gate bus line 502. If the interlayer short-circuit to the data bus line 506a is caused, the contact holes 516a (516b), 544a (544b) are formed on the gate bus line 502 and the spare wiring 542a respectively. Then, the contact holes 516a and 544a (the contact holes 516b and 544b) are connected by the metal wiring 546a (546b) to bury them.

As a result, since the spare wiring 542a is formed to cross the gate bus line 502, the detouring circuit reaching the metal wiring 546b from the metal wiring 546a via the spare wiring 542a is constructed, and thus the interlayer short-circuit 510a between the data bus line 506a and the data bus line 502 can be repaired. According to this example 3, since merely the metal wirings 546a, 546b are drawn by the laser CVD method, the areas that are drawn by the laser CVD method can be shortened, like the example 2.

Similarly to the interlayer short-circuit 510b, the contact holes 516c, 516d, 538a, 538b are formed respectively, and then the interlayer short-circuit 510b between the data bus line 506a and the storage capacitance bus line 526 can be repaired by connecting the contact holes 516c and 548a by the metal wiring 550a and also connecting the contact holes 516d and 548b by the metal wiring 550b.

### EXAMPLE 4

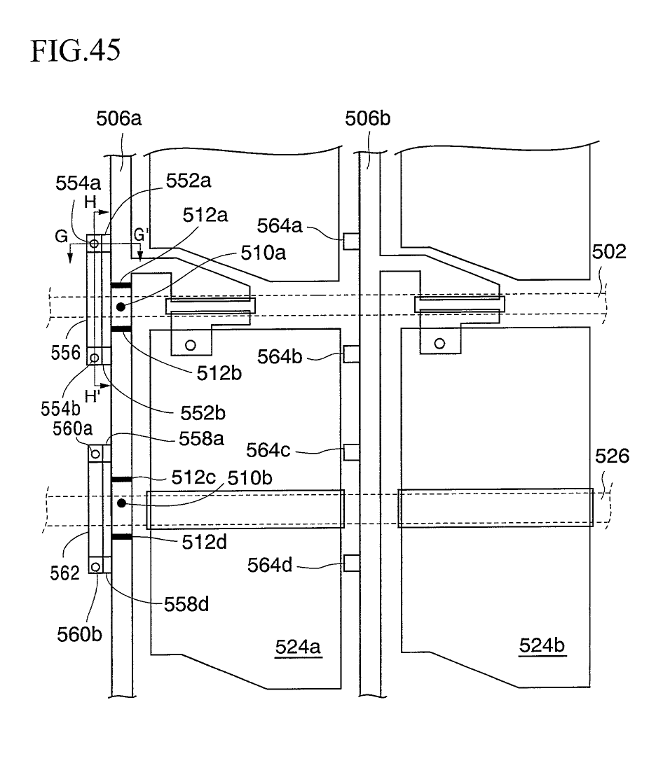

FIG. 45 shows a substrate surface when the interlayer short-circuit portion of the TFT substrate of the liquid crystal display device is viewed from the liquid crystal layer side. In FIG. 45, two data bus lines 506a, 506b and one gate bus line 502 are shown, and two pixel areas (pixel electrodes 524a, 524b) defined by these bus lines are shown. Also, the storage capacitance bus line 526 is shown to traverse laterally middle portions of two pixel electrodes 524a, 524b.

In this example 4, near the intersection area between the data bus line 506a and the gate bus line 502, spare pads 552a, 552b having a predetermined length are provided on the side portions of the data bus line 506a on both sides of the gate bus line 502 in the width direction. Also, spare pads 564a, 564b having a predetermined length are provided similarly on the side portions of the data bus line 506b. In addition, near the intersection area between the data bus line 506a and the storage capacitor bus line 526, spare pads 558a, 558b having a predetermined length are provided on the side portions of the data bus line 506a on both sides of the storage capacitance bus line 526 in the width direction. Also, spare pads 566a, 566b having a predetermined length are provided similarly on the side portions of the data bus line 506b.

In FIG. 45, like the example 1, the data bus line 506a is short-circuited to the data bus line 502 at the interlayer short-circuit portion 510a. Also, the data bus line 506a is short-circuited to the storage capacitance bus line 526 at the interlayer short-circuit portion 510b.

First, the repairing method of the interlayer short-circuit portion 510a will be explained hereunder. In this example 4, the data bus line 506a is disconnected at the disconnected portions 512a, 512b, and the contact holes 516a, 516b are formed respectively by irradiating the laser beam onto the insulating film 508 in vicinity of the disconnected portions 512a, 512b. Also, contact holes 554a, 554b are formed by irradiating the laser beam onto the insulating film 508 on the spare pads 552a, 552b. Then, a metal wiring 556 for connecting the contact holes 554a and 554b is formed by the laser CVD method.

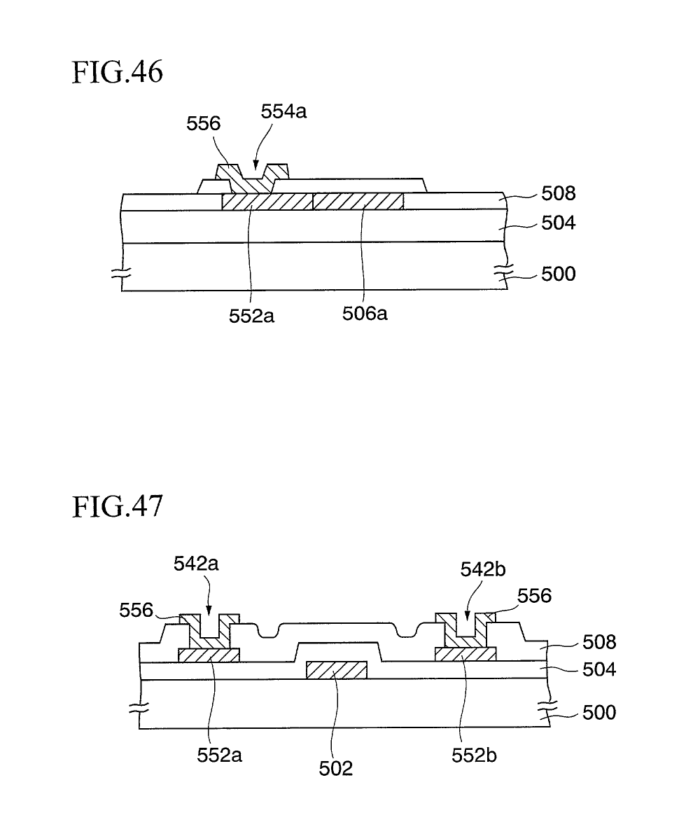

More particularly, the interlayer short-circuit is repaired in compliance with procedures shown in FIG. 46 and FIG. 47 hereunder. FIG. 46 shows a sectional shape of the TFT taken along a G-G′ line in FIG. 45. FIG. 47 shows a sectional shape of the TFT taken along an H-H′ line in FIG. 45. As shown in FIG. 46 and FIG. 47, spare pads 552a, 552b are formed previously by steps applied to form the data bus line 506a. If the interlayer short-circuit occurs between the data bus line 506a and the gate bus line 502, the contact holes 554a, 554b are formed on the spare pads 552a and 552b respectively. Then, the metal wiring 556 for connecting the contact holes 554a and 554b is formed by the laser CVD method.

As a result, the detouring circuit reaching the spare pad 552b from the spare pad 552a via the metal wiring 556 is constructed, and thus the interlayer short-circuit 510a between the data bus line 506a and the data bus line 502 can be repaired. According to this example 4, since the contact holes are provided merely on the spare pads 552a, 552b, the simplification of the repairing operation can be achieved rather than the case of the examples 2, 3 in which the spare wirings are also provided.

Similarly to the interlayer short-circuit 510b, since the contact holes 560c and 560b provided on the spare pads 558a, 558b are connected via the metal wiring 562, the interlayer short-circuit 510b between the data bus line 506a and the storage capacitance bus line 526 can be repaired.

### EXAMPLE 5

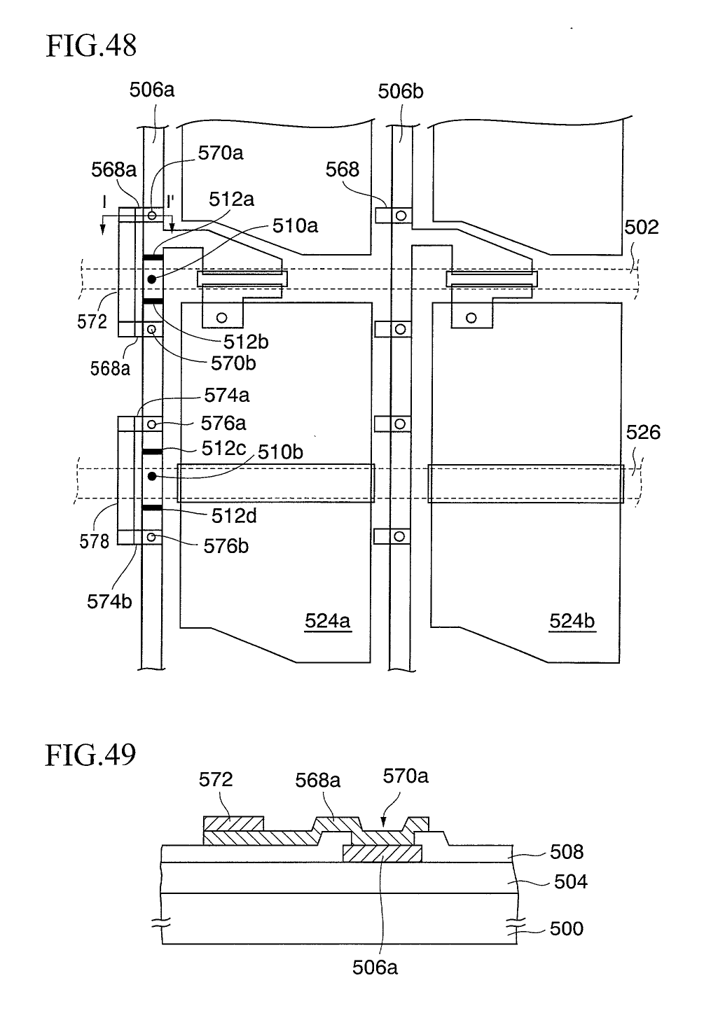

FIG. 48 shows a substrate surface when the interlayer short-circuit portion of the TFT substrate of the liquid crystal display device is viewed from the liquid crystal layer side. In FIG. 48, two data bus lines 506a, 506b and one gate bus line 502 are shown, and two pixel areas (pixel electrodes 524a, 524b) defined by these bus lines are shown. Also, the storage capacitance bus line 526 is shown to traverse laterally middle portions of two pixel electrodes 524a, 524b.

In FIG. 48, like the example 1, the data bus line 506a is short-circuited to the data bus line 502 at the interlayer short-circuit portion 510a. Also, the data bus line 506a is short-circuited to the storage capacitance bus line 526 at the interlayer short-circuit portion 510b.

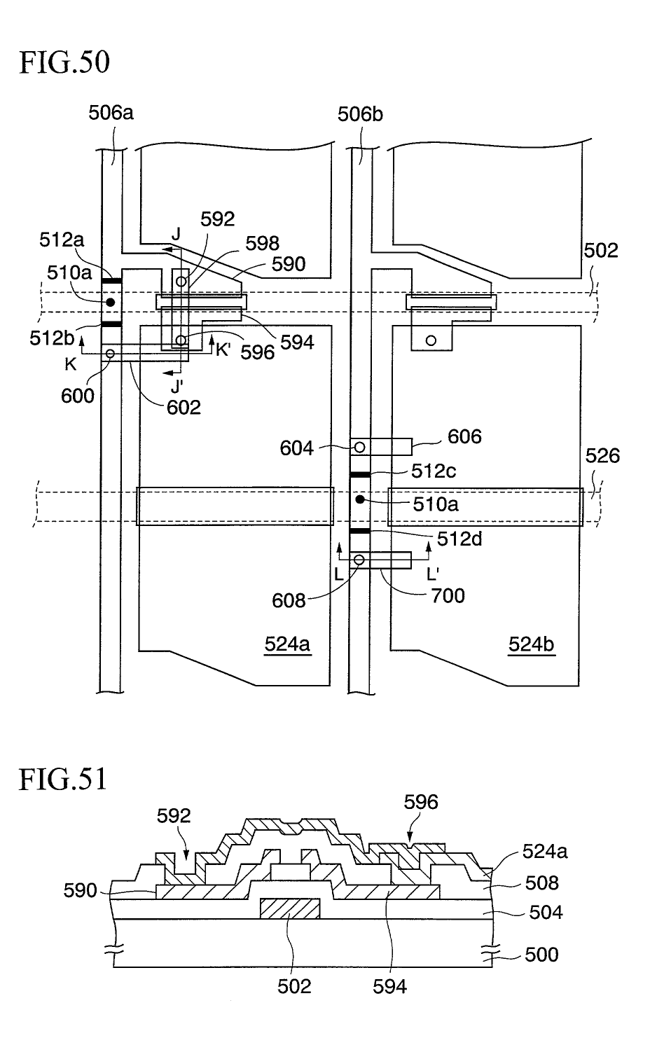

The repairing method of the interlayer short-circuit portion 510a will be explained with reference to FIG. 49 hereunder. FIG. 49 shows a sectional shape of the TFT taken along an I-I′ line in FIG. 48. In this example 5, contact holes are opened previously in the insulating film on the data bus lines 506a, 506b at a predetermined interval. Then, spare pads 568a, 568b, . . . made of the transparent electrode film (ITO) and connected to the data bus lines 506a, 506b via the contact holes are formed at the same time when the pixel electrode 524 is formed. The spare pad 568 is formed near the intersecting portion between the data bus line 506 and the gate bus line 502 and the storage capacitance bus line 526.

Accordingly, the detouring circuit reaching the spare pad 568b from the spare pad 568a via the metal wiring 572 is constructed merely by cutting off the data bus line 506a at the disconnected portions 512a, 512b and then connecting end portions of the spare pads 568a, 568b via the metal wiring 572 formed by the laser CVD method, and thus the interlayer short-circuit 510a between the data bus line 506a and the data bus line 502 can be repaired. According to this example 5, since the repair can be completed merely by connecting the spare pads 568a, 568b by the metal wiring 572 formed by the laser CVD method without the provision of the contact holes in repairing operation, the substantial simplification of the repairing operation can be achieved.

Similarly to the interlayer short-circuit 510b, since the spare pads 574a, 575b are connected via the metal wiring 578 formed by the laser CVD method, the interlayer short-circuit 510b between the data bus line 506a and the storage capacitance bus line 526 can be repaired.

### EXAMPLE 6

FIG. 50 shows a substrate surface when the interlayer short-circuit portion of the TFT substrate of the liquid crystal display device is viewed from the liquid crystal layer side. In FIG. 50, two data bus lines 506a, 506b and one gate bus line 502 are shown, and two pixel areas (pixel electrodes 524a, 524b) defined by these bus lines are shown. Also, the storage capacitance bus line 526 is shown to traverse laterally middle portions of two pixel electrodes 524a, 524b.

In FIG. 50, the data bus line 506a is short-circuited to the data bus line 502 at the interlayer short-circuit portion 510a. Also, the data bus line 506a is short-circuited to the storage capacitance bus line 526 at the interlayer short-circuit portion 510b.

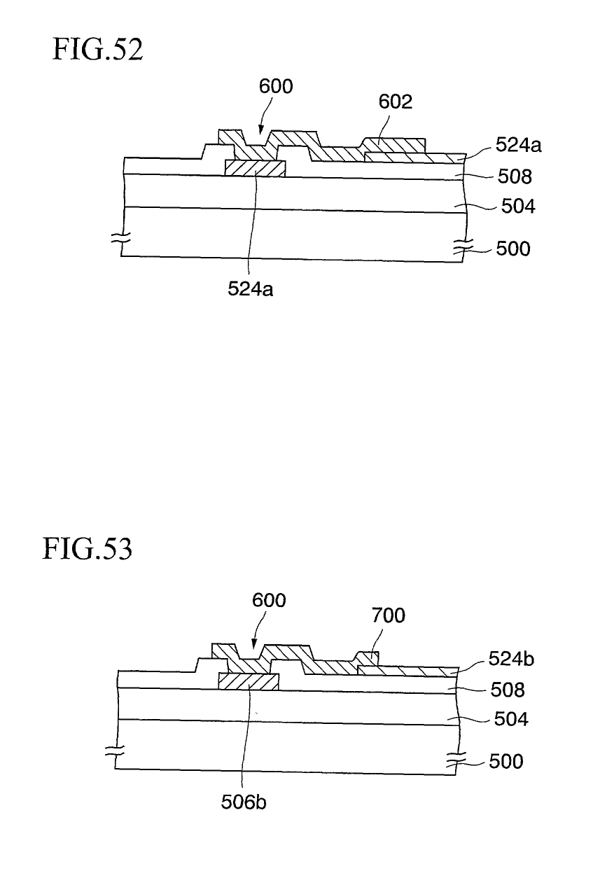

In this case, in the example 6, the interlayer short-circuit is repaired by forming the detour route via the pixel electrode in compliance with procedures shown in FIG. 51, FIG. 52 and FIG. 53 hereunder. FIG. 51 shows a sectional shape of the TFT taken along a J-J′ line in FIG. 50. FIG. 52 shows a sectional shape of the TFT taken along a K-K′ line in FIG. 50. FIG. 53 shows a sectional shape of the TFT taken along an L-L′ line in FIG. 50.

First, the repairing method of the interlayer short-circuit 510a will be explained with reference to FIG. 50 to FIG. 52 hereunder. The data bus line 506a is disconnected at the disconnected portions 512a, 512b, and then a contact hole 600 is formed by irradiating the laser beam onto the outside of the disconnected portion 512b. Then, a contact hole 592 is provided on the drain electrode 590 of the TFT that is extended from the data bus line 506a and positioned on the gate bus line 502.

Then, a metal wiring 598 is formed by the laser CVD method to connect the contact hole 596, that is formed to connect the source electrode 594 of the TFT and the pixel electrode 524a, and the contact hole 592 formed to repair. Then, a metal wiring 602 to connect the contact hole 600 and the left side end of the pixel electrode 524a is formed by the laser CVD method.

Accordingly, the detouring route reaching the other disconnected portion side of the data bus line 506a from one disconnected portion side of the data bus line 506a via the contact hole 592, the metal wiring 598, the contact hole 596, the pixel electrode 524a, the metal wiring 602, and the contact hole 600 is constructed, and thus the interlayer short-circuit 510a between the data bus line 506a and the data bus line 502 can be repaired.

Then, the repairing method of the interlayer short-circuit 510b will be explained with reference to FIG. 50 and FIG. 53 hereunder. The data bus line 506a is disconnected at the disconnected portions 512c, 512d, and then contact holes 604, 608 are formed by irradiating the laser beam onto the insulating film in vicinity of both disconnected portions 512a, 512b respectively. Then, metal wirings 606, 700 for connecting the contact holes 604, 608 and the pixel electrode 524b are formed by the laser CVD method respectively.

Accordingly, the detouring route reaching the other disconnected portion side of the data bus line 506b from one disconnected portion side of the data bus line 506b via the contact hole 604, the metal wiring 606, the pixel electrode 524b, the metal wiring 700, and the contact hole 608 is constructed, and thus the interlayer short-circuit 510b between the data bus line 506b and the storage capacitance bus line 526 can be repaired.

In the above first and second embodiments, the laser CVD method is applied as the method of forming the conductive film in the predetermined area to repair the fault, but the present invention is not limited to this method. For example, it is a matter of course that the conductive film may be formed by baking the chemicals.

(Third Embodiment)

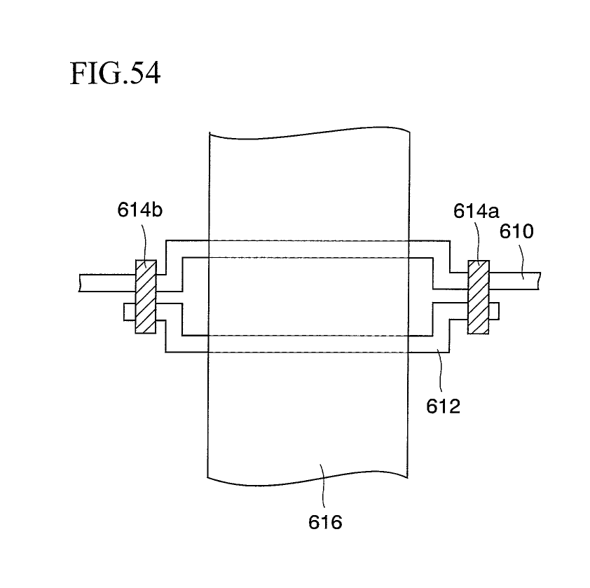

FIG. 54 is a view showing the principle of the invention set forth in claims 11 to 15 in the present invention.

In the present invention, a repairing auxiliary wiring 612 that is independent from the gate bus line 610 is arranged adjacent to the gate bus line 610. The repairing auxiliary wiring 612 is positioned such that it intersects orthogonally with a storage capacitance bus line general electrode 616, like the gate bus line 610, but both ends of the repairing auxiliary wiring 612 do not overlap with the storage capacitance bus line general electrode 616. In addition, repairing connection electrodes 614a, 614b are provided on both sides of the storage capacitance bus line general electrode 616 to intersect orthogonally with the gate bus line 610 and the repairing auxiliary wiring 612.

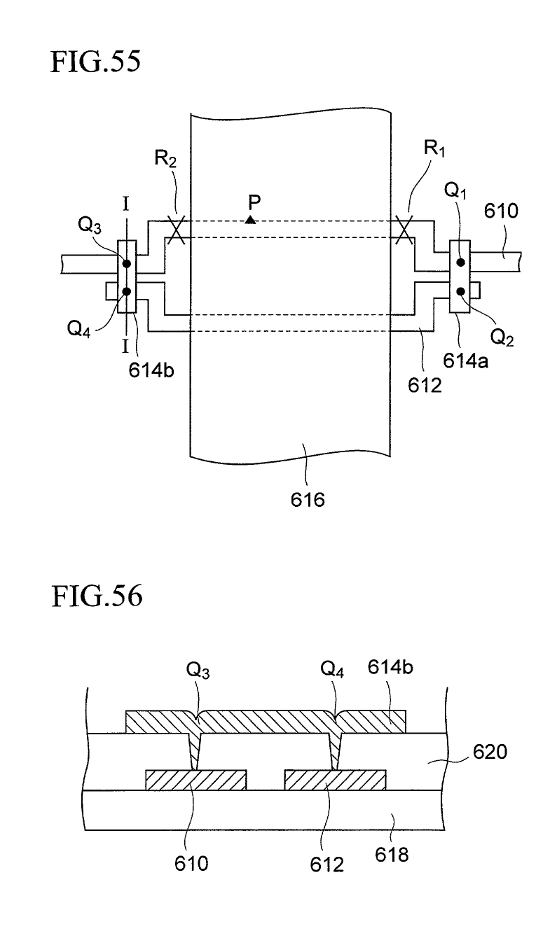

FIG. 55 is a view showing the short-circuit fault repairing method.

The gate bus line 610 and the storage capacitance bus line general electrode 616 are short-circuited at a point P. In such case, first two points R1, R2 located on both sides of the storage capacitance bus line general electrode 616 are disconnected by the laser beam irradiation, etc. to separate the short-circuited portion from the gate bus line 610. Then, the gate bus line 610 and the repairing auxiliary wiring 612 are connected mutually by the laser beam irradiation, etc. at four points Q1 to Q4 at which the gate bus line 610 and the repairing auxiliary wiring 612 intersect orthogonally with each other. In this manner, the fault is repaired.

FIG. 56 is a sectional view taken along a I-I line in FIG. 55.

The gate bus line 610 and the repairing auxiliary wiring 612 are formed independently on the insulating substrate 618. The gate bus line 610 and the repairing auxiliary wiring 612 are formed simultaneously by patterning the same conductive film. Also, the storage capacitance bus line is formed by the same steps. A repairing connection electrode 614b (614a) is formed on the gate bus line 610 and the repairing auxiliary wiring 612 via an insulating film (gate insulating film) 620. The repairing connection electrode 614b (614a) is formed simultaneously by the same material in the steps applied to form the drain electrode of the TFT and the data bus line. The storage capacitance bus line general electrode 616 is formed by the same steps as the data bus line. Upon repairing the fault, the gate bus line 610 and the repairing auxiliary wiring 612 are connected electrically by applying the laser beam irradiation, etc. to the portions (points Q3, Q4), at which the repairing connection electrode 614b (614a) and the gate bus line 610 and the repairing auxiliary wiring 612 intersect orthogonally mutually, to melt the repairing connection electrode 614b.

As the method of connecting the repairing connection electrode 614b and the gate bus line 610 and the repairing auxiliary wiring 612, there may be used the so-called laser CVD method, in which the metal film is formed selectively on the substrate surface by irradiating the laser beam to the atmosphere containing the metal, in addition to the above melting of the conductive layer by the laser beam irradiation. Also, since the conductive film can be formed at any position if this laser CVD method is employed, there is no necessity to form previously the repairing connection electrode 614b.

More particularly, in FIG. 55 and FIG. 56 (assuming repair wirings that the repairing connection electrode 614a and 614b are not provided), if the gate bus line 610 and the storage capacitance bus line general electrode 616 are short-circuited at the point P, the gate bus line 610 is disconnected at two points R1, R2 located on both sides of the storage capacitance bus line general electrode 616. Then, the insulating film 620 formed on the gate bus line 610 and the repairing auxiliary wiring 612 is removed at four points Q1 to Q4 to expose the gate bus line 610 and the repairing auxiliary wiring 612. Then, the conductive films for connecting the points Q1 and Q2 and the points Q3 and Q4 are formed by the laser CVD method. In this way, the fault can be repaired.

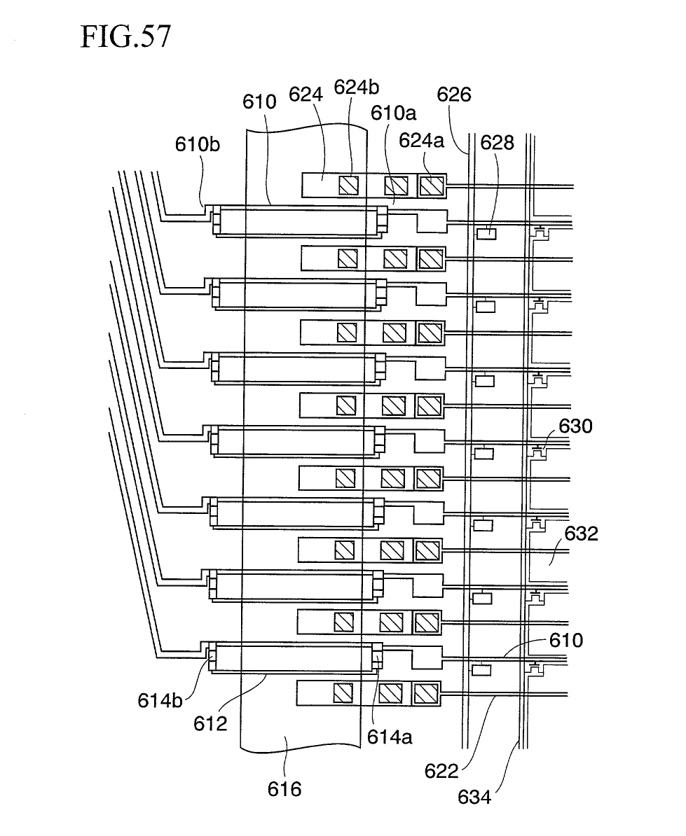

FIG. 57 is a view showing a short-circuit repairing method for the liquid crystal display device according to the third embodiment of the present invention.

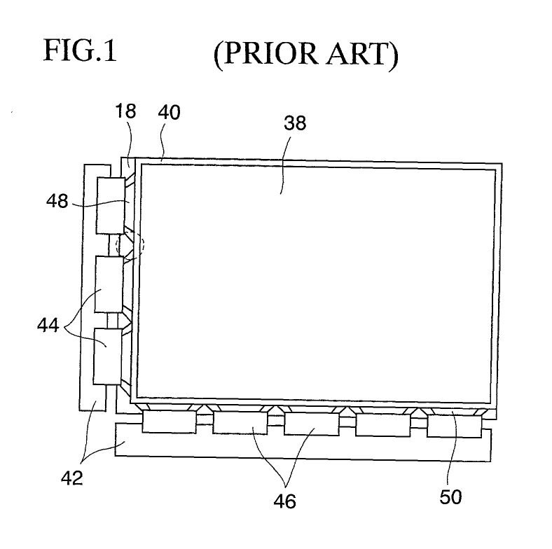

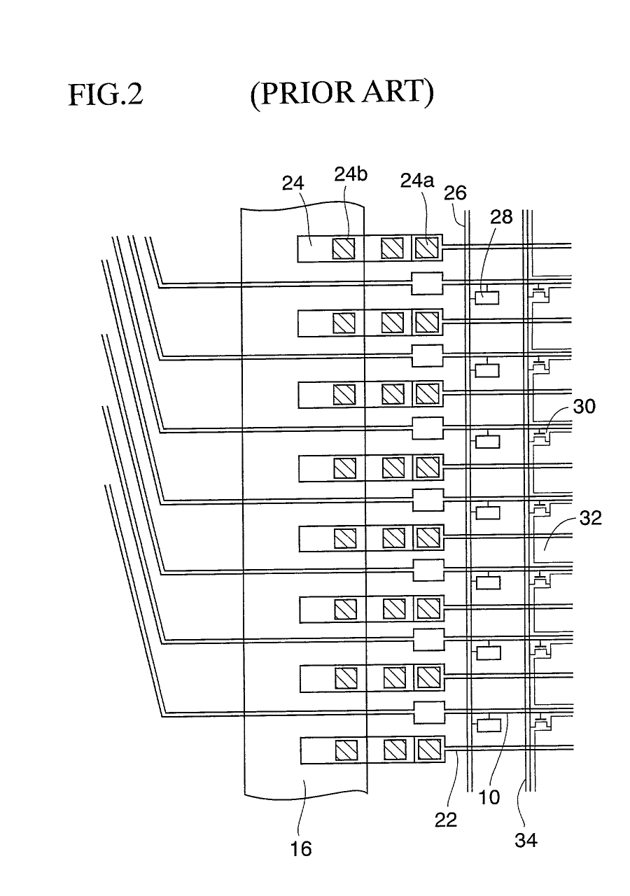

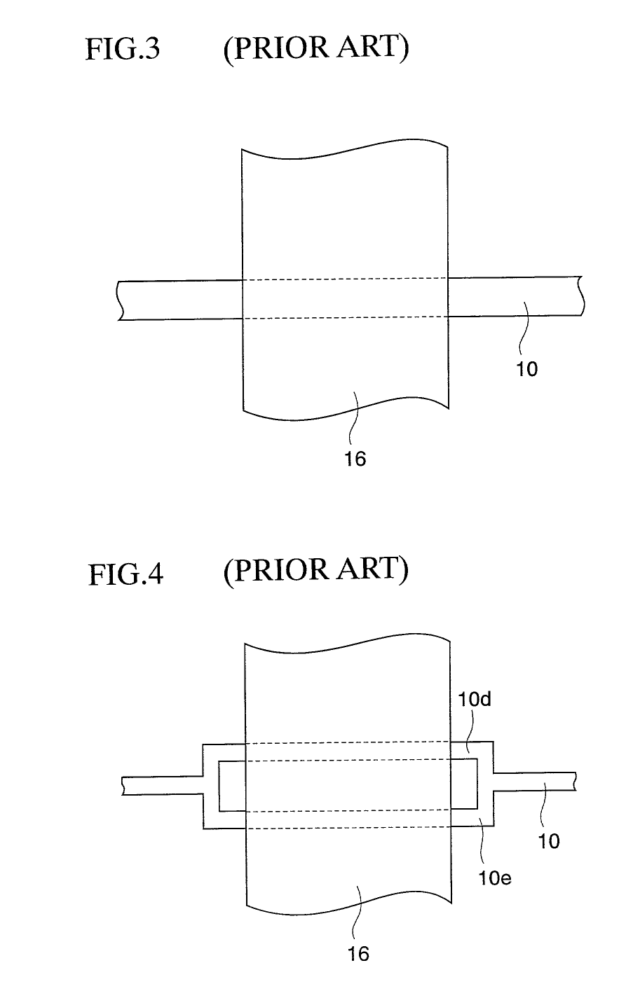

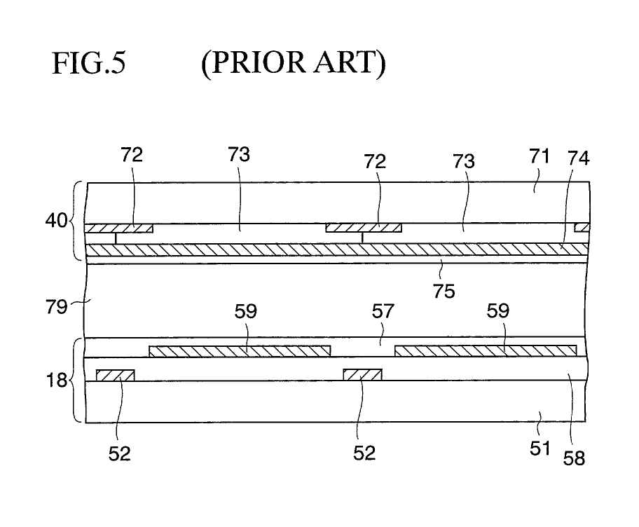

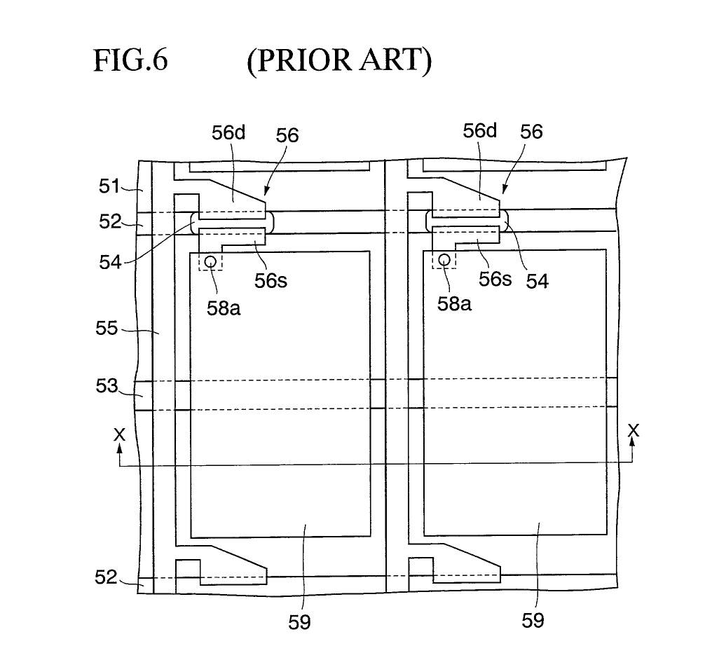

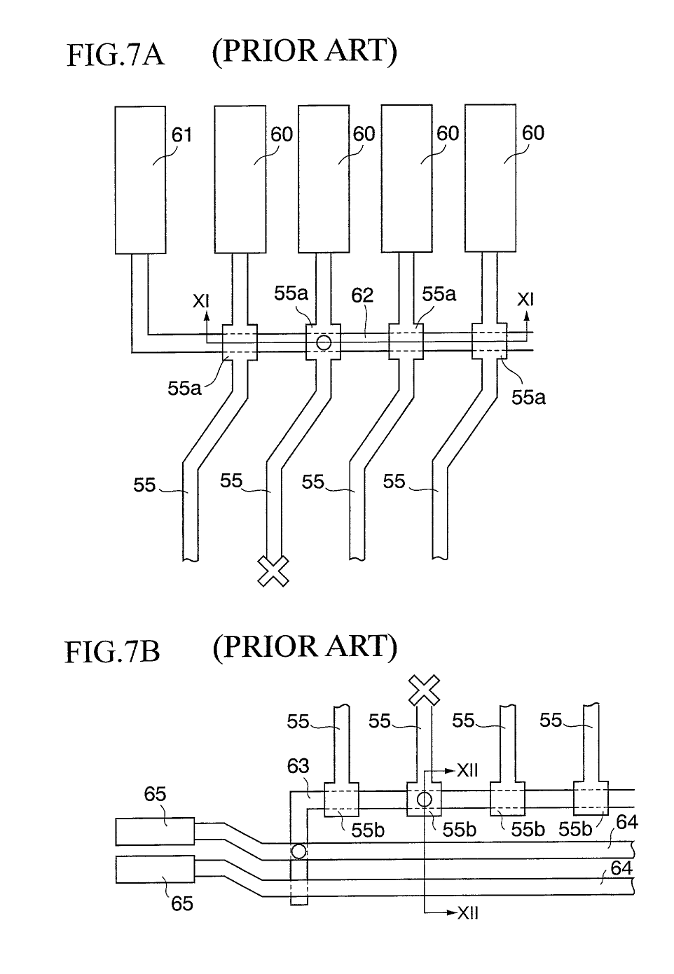

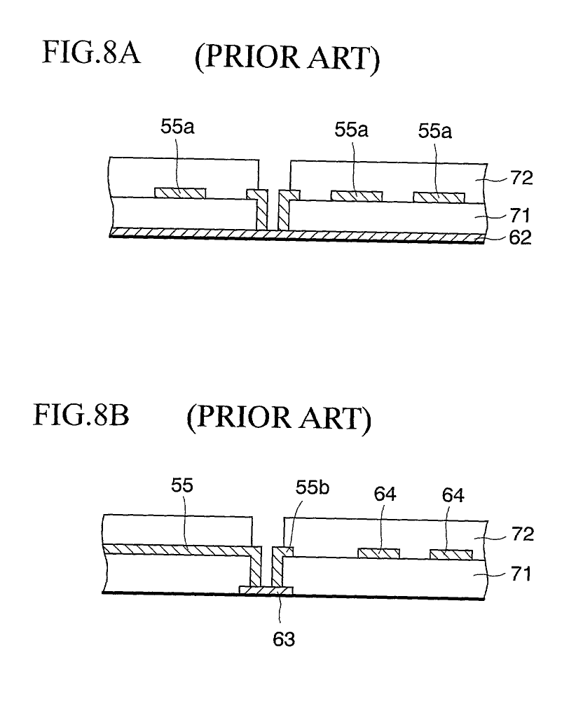

In the liquid crystal display device of the present invention, the gate bus lines are extracted only to the left side, like FIG. 1, and thus the gate bus lines and the storage capacitance bus line general electrode intersect mutually only on the left end portion. FIG. 57 shows the area in which the gate bus line 610 and the storage capacitance bus line general electrode 616 intersect mutually. Since the storage capacitance bus line general electrode 616 is formed in the same layer as the data bus line 634 and formed by the same material by the same steps, it is arranged to extend in parallel with the data bus line 634 and intersect with the gate bus line 610. The difference of the example in FIG. 57 from the conventional configuration in FIG. 2 resides in that the repairing auxiliary wiring 612 and the repairing connection electrode 614a and 614b are provided near the intersecting portion between the gate bus line 610 and the storage capacitance bus line general electrode 616.

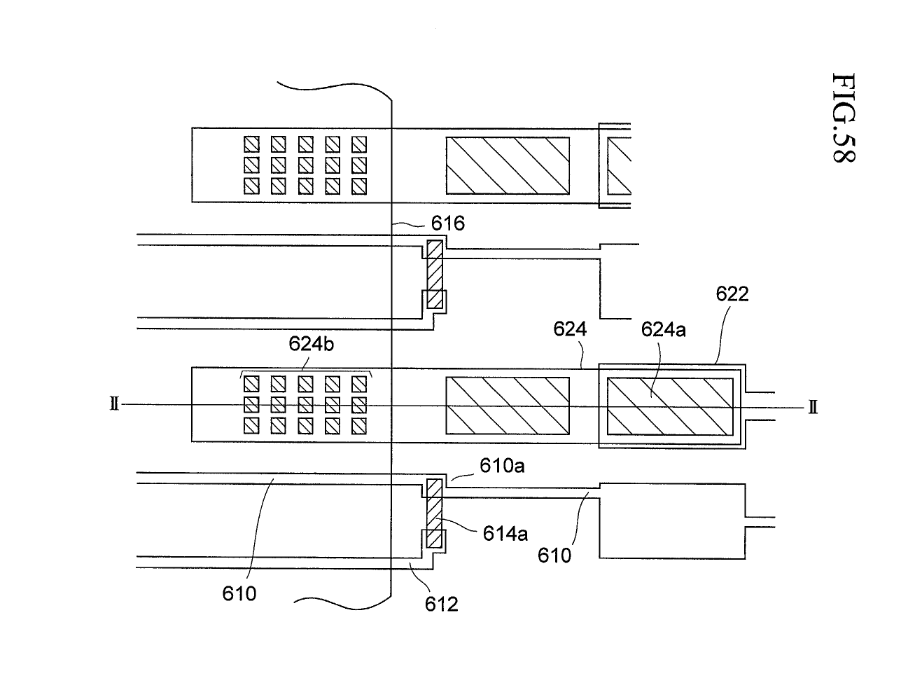

FIG. 58 is a partially enlarged view showing a part of the liquid crystal display device in FIG. 57. Bending portions 610a, 610b (see FIG. 57) are provided to the gate bus line 610, and such bending portions 610a, 610b are formed wider than the normal wiring width. The gate bus line 610 is overlapped with the repairing connection electrode 614a, 614b at the bending portions 610a, 610b (see FIG. 57). In this case, the insulating film is present between the bending portions 610a, 610b and the repairing connection electrodes 614a, 614b. The reason for that the width of the overlapped portion is extended is to take into consideration the event that a part of the gate bus line 610 disappears due to the laser process described later. Also, the repairing auxiliary wiring 612 is provided close to but electrically independently to the gate bus line 610. The repairing auxiliary wiring 612 is formed to have the substantially same wiring width as the gate bus line 610. A top end portion of the repairing auxiliary wiring 612 is extended in width like the bending portion 610a of the gate bus line 610 and is overlapped with the repairing connection electrodes 614a, 614b.

According to such configuration, it is feasible to check the presence of the short-circuit by performing the electrical test. In addition, since the repairing auxiliary wiring 612 and the gate bus line 610 are provided independently prior to the repairing process and not electrically connected mutually, the disconnected portion to be separated or the portion to be electrically connected can be decided if the short-circuited gate bus line 610 can be identified. Thus, a repairing rate can be improved.

Storage capacitance bus lines 622 and the storage capacitance bus line general electrode 616 are connected via storage capacitance bus line connecting electrodes 624, that are formed by the same steps as the pixel electrode, via the connection portions 624a, 624b.

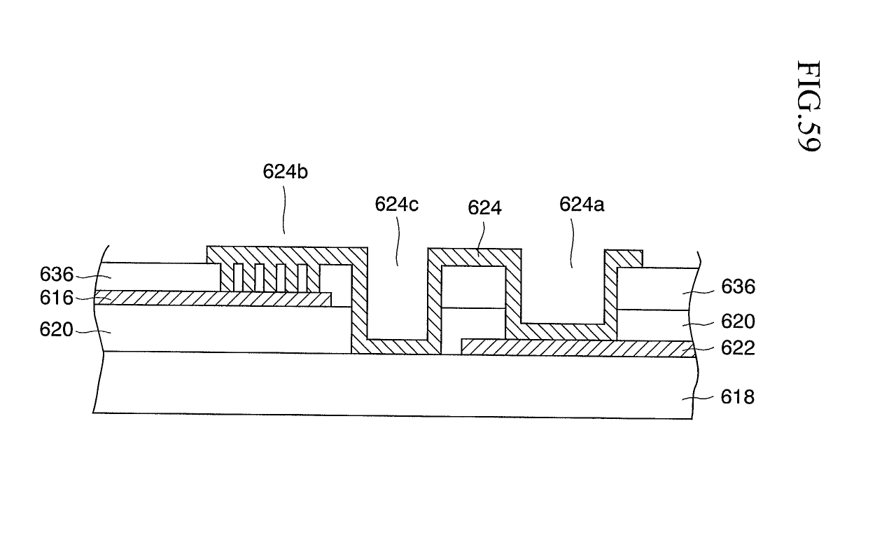

FIG. 59 is a view showing the connected portion between the storage capacitance bus lines 622 and the storage capacitance bus line general electrode 616, and a sectional view taken along a II-II line in FIG. 58.

The storage capacitance bus lines 622 that are formed by the same steps as the gate bus line 610 to constitute the storage capacitances together with the pixel electrodes 632 respectively are provided on the insulating substrate 618. The storage capacitance bus line general electrode 616 is formed by the same steps as the data bus lines 634 and provided on the gate insulating film 620. The storage capacitance bus line connecting electrodes 624 are formed by the same steps as the pixel electrodes 632 to connect electrically the storage capacitance bus lines 622 and the storage capacitance bus line general electrode 616 via connection portions 624a, that are provided by opening the gate insulating film 620 and the protection film 636 on the storage capacitance bus lines 622, and connection portions 624b, that are provided by opening the protection film 636 on the storage capacitance bus line general electrode 616. In order to improve the adhesiveness of the storage capacitance bus line connecting electrodes 624, connection portions 624c are provided to come into contact with the insulating substrate 618.

(Fourth Embodiment)

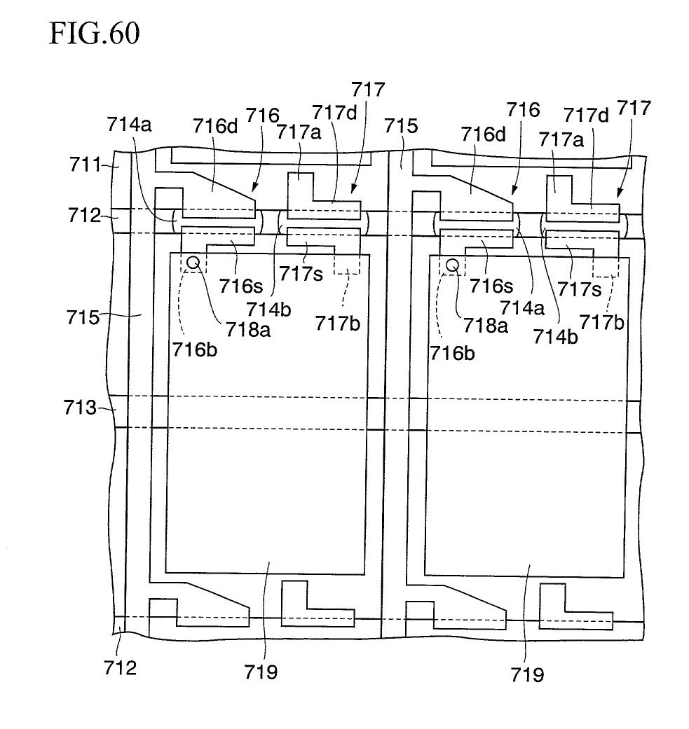

FIG. 60 is a plan view showing the TFT substrate of the liquid crystal display device according to a fourth embodiment of the present invention. Since the CF substrate is basically identical to the CF substrate in the prior art, explanation of the CF substrate will be omitted herein.

As shown in FIG. 60, spare TFTs 717 in addition to TFTs 716 serving as the switching element are provided to the TFT substrate of the liquid crystal display device according to the fourth embodiment.

More particularly, a plurality of gate bus lines 712 and a plurality of storage capacitance bus lines 713 are formed as the first wiring layer on a glass substrate 711. Respective gate bus lines 712 are formed in parallel mutually, and the storage capacitance bus lines 713 are arranged in parallel with the gate bus lines 712 between the gate bus lines 712 respectively. This first wiring layer is formed of Cr (chromium), for example.

The gate bus lines 712 and the storage capacitance bus lines 713 are covered with a first insulating film (gate insulating film; not shown) formed of silicon oxide. Silicon films (amorphous silicon film or polysilicon film) 714a, 714b serving as the channels of the TFTs 716, 717 are formed on the first insulating film. Also, a plurality of data bus lines 715, source electrodes 716s and drain electrodes 716d of the TFTs 716, and source electrodes 717s and drain electrodes 717d of the spare TFTs 717 are formed as the second wiring layer on the first insulating film. This second wiring layer has a triple-layered structure that is formed of Ti (titanium)/Al (aluminum)/Ti (titanium), for example.

The data bus lines 715 are formed to intersect orthogonally with the gate bus lines 712. The source electrodes 716s and the drain electrodes 716d are formed on both sides of the silicon films 714a in the width direction to be separated mutually. The source electrodes 717s and the drain electrodes 717d are formed on both sides of the silicon films 714b in the width direction to be separated mutually. Rectangular areas partitioned by the gate bus lines 712 and the data bus lines 715 are the pixel areas respectively.

The data bus lines 715, the TFTs 716, and the TFTs 717 are covered with a second insulating film (protection insulating film; not shown) formed of silicon oxide. Pixel electrodes 719 made of ITO are formed on the second insulating film.

As shown in FIG. 60, the source electrodes 716s of the TFTs 716 are connected to the data bus lines 715, and source electrode terminals 716b are connected to the pixel electrodes 719 via the contact holes 718a formed in the protection insulating film.

Meanwhile, the drain electrode terminals 717a and the source electrode terminals 717b of the spare TFTs 717 are connected to nowhere. This is because, if the spare TFTs 717 are connected to the data bus lines 715 and the pixel electrodes 719, large load capacitances (Cgs) are generated between the gate bus lines 712 and the data bus line 715 and the pixel electrodes 719 to cause the degradation of the display quality. In this case, in the fourth embodiment, the source electrode terminals 717b are formed at positions that overlap partially with the pixel electrodes 719.

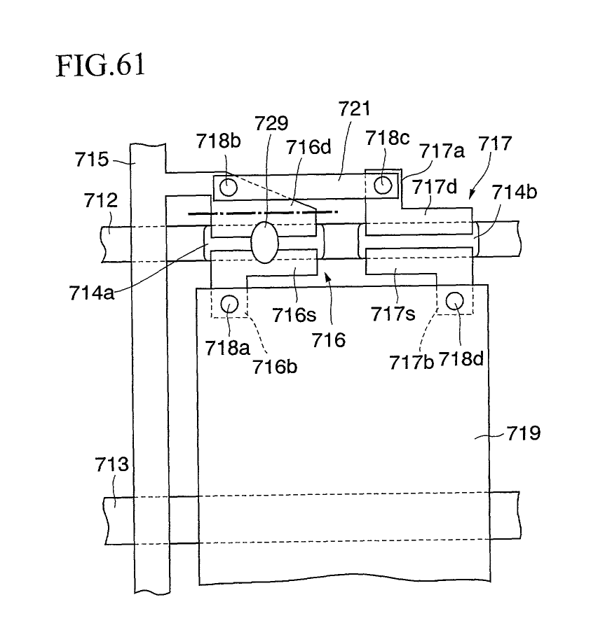

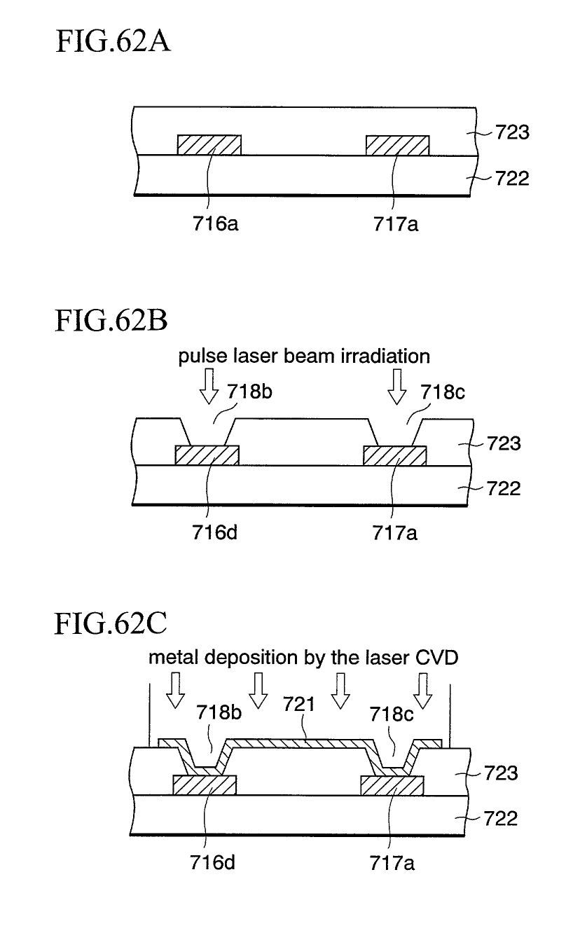

The fault repairing method for the liquid crystal display panel according to the fourth embodiment of the present invention will be explained with reference to FIG. 61 and FIGS. 62A to 62C hereunder. In this fourth embodiment, as shown in FIG. 61, the fault repairing method applied to the case where the source electrodes 716s and the drain electrodes 716d of the TFTs 716 are short-circuited by a foreign matter 729 will be explained.

FIGS. 62A to 62C are schematic sectional views showing the fault repairing method in the order of steps. In FIGS. 62A to 62C, a symbol 722 denotes the first insulating film (gate insulating film), and a symbol 723 denotes the second insulating film (protection insulating film).

First, the pixel electrode 719 and the data bus line 715 are electrically separated mutually. For example, the drain electrode 716d is disconnected at a portion indicated by a dot-dash line in FIG. 61 by irradiating the pulse laser beam, for example.

Then, the contact holes 718b, 718c are formed on the drain electrode 716d (the portion connected to the data bus line 715) of the TFT 716 and the drain electrode terminal 717a of the spare TFT 717. More particularly, as shown in FIG. 62A, the laser pulse is irradiated to the second insulating film 723 on the drain electrode 716d and the terminal 717a and thus, as shown in FIG. 62B, the contact holes 718b, 718c are formed. Since this laser beam irradiation intends not to melt the drain electrode 716d and the terminal 717a but form the contact hole in the second insulating film 723, the short-wavelength laser beam is employed. For example, if the third harmonic (wavelength 355 nm) or the fourth harmonic (wavelength 266 nm) of the YAG laser is employed, the contact holes 718b, 718c can be formed in the second insulating film 723 without the melting of the drain electrode 716d and the terminal 717a.

Then, as shown in FIG. 62C, a conductive pattern (wiring) 721 that connects electrically the drain electrode 716d and the terminal 717a is formed by the laser CVD method. According to the laser CVD, the conductive pattern 721 is formed by continuously irradiating the YAG laser beam whose wavelength is 355 nm, while flowing locally the Ar (argon) gas containing W (tungsten) organic metal, Mo (molybdenum) organic metal, or Cr (chromium) organic metal around the conductive pattern forming area. At this time, the concentration of the organic metal gas, the laser power, the scanning rate, and the number of times of scanning are adjusted appropriately. For example, as the conductive pattern 721 forming condition parameters for the laser CVD, the scanning rate is 3.0 μm/sec, the laser transmittance rate is 55%, the laser Q switching frequency is 4 kHz, the flow rate of the carrier gas is 90 cc/min, the temperature of the material gas is 53° C., and the slit size of the film forming area is 5 μm×5 μm. When the inventors of this application formed actually the conductive pattern formed of tungsten, the conductive pattern in which the minimum drawing line width was 5 μm, the film thickness was 30 nm, and the specific resistance was less than 50 μΩcm could be formed.

In contrast, the source electrode 717s of the spare TFT 717 is connected electrically to the pixel electrode 719. That is, the contact hole 718d in the second insulating film 723 is formed by irradiating the YAG laser beam, for example, to the overlapped areas of the source electrode terminal 717b and the pixel electrode 719, and also the pixel electrode 719 and the source electrode 717s are connected electrically by melt-jointing (laser welding) the pixel electrode 719 in the concerned area and the source electrode 717s.

Accordingly, the fault repair of the liquid crystal panel can be completed.

According to the fault repairing method for the liquid crystal display device of the fourth embodiment, since the conductive pattern for connecting the drain electrode 717d of the spare TFT 717 and the data bus line 715 is formed by the laser CVD method and then the source electrode 717s of the spare TFT 717 and the pixel electrode 719 are connected by the melt-joint using the laser, the defective pixel can be restored into the normal pixel. That is, according to the fourth embodiment, since the fault is not made inconspicuous but the defective pixel is restored into the normal pixel by repairing the fault, the high quality pixel display can be achieved and also the yield of fabrication of the liquid crystal display panel can be improved.

According to the liquid crystal display device of the fourth embodiment, since the source electrode 717s and the drain electrodes 717d of the spare TFT 717 are not connected to the pixel electrodes 719 and the data bus lines 715, the increase of the load capacitance can be avoided.

In the fourth embodiment, the case where the fault caused by the short-circuit between the source electrode 716s and the drain electrodes 716d of the TFT 716 is repaired is explained. But the present invention can be applied to the fault repair caused by the ON characteristic failure of the TFT 716. That is, if the writing ability lacks because of the insufficient ON characteristic of the TFT 716, the source electrode 717s is connected to the pixel electrode 719 by connecting the drain electrodes 717d of the spare TFT 717 to the data bus line 715, without the disconnection of the drain electrode 716d of the TFT 716, like the above embodiment. As a result, two TFTs 716, 717 are connected in parallel to increase the writing ability and thus the reduction in display quality due to the ON characteristic failure of the TFT 716 can be avoided.

In addition, in the fourth embodiment, the conductive pattern 721 is formed after the drain electrode 716d is separated. But the drain electrode 716d may be disconnected after the conductive pattern 721 is formed.

Furthermore, in the fourth embodiment, the case where one spare TFT is provided is explained. Two spare TFTs or more may be provided.

(Fifth Embodiment)

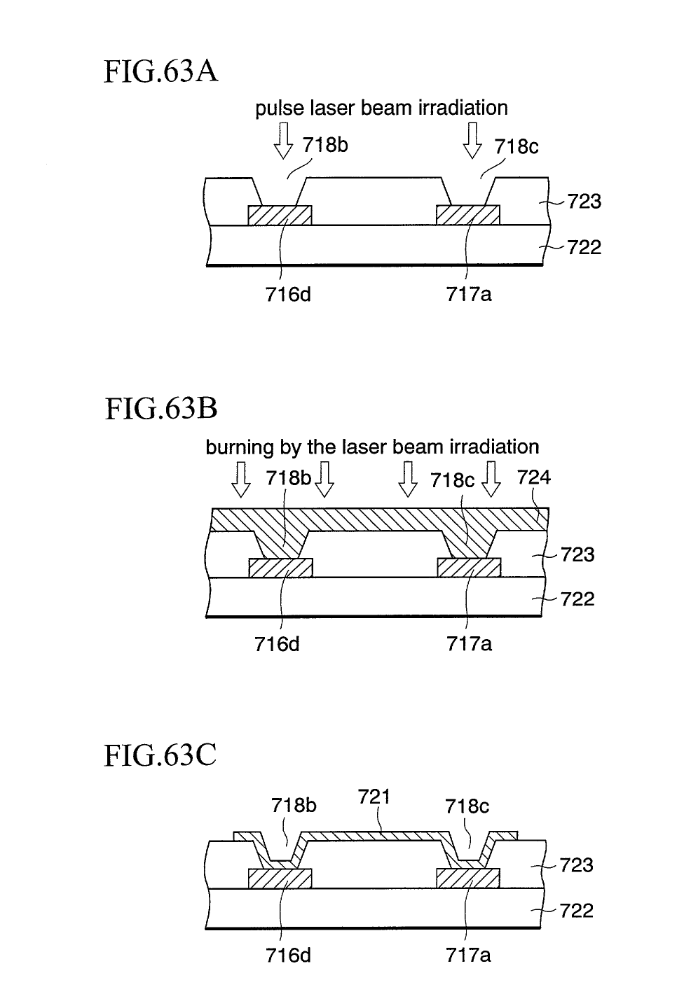

A fifth embodiment of the present invention will be explained with reference to FIGS. 63A to 63C hereunder. Since the fifth embodiment is basically similar to the fourth embodiment except that the conductive pattern forming method is different, their detailed explanation will be omitted by affixing the same symbols to the same constituent elements in FIGS. 63A to 63C as those in FIG. 62.

In the fourth embodiment, the conductive pattern 721 is formed by the laser CVD method. In contrast, in the fifth embodiment, the conductive pattern 721 is formed by baking the conductive paste (conductive chemicals).

More particularly, as shown in FIG. 63A, like the fourth embodiment, contact holes 718b, 718c are formed on the drain electrode 716d of the TFT 716 and the drain electrode terminal 717a of the spare TFT 717 respectively.

Then, as shown in FIG. 63B, conductive paste 724 containing Au (gold), Ag (silver), or the like is coated on the area containing the contact holes 718b, 718c. Then, the conductive paste 724 is baked by irradiating the laser beam to the area containing the contact holes 718b, 718c.

Then, the conductive paste 724 is removed from the unbaked area. As a result, as shown in FIG. 63C, the conductive pattern 721 for connecting the drain electrode 716d of the TFT 716 and the drain electrode terminal 717a of the spare TFT 717 can be completed.

In the fifth embodiment, like the fourth embodiment, the liquid crystal display panel having no defective pixel can be obtained by repairing the fault of the liquid crystal display panel.

(Sixth Embodiment)

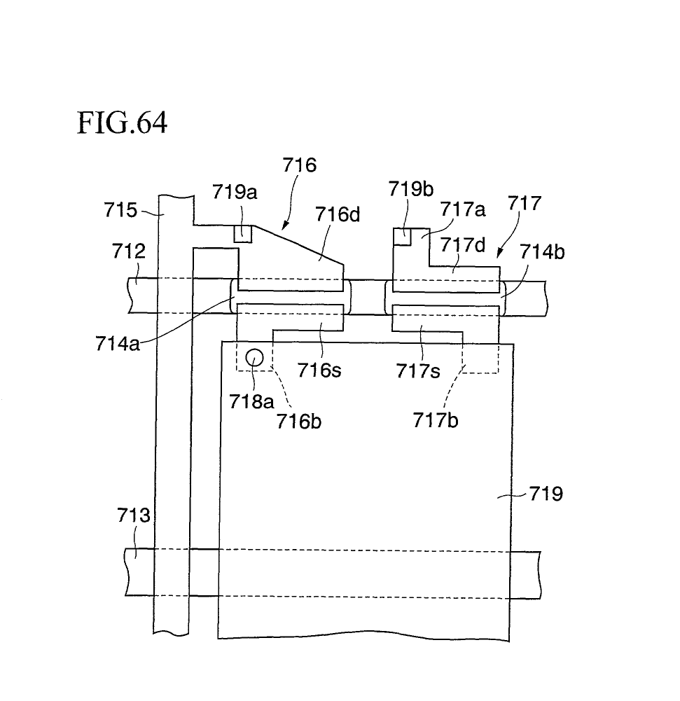

A sixth embodiment of the present invention will be explained with reference to FIG. 64 hereunder. Since the fifth embodiment is basically similar to the fourth embodiment except that the conductive pattern forming method is different, their detailed explanation will be omitted by affixing the same symbols to the same constituent elements in FIG. 64 as those in FIG. 62.

In the sixth embodiment, when the contact hole 718a is formed in the second insulating film after the second insulating film (protection insulating film) is formed, the contact hole reaching the drain electrode 716d of the TFT 716 and the contact hole reaching the drain electrode terminal 717a of the spare TFT 717 are formed simultaneously.

Then, the ITO film is formed on the overall surface. Then, the pixel electrodes 719 are formed by patterning the ITO film and also pads 719a connected to the drain electrodes 716d of the TFTs 716 and pads 719b connected to the drain electrode terminals 717a of the spare TFTs 717 are formed.

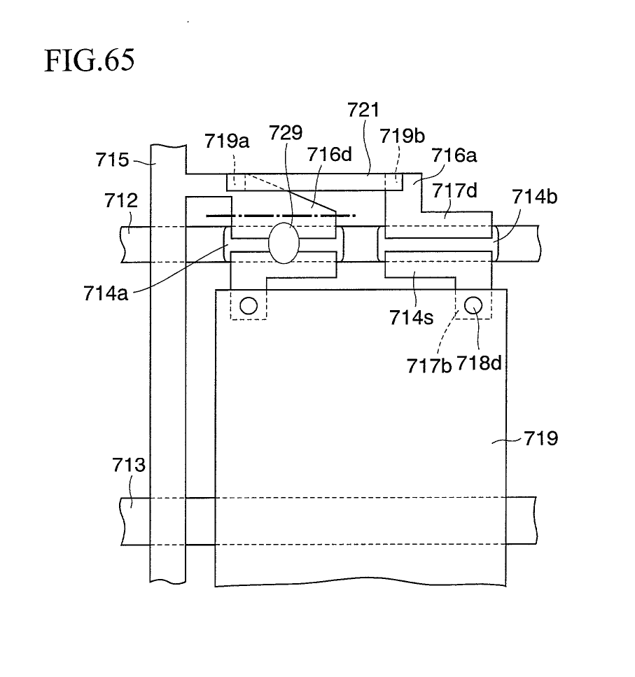

If the short-circuit between the source electrode 716s and the drain electrode 716d of the TFT 716 occurs due to the foreign matter, as shown in FIG. 65, for example, on the TFT substrate constructed in this way, the conductive pattern 721 for connecting the pads 719a, 719b is formed in the same manner as the fourth embodiment or the fifth embodiment. Then, the drain electrode 716d is disconnected at a position indicated by a dot-dash line in FIG. 65, for example.

In this case, if the short-circuit between the source electrode 716s and the drain electrode 716d of the TFT 716 does not occur but the ON characteristic failure of the TFT 716 is caused, there is no necessity to disconnect the drain electrode 716d.

According to the sixth embodiment, in addition to the advantages obtained in the fourth embodiment, there is such an advantage that there is no need to form the contact hole in the second insulating film by irradiating the laser beam in repairing the fault. Also, since the pads 719a, 719b are formed simultaneously with the pixel electrodes 719, the increase in the number of steps can be avoided.

(Seventh Embodiment)

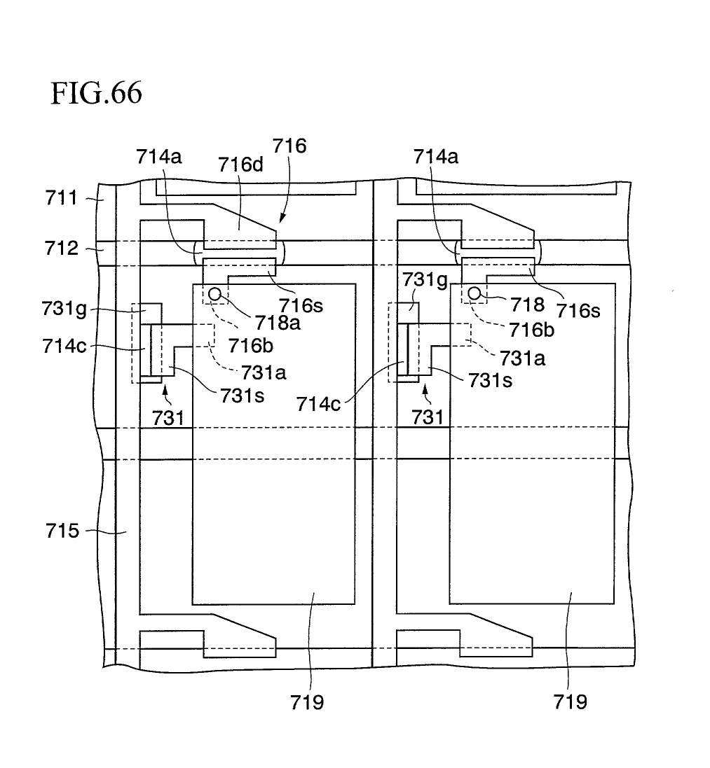

FIG. 66 is a view showing the TFT substrate of the liquid crystal display device according to a seventh embodiment of the present invention. In FIG. 66, the same symbols are affixed to the same constituent elements as those in FIG. 60 and their detailed explanation will be omitted. Also, in the seventh embodiment, since the configuration of the CF substrate is basically similar to that in the prior art, the explanation of the CF substrate will be omitted.

On the TFT substrate of the liquid crystal display device according to the seventh embodiment, a spare TFT 731 is provided every pixel in addition to the TFT 716 serving as the switching element.

This spare TFT 731 consists of a gate electrode 731g formed in the first wiring layer in which the gate bus line 712 and the storage capacitance bus line 713 are formed, a silicon film 714c formed on the gate electrode 731g via the first insulating film, and the data bus line 715 and a source electrode 731s arranged on both sides of the silicon film 714c in the width direction. The source electrode 731s is arranged in the second wiring layer like the data bus line 715. The source electrode 731s is connected to nowhere. In this case, a source electrode terminal 731a overlaps with a part of the pixel electrode 719 to put the protection insulating film between them. Also, the portion of the data bus line 715 that overlaps with the silicon film 714c acts as the drain electrode of the TFT 731.

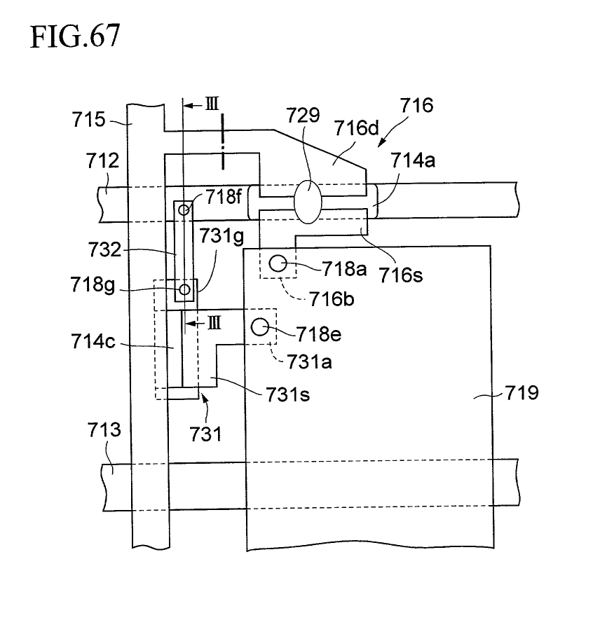

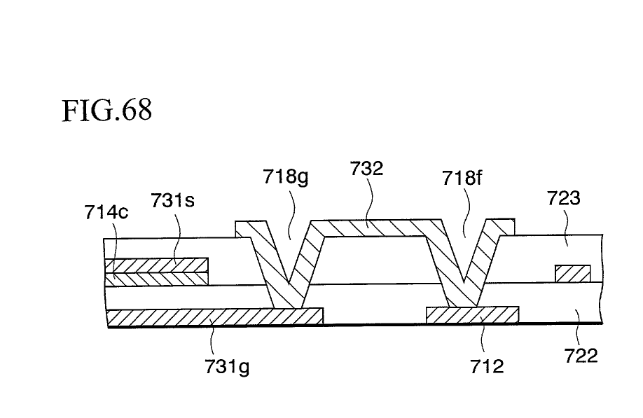

The fault repairing method for the liquid crystal display panel according to the seventh embodiment will be explained with reference to FIG. 67 and FIG. 68 hereunder. FIG. 68 is a sectional view taken along a III-III line in FIG. 67. In this seventh embodiment, as shown in FIG. 67, the fault repair applied when the short-circuit between the drain electrode 716d and the source electrode 716s of the TFT 716 occurs due to the foreign matter 729 will be explained hereunder.

First, the pixel electrode 719 and the data bus line 715 are disconnected electrically. The connecting portion (portion indicated by a dot-dash line in FIG. 67) between the drain electrode 716d and the data bus line 715 is cut off by irradiating the pulse laser beam, for example.

Then, contact holes 718g, 718f are formed on the gate electrode 731g and the gate bus line 712. As explained in the fourth embodiment, the third harmonic or the fourth harmonic of the YAG laser is employed to form the contact holes 718g, 718f.

Then, the conductive pattern for connecting electrically the gate electrode 731g and the gate bus line 712 is formed by the laser CVD method. According to the laser CVD, the conductive pattern 732 is formed by continuously irradiating the YAG laser beam whose wavelength is 355 nm, while flowing the Ar (argon) gas containing W (tungsten) organic metal, Mo (molybdenum) organic metal, or Cr (chromium) organic metal.

Then, the source electrode 731s of the spare TFT 731 and the pixel electrode 719 are connected electrically. That is, the contact hole 718e is formed in the second insulating film 723 by irradiating the YAG laser beam, for example, to the overlapped areas of the source electrode terminal 731a and the pixel electrode 719, and also the pixel electrode 719 and the source electrode 731s are connected electrically by melt-jointing (laser welding) the pixel electrode 719 in the concerned area and the source electrode 717s. Accordingly, the fault repair of the liquid crystal panel can be completed.

In the seventh embodiment, in the case of the ON characteristic failure of the TFT 716, there is no need to disconnect the TFT 716 and the data bus line 715. Also, like the fifth embodiment, the conductive pattern 732 may be formed by baking the conductive paste. In addition, like the sixth embodiment, the pads may be formed previously at the positions that correspond to the contact holes 718f, 718g. As a result, there are omitted the steps of forming the contact holes in repairing the fault.

Besides, in the above fourth to seventh embodiment, the fault repair of the liquid crystal display device in which the protection insulating film is formed on the TFTs is explained. But the present invention may be applied to the liquid crystal display device in which the protection insulating film is not formed. In this case, the steps of forming the contact holes can be omitted.

(Eighth Embodiment)

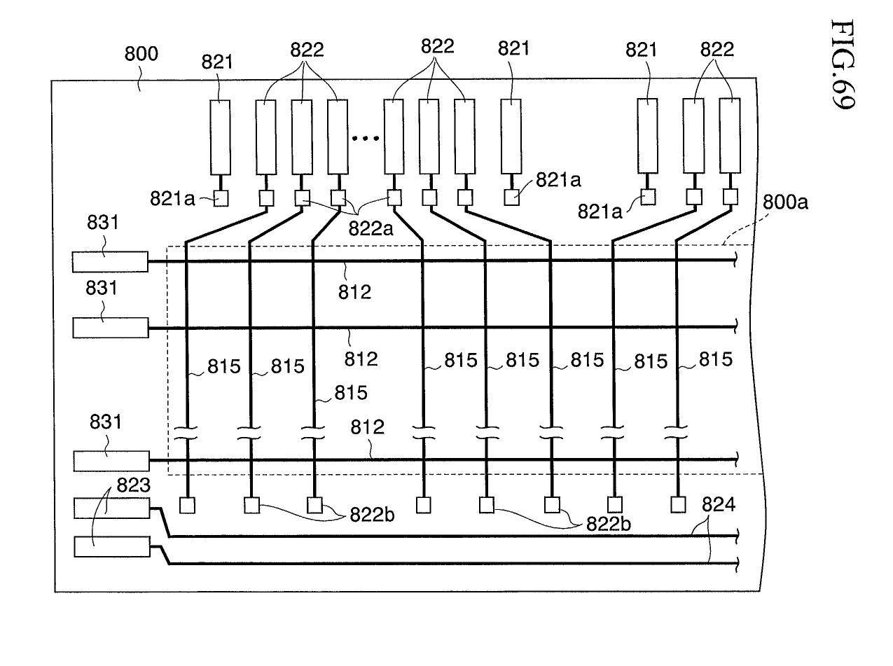

FIG. 69 is a schematic view showing a TFT substrate of a liquid crystal display device according to an eighth embodiment of the present invention. In the eighth embodiment, since the configuration of the CF substrate is basically similar to that in the prior art, the explanation of the CF substrate will be omitted.

A plurality of gate bus lines 812 and a plurality of data bus lines 815 are formed in a display area 800a of a TFT substrate 800. The rectangular areas partitioned by the gate bus lines 812 and the data bus lines 815 are the pixels respectively. Although the TFT, the pixel electrode, and the auxiliary capacitance are formed in the pixel respectively, their illustration is omitted in FIG. 69.

TAB terminals 822 and spare TAB terminals 821 are aligned along one side (referred to as a “first side” hereinafter) of the TFT substrate 800. The TAB terminals 822 are divided into a plurality of groups, and the spare TAB terminals 821 are arranged such that two spare TAB terminals 821 are assigned to each group to put the group between them. Each spare TAB terminal 821 is connected to the corresponding data bus line 815. The video signals are supplied to these TAB terminals 822 via the TAB substrate (see FIG. 1).

An alignment pitch of the TAB terminals 822 is set smaller than an alignment pitch of the data bus lines 815. Also, a repair terminal 822a is provided to each data bus line 815 in vicinity of the TAB terminal 822, and a repair terminal 822b is provided to the other end side. While, the spare TAB terminals 821 are connected to the repair terminals 821a that are arranged in vicinity of the spare TAB terminals 821 respectively.

One or a plurality (two in FIG. 69) of repair wirings 824 are formed near the side of the TFT substrate 800 opposing to the first side (referred to as a “second side” hereinafter) in parallel with the second side.

Also, TAB terminals 831 and spare TAB terminals 823 are aligned along other one side (referred to as a “first side” hereinafter) adjacent to the first side of the TFT substrate 800. Each TAB terminal 831 is connected to the corresponding gate bus line 812. Also, each spare TAB terminal 823 is connected to the repair wiring 824. The scanning signals are supplied to these TAB terminals 831 via the TAB substrate (see FIG. 1).

As shown in FIG. 69, all the TAB terminals 822, 831, the spare TAB terminals 821, 823, the repair terminals 822a, 822b, and the repair wiring 824 are provided on the outside of the display area 800a. Also, the repair terminals 822b of the data bus lines 815 are arranged near the repair wiring 824.

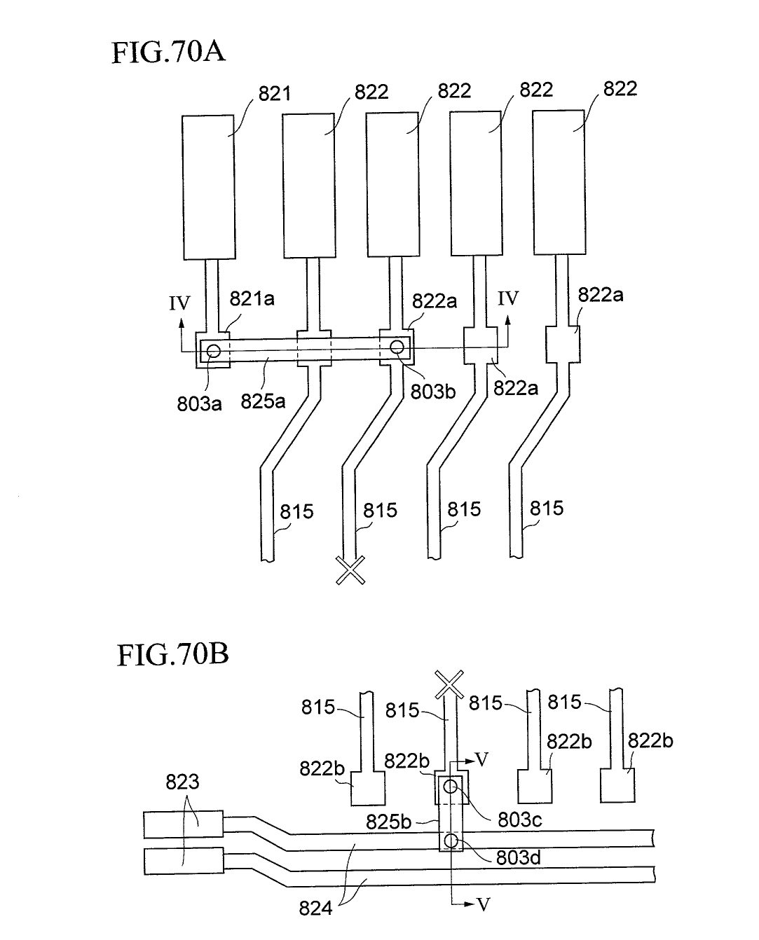

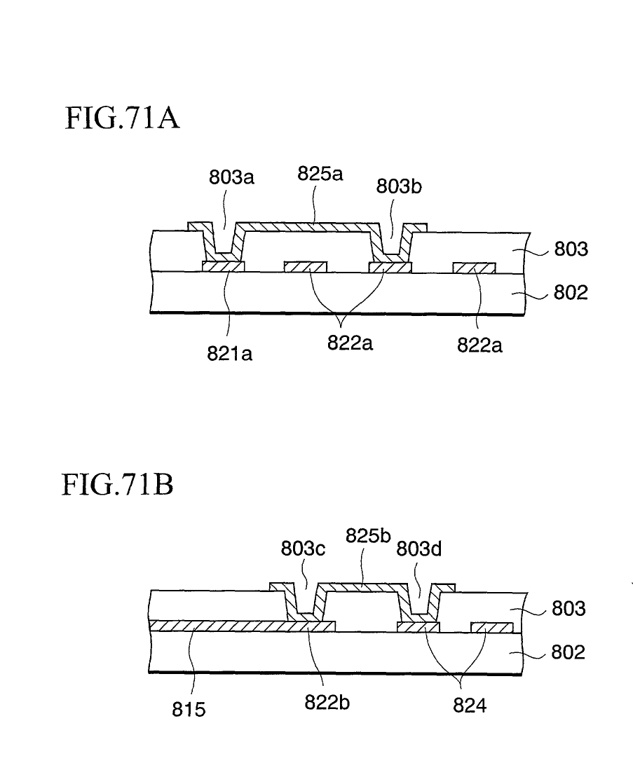

The fault repairing method for the liquid crystal display device according to the eighth embodiment will be explained with reference to FIGS. 70A and 70B and FIGS. 71A and 71B hereunder. FIG. 71A is a sectional view taken along a IV-IV line in FIG. 70A, and FIG. 71B is a sectional view taken along a V-V line in FIG. 70B.

In this eighth embodiment, it is on the assumption that the disconnection of the data bus line 815 occurs at portions indicated by a × mark in FIGS. 70A and 70B. Also, in FIGS. 71A and 71B, 802 denotes the first insulating film (gate insulating film) provided to the TAB substrate 800, and 803 denotes the second insulating film (protection insulating film).

First, contact holes 803a to 803d are formed by irradiating the laser beam onto the repair terminals 822a, 822b of the disconnected data bus line 815, the repair terminal 821a of the spare TAB terminal 821, and the repair wiring 824 respectively. According to this laser irradiation, the contact holes 803a to 803d can be formed in the second insulating film 803 by employing the short-wavelength laser beam, without the melting of the repair terminals 821a, 822a, 822b and the repair wiring 824. For example, the third harmonic (wavelength 355 nm) or the fourth harmonic (wavelength 266 nm) of the YAG laser can be employed as the laser beam.

Then, the conductive pattern 825a for connecting electrically the repair terminal 821a and the repair terminal 822a and the conductive pattern 825b for connecting electrically the repair terminal 822b and the repair wiring 824 are formed by the laser CVD method. These conductive patterns 825a, 825b are formed by continuously irradiating the YAG laser beam whose wavelength is 355 nm, while flowing locally the Ar (argon) gas containing W (tungsten) organic metal, Mo (molybdenum) organic metal, or Cr (chromium) organic metal around the conductive pattern forming area. At this time, the concentration of the organic metal gas, the laser power, the scanning rate, and the number of times of scanning are adjusted appropriately. For example, according to the examination made by the inventors of this application, if the scanning rate is 3.0 μm/sec, the laser transmittance rate is 65%, the laser Q switching frequency is 4 kHz, the flow rate of the carrier gas is 89 cc/min, the temperature of the material gas is 52° C., and the slit size of the film forming area is 5 μm×5 μm, the conductive pattern in which the minimum drawing line width is 5 μm, the film thickness is 30 nm, and the specific resistance is less than 50 μΩcm can be formed.

Then, the spare TAB terminal 821 connected to the data bus line 815 and the spare TAB terminal 823 are connected electrically via the wire. Accordingly, the fault repair of the liquid crystal display device can be completed.

According to the fault repairing method for the liquid crystal display device of the eighth embodiment, the repair terminal 822a and the spare TAB terminal 821 and the repair terminal 822b and the repair wiring 824 of the data bus line 815 which is disconnected are connected by the conductive patterns 825a, 825b formed by the laser CVD method respectively. As a result, the line fault caused by the disconnection of the data bus line 815 can be repaired and thus the liquid crystal display device can be restored to the normal liquid crystal display device.

In the above embodiments, the data bus line 815 in which the fault occurs and the spare TAB terminal 821 are connected by the conductive pattern and the spare TAB terminal 821 and the spare TAB terminal 823 are connected by the wire. However, if the TAB terminal 823 and the TAB terminal 822 can be directly connected electrically, the spare TAB terminal 821 and the conductive pattern 825a are not needed.

Also, in the eighth embodiment, the conductive patterns 825a, 825b are formed by the laser CVD method. As explained in the fifth embodiment, the conductive pattern may be formed by baking the conductive paste.

In addition, in the eighth embodiment, the case where two repair wirings 824 are employed is explained. In this case, two disconnected data bus lines can be repaired. But the number of the repair wirings 824 is not limited to two in the present invention, and one or three repair wirings may be employed.

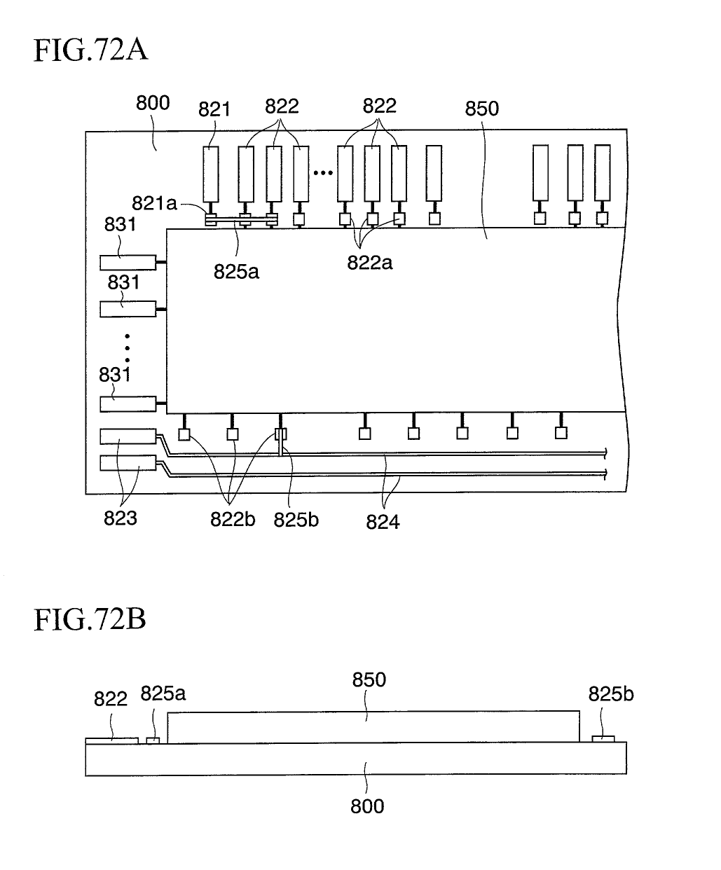

Furthermore, as shown in a plan view of FIG. 72A and a side view of FIG. 72B, if the repair terminals 821a, 822a, 822b and the repair wiring 824 are arranged on the outside of the CF substrate 850, the disconnection of the data bus line 815 can be repaired after the TFT substrate 800 and the CF substrate 850 are jointed together.

(Ninth Embodiment)

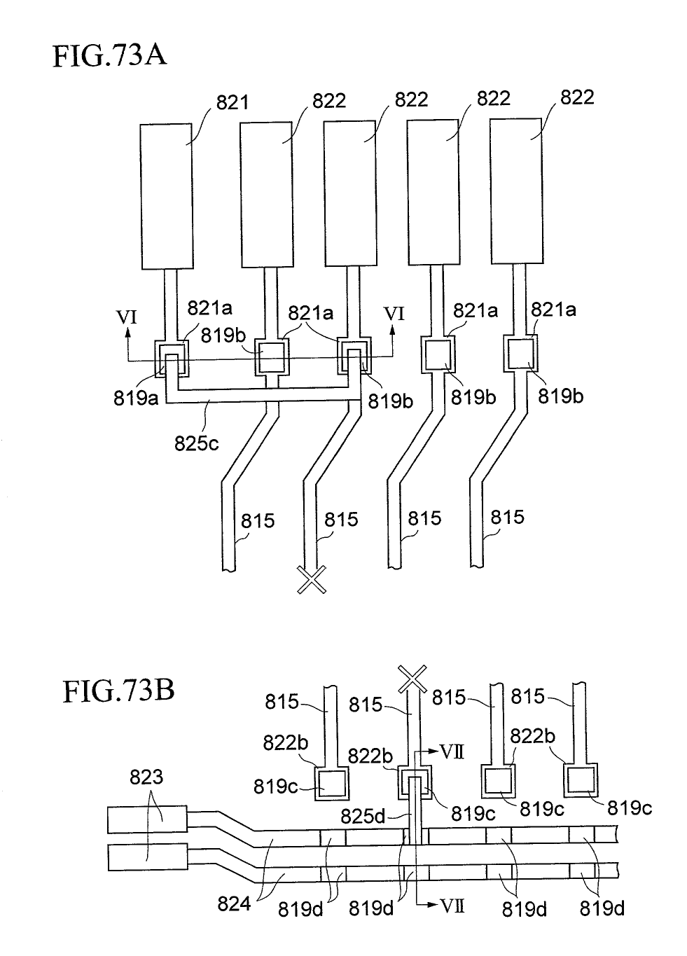

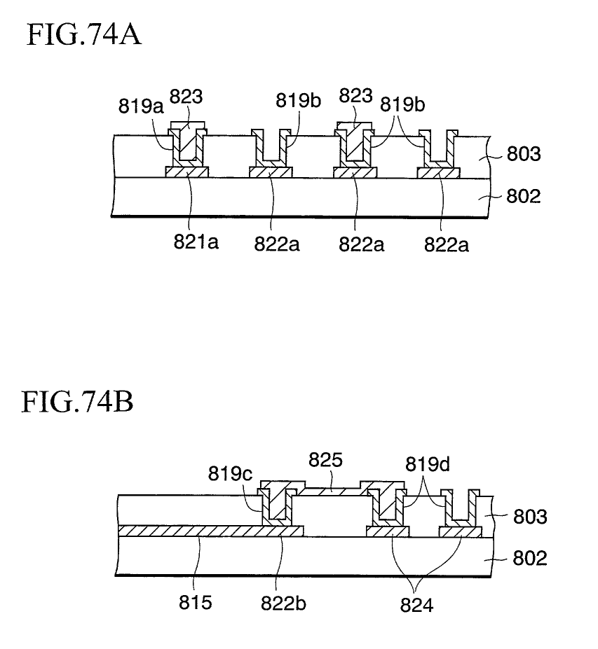

A ninth embodiment of the present invention will be explained with reference to FIGS. 73A and 73B and FIGS. 74A and 74B hereunder. Since the ninth embodiment is basically similar to the eighth embodiment except that the conductive pattern forming method is different, their detailed explanation will be omitted by affixing the same symbols to the same constituent elements in FIGS. 73A, 73B and FIGS. 74A, 74B as those in FIGS. 70A, 70B and FIGS. 71A, 71B. FIG. 74A is a sectional view taken along a VI-VI line in FIG. 73A, and FIG. 74B is a sectional view taken along a VII-VII line in FIG. 73B.

In the ninth embodiment, when the contact hole reaching the source electrode of the TFT is formed in the second insulating film 803 after the second insulating film (protection insulating film) 803 is formed, the contact hole reaching the repair terminals 821a, 822a, 822b and the contact hole reaching the repair wiring 824 are formed simultaneously. The contact holes are formed in the repair wiring 824 at positions that correspond to the repair terminals 822b respectively.

Then, the ITO film is formed on the overall surface. Then, the pixel electrodes 719 are formed by patterning the ITO film and also pads 819a connected to the repair terminals 821a, pads 819b connected to the repair terminals 821a, pads 819c connected to the repair terminals 822b, and pads 819d connected to the repair wirings 824 are formed.

If the disconnection of the data bus line 815 is caused at a position indicated by a × mark, as shown in FIGS. 73A and 73B, for example, on the TFT substrate constructed in this manner, the conductive pattern 825c for connecting the pad 819a and the pad 819b and the conductive pattern 825d for connecting the pad 819c and the pad 819d are formed by the laser CVD method or by baking the conductive paste.

According to the ninth embodiment, in addition to the advantages obtained in the eighth embodiment, there is such an advantage that there is no need to form the contact hole in the second insulating film 803 by irradiating the laser beam upon repairing the fault. Also, since the pads 819a to 819d are formed simultaneously with the pixel electrodes, the increase in the number of steps can be avoided.

In the eighth and ninth embodiment, the case where the disconnection of the data bus line is repaired is explained. But the present invention can be applied to the repair of the disconnection of the gate bus line.

What is claimed is:

1. A fault repairing method for a liquid crystal display device, comprising the steps of:
forming first and second disconnection repairing contact holes, that have a width larger than a width of a disconnected wiring and a depth to expose an upper surface and both side surfaces of the disconnected wiring respectively, at two locations which are positioned to sandwich a disconnected portion of the disconnected wiring; and
forming first and second conductive films, that are connected electrically to the upper surface and both side surfaces, on inner walls and surfaces of the first and second disconnection repairing contact holes to repair the disconnection.

2. The fault repairing method for a liquid crystal display device according to claim 1, wherein the first and second conductive films are formed by a laser CVD method.

3. A fault repairing method for a liquid crystal display device, comprising the steps of:
forming first and second disconnection repairing contact holes, that have a width larger than a width of a disconnected wiring and a depth to expose an upper surface and both side surfaces of the disconnected wiring respectively, at two locations which are positioned to sandwich a disconnected portion of the disconnected wiring; and
forming a conductive film, that is connected electrically to the upper surface and both side surfaces, on inner walls and surfaces of the first and second disconnection repairing contact holes to repair the disconnection.

4. The fault repairing method for a liquid crystal display device according to claim 3, wherein the conductive film is formed by a laser CVD method.

5. The fault repairing method for a liquid crystal display device according to claim 1, wherein both the first and second conductive films are connected to a pixel electrode.

6. A fault repairing method for a liquid crystal display device comprising the steps of:
forming a conductive film over an area located between disconnection end portions of a disconnected wiring by a laser CVD method; and
connecting electrically the conductive film and the disconnection end portions by a laser welding method to repair the disconnection.

7. A liquid crystal display device in which a liquid crystal is sealed between a first substrate, on which first and second wirings intersected via an insulating film are formed, and a second substrate that opposes to the first substrate, comprising:
spare wirings that are formed in vicinity of intersecting positions of the first and second wirings and constitute a part of a detour route used when an interlayer short-circuit between the first and second wirings is repaired.

8. A liquid crystal display device in which a liquid crystal is sealed between a first substrate, on which first and second wirings intersected via an insulating film are formed, and a second substrate that opposes to the first substrate, comprising:
spare pads that are connected to any one of the first and second wirings in vicinity of intersecting positions of the first and second wirings and constitute a part of a detour route used when an interlayer short-circuit between the first and second wirings is repaired.

9. A fault repairing method for a liquid crystal display device comprising the steps of:
disconnecting one wiring of first and second wirings in which an interlayer short-circuit occurs, at two locations that sandwich a short-circuit portion to separate electrically from other wiring; and
forming a detour route to detouring the short-circuit portion to connect electrically disconnection end portions of one wiring.

10. The fault repairing method for a liquid crystal display device according to claim 9, wherein the detour route contains spare wirings, that are formed in vicinity of an intersecting position of the first and second wirings to repair an interlayer short-circuit between the first and second wirings, as a part of its configuration.

11. The fault repairing method for a liquid crystal display device according to claim 9, wherein the detour route contains spare pads, that are connected to any one of the first and second wirings in vicinity of an intersecting position of the first and second wirings to repair an interlayer short-circuit between the first and second wirings, as a part of its configuration.

12. A liquid crystal display device comprising:
a plurality of gate bus lines;
a plurality of storage capacitance bus lines;
a storage capacitance bus line general electrode connected commonly to the storage capacitance bus lines, and arranged to intersect with the plurality of gate bus lines to sandwich an insulating film;
repairing auxiliary wirings that are intersected with the storage capacitance bus line general electrode and are provided electrically independently from the gate bus lines; and
repairing connecting electrodes arranged on both sides of the storage capacitance bus lines general electrode in a width direction respectively, one ends of which overlap with the gate bus lines and other ends of which overlap with the repairing auxiliary wirings.

13. The liquid crystal display device according to claim 12, wherein the repairing auxiliary wirings are formed by same steps as the gate bus lines.

14. The liquid crystal display device according to claim 12, wherein the repairing connecting electrodes are formed by same steps as the storage capacitance bus line general electrode.

15. A fault repairing method of repairing a short-circuit between a gate bus line and a storage capacitance bus line general electrode in a liquid crystal display device that includes a plurality of gate bus lines, a plurality of storage capacitance bus lines, and a storage capacitance bus line general electrode that is connected commonly to the plurality of storage capacitance bus lines and intersected with the gate bus lines to sandwich an insulating film between them, comprising the steps of:
forming repairing auxiliary wirings to intersect with the storage capacitance bus line general electrode;
forming repairing connection electrodes one ends of which are connected to the gate bus lines and other ends of which are connected to the repairing auxiliary wirings; and
disconnecting a gate bus line, that is short-circuited to a storage capacitance bus line general electrode, on both sides of the storage capacitance bus line general electrode.

16. A fault repairing method of repairing a short-circuit between a gate bus line and a storage capacitance bus line general electrode in a liquid crystal display device that includes a plurality of gate bus lines, a plurality of storage capacitance bus lines, and a storage capacitance bus line general electrode that is connected commonly to the plurality of storage capacitance bus lines and intersected with the gate bus lines, comprising the steps of:
forming repairing auxiliary wirings to intersect with the storage capacitance bus line general electrode;
disconnecting a gate bus line, that is short-circuited to a storage capacitance bus line, on both sides of the storage capacitance bus line general electrode;
exposing two locations of the gate bus line to sandwich the storage capacitance bus line general electrode between them;
exposing two locations of the repairing auxiliary wiring to sandwich the storage capacitance bus line general electrode; and
depositing a conductive film on an area extended from an exposed portion of the gate bus line to an exposed portion of the repairing auxiliary wiring to connect electrically the gate bus line to the repairing auxiliary wiring.

17. A fault repairing method for a liquid crystal display device that includes switching thin film transistors that are connected to gate bus lines, data bus lines and pixel electrodes, and spare thin film transistors that are not connected to the data bus lines, comprising the step of:
forming a conductive pattern, that connects a drain electrode of a spare thin film transistor and a data bus line, in repairing a fault.

18. The fault repairing method for a liquid crystal display device according to claim 17, wherein the conductive pattern is formed by a laser CVD method or by baking conductive chemicals by virtue of a laser beam irradiation.

19. The fault repairing method for a liquid crystal display device according to claim 17, wherein the spare thin film transistor is separated from the pixel electrode, a source electrode of the spare thin film transistor and the pixel electrode are connected by a laser welding in repairing the fault.

20. The fault repairing method for a liquid crystal display device according to claim 17, wherein contact holes are opened in an insulating film on the drain electrode of a spare thin film transistor and on a drain electrode of a switching thin film transistor, by laser beam irradiation before forming the conductive pattern.

21. The fault repairing method for a liquid crystal display device according to claim 17, wherein the conductive pattern is formed of any one metal selected from a group consisting of tungsten, molybdenum, chromium, gold, and silver.

22. A fault repairing method for a liquid crystal display device that includes switching thin film transistors that are connected to gate bus lines, data bus lines and pixel electrodes, and spare thin film transistors that are not connected to the gate bus lines, comprising the step of:
forming a conductive pattern, that connects at least a gate electrode of a spare thin film transistor and a gate bus line, in repairing a fault.

23. The fault repairing method for a liquid crystal display device according to claim 22, wherein the conductive pattern is formed by a laser CVD method or by baking conductive chemicals by virtue of a laser beam irradiation.

24. The fault repairing method for a liquid crystal display device according to claim 22, wherein the spare thin film transistor is separated from the pixel electrode, a source electrode of the spare thin film transistor and the pixel electrode are connected by a laser welding in repairing the fault.

25. The fault repairing method for a liquid crystal display device according to claim 22, wherein contact holes are opened in an insulating film on the gate electrode of a spare thin film transistor and on the gate bus line of a switching thin film transistor, by laser beam irradiation before forming the conductive pattern.

26. The fault repairing method for a liquid crystal display device according to claim 22, wherein the conductive pattern is formed of any one metal selected from a group consisting of tungsten, molybdenum, chromium, gold, and silver.

27. A liquid crystal display device comprising:
switching thin film transistors that are connected to gate bus lines, data bus lines and pixel electrodes; and
spare thin film transistors that are not connected to the gate bus lines, wherein a part of the gate bus lines are provided as a gate electrode of the spare thin film transistor.

28. A liquid crystal display device comprising:
switching thin film transistors that are connected to gate bus lines, data bus lines and pixel electrodes; and
spare thin film transistors that are not connected to the gate bus lines, wherein a gate electrode of the spare thin film transistor is arranged between the data bus line and the pixel electrode.

29. A fault repairing method for a liquid crystal display device that includes a plurality of bus lines formed on a substrate, TAB terminals arranged along a first side of the substrate and connected to the bus lines respectively, and repair wirings arranged along a second side opposing to the first side, comprising the step of:
forming at least a conductive pattern for connecting electrically a bus line and a repair wiring, in repairing the fault.

30. The fault repairing method for a liquid crystal display device according to claim 29, wherein the conductive pattern is formed by a laser CVD method or by baking conductive chemicals by virtue of a laser beam irradiation.

31. The fault repairing method for a liquid crystal display device according to claim 29, wherein a plurality of repair wiring are provided.

32. The fault repairing method for a liquid crystal display device according to claim 29, wherein contact holes are opened on the bus lines and the repair wirings, by laser beam irradiation before forming the conductive pattern.

33. The fault repairing method for a liquid crystal display device according to claim 29, wherein the conductive pattern is formed of any one metal selected from a group consisting of tungsten, molybdenum, chromium, gold, and silver.

34. A liquid crystal display device comprising:
a plurality of first bus lines on a substrate;
a plurality of second bus lines intersected with the plurality of first bus lines via an insulating film;
a plurality of TAB terminals arranged along a first side of the substrate and connected to the plurality of first bus lines respectively; and
repair wirings arranged along a second side opposing to the first side, the repair wirings having no wiring that intersects with the repair wirings before a fault is repaired.

35. A liquid crystal display device comprising:
a plurality of first bus lines on a substrate;
a plurality of second bus lines intersected with the plurality of first bus lines via an insulating film;
a plurality of TAB terminals arranged along a first side of the substrate and connected to the plurality of first bus lines respectively;
repair wirings arranged along a second side opposing to the first side;
repair terminals of the first bus lines provided along the second side;
first connecting pads exposed on the repair terminals and connected electrically to the repair terminals; and
second connecting pads exposed on the repair wirings and connected electrically to the repair wirings.

36. The liquid crystal display device according to claim 35, wherein the repair wirings and the first connecting pads are arranged on an outside of a color filter substrate opposing to the substrate for sealing liquid crystal between them.

37. The liquid crystal display device according to claim 35, wherein a repair TAB terminal is formed adjacently to the TAB terminals.

38. The liquid crystal display device according to claim 37, the repair TAB terminal is connected to the first bus line in repairing the fault.
